(19) United States
(12) Patent Application Publication
(10) Pub. No.: US 2025/0159391 A1
(43) Pub. Date: May 15, 2025

(54) SOUND APPARATUS AND VEHICULAR APPARATUS INCLUDING THE SAME

(71) Applicant: LG Display Co., Ltd., Seoul (KR)

(72) Inventors: Daewon KIM, Paju-si (KR); Daeho KIM, Paju-si (KR); DoHyeong KIM, Paju-si (KR); Seungwoo BAEK, Paju-si (KR)

(73) Assignee: LG Display Co., Ltd., Seoul (KR)

(21) Appl. No.: 18/940,331

(22) Filed: Nov. 7, 2024

(30) Foreign Application Priority Data
Nov. 10, 2023 (KR) 10-2023-0155635

(51) Int. Cl. H04R 1/02

(52) U.S. Cl. CPC H04R 1/02; H04R 2499/13

(57) ABSTRACT

A sound apparatus and a vehicular apparatus including the sound apparatus are discussed. The sound apparatus can include an enclosure including an internal space and an opening part connected to the internal space, and a sound generating module at the internal space of the enclosure. The sound generating module can include a vibration member at the enclosure and a vibration apparatus connected to the enclosure to vibrate the vibration member.

### CROSS-REFERENCE TO RELATED APPLICATIONS

This application claims priority to Korean Patent Application No. 10-2023-0155635 filed in the Republic of Korea on Nov. 10, 2023, the entire disclosure of which is hereby expressly incorporated by reference into the present application.

### BACKGROUND

### Technical Field

The present disclosure relates to a sound apparatus and a vehicular apparatus including the same.

### Discussion of the Related Art

Vehicles include a sound apparatus which outputs a sound based on an audio signal output from a multimedia device such as a car audio device. For example, the sound apparatus applied to the vehicles can include a front speaker and a rear speaker, which are configured as a coil type.

However, a sound apparatus in the vehicles can be limited when outputting a realistic sound or stereo sound of a multichannel through the front speaker and the rear speaker to limitations of the coil type device. Further, in the sound apparatus in vehicles, in a case where the number of speakers are increased, a stereo sound can be output, but due to a size of the speakers based on the coil type device and a limitation of a space in vehicles, there can be a limitation in increasing the number of speakers so that a realistic sound or stereo sound may not be provided using the coil type device.

### SUMMARY OF THE DISCLOSURE

The inventors of the present disclosure have recognized the problems and disadvantages of the related art and have performed extensive research and experiments for enhancing a sound characteristic and/or a sound pressure level characteristic of a sound apparatus for vehicles. Based on the extensive research and experiments, the inventors have invented a sound apparatus and a vehicular apparatus including the same, which can enhance a sound characteristic and/or a sound pressure level characteristic.

An aspect of the present disclosure is directed to providing a sound apparatus and a vehicular apparatus including the same, which can enhance a sound characteristic and/or a sound pressure level characteristic.

An aspect of the present disclosure is directed to providing a sound apparatus and a vehicular apparatus including the same, which can enhance a sound characteristic and/or a sound pressure level characteristic in a pitched sound band including a sound of a low-pitched sound band.

Additional features, advantages, and aspects of the present disclosure will be set forth in the description that follows, and in part will be apparent from the description, or can be learned by practice of the inventive concepts provided herein. Other features, advantages, and aspects of the present disclosure can be realized and attained by the structure particularly pointed out in the written description, or derivable therefrom, and the claims hereof as well as the appended drawings.

To achieve these and other advantages and aspects of the present disclosure, as embodied and broadly described herein, in one or more aspects, a sound apparatus comprises an enclosure including an internal space and an opening part connected to the internal space, and a sound generating module at the internal space of the enclosure. The sound generating module comprises a vibration member at the enclosure, and a vibration apparatus connected to the enclosure to vibrate the vibration member.

In one or more aspects of the present disclosure, a vehicular apparatus can comprise an interior material exposed at an interior space, and one or more sound generating apparatuses disposed at the interior material to output a sound to the interior space. The one or more sound generating apparatuses comprises an enclosure including an internal space and an opening part connected to the internal space, and a sound generating module at the internal space of the enclosure. The sound generating module comprises a vibration member at the enclosure, and a vibration apparatus connected to the enclosure to vibrate the vibration member.

In one or more aspects of the present disclosure, a vehicular apparatus can comprise an interior material exposed at an interior space, and one or more sound apparatuses as described above, disposed at the interior material to output a sound to the interior space.

Details of other various embodiments will be included in the detailed description of the disclosure and the accompanying drawings.

According to a sound apparatus and a vehicular apparatus including the same according to one or more embodiments of the present disclosure, a sound characteristic and/or a sound pressure level characteristic can be enhanced.

According to a sound apparatus and a vehicular apparatus including the same according to one or more embodiments of the present disclosure, a sound characteristic and/or a sound pressure level characteristic can be enhanced in a sound band including a sound of a low-pitched sound band.

According to a sound apparatus and a vehicular apparatus including the same according to one or more embodiments of the present disclosure, a heat dissipation part can be configured at an enclosure, thereby preventing a reduction in performance of a vibration apparatus caused by heat.

According to a sound apparatus and a vehicular apparatus including the same according to one or more embodiments of the present disclosure, one or more holes can be configured at a vibration member, and thus, a sound characteristic and/or a sound pressure level characteristic can be enhanced in a sound band including a sound of a low-pitched sound band.

According to a sound apparatus and a vehicular apparatus including the same according to one or more embodiments of the present disclosure, a protrusion part and a coupling part can be configured as one part (or one component), thereby realizing an effect of uni-materialization.

According to a sound apparatus and a vehicular apparatus including the same according to one or more embodiments of the present disclosure, a connection member is configured between a vehicle interior material and an enclosure, and thus, a sound characteristic and/or a sound pressure level characteristic can be enhanced in a sound band including a sound of a low-pitched sound band.

According to a sound apparatus and a vehicular apparatus including the same according to one or more embodiments of the present disclosure, a sound can be output through a hollow part including a chamfer portion having a non-rectangular shape, and thus, a sound characteristic and/or a sound pressure level characteristic can be enhanced in a sound band including a sound of a low-pitched sound band, and peak and/or dip in a high-pitched sound band can be improved, thereby enhancing a balance characteristic of a sound pressure level or a flatness characteristic of a sound pressure level.

According to a sound apparatus and a vehicular apparatus including the same according to one or more embodiments of the present disclosure, a coupling part coupled to an opening part of an enclosure can have an optimized width and/or length, and thus, a sound characteristic and/or a sound pressure level characteristic can be enhanced in a sound band including a sound of a low-pitched sound band, and peak and/or dip in a high-pitched sound band can be improved, thereby enhancing a balance characteristic of a sound pressure level or a flatness characteristic of a sound pressure level.

According to a sound apparatus and a vehicular apparatus including the same according to one or more embodiments of the present disclosure, a connection member having different thicknesses can be configured between an enclosure and a vehicle interior material, and thus, a sound characteristic and/or a sound pressure level characteristic of a low-pitched sound band can be enhanced.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with aspects of the disclosure.

It is to be understood that both the foregoing description and the following description of the present disclosure are examples and explanatory and are intended to provide further explanation of the disclosure as claimed.

### BRIEF DESCRIPTION OF THE DRAWINGS

The accompanying drawings, which are included to provide a further understanding of the disclosure, and incorporated in and constitute a part of this disclosure, illustrate aspects and embodiments of the disclosure and together with the description serve to explain principles of the disclosure.

FIG. 1 illustrates a sound apparatus for vehicles according to an embodiment of the present disclosure.

FIG. 2 illustrates a sound apparatus for vehicles according to another embodiment of the present disclosure.

FIG. 3 illustrates a sound apparatus according to an embodiment of the present disclosure.

FIG. 4 is an exploded perspective view of the sound apparatus illustrated in FIG. 3 according to an embodiment of the present disclosure.

FIG. 5 is a cross-sectional view illustrating a vibration apparatus of the sound generating module illustrated in FIGS. 3 and 4 according to an embodiment of the present disclosure.

FIG. 6 illustrates a sound apparatus according to another embodiment of the present disclosure.

FIG. 7 is an exploded perspective view of the sound apparatus illustrated in FIG. 6 according to an embodiment of the present disclosure.

FIG. 8 illustrates a sound apparatus according to another embodiment of the present disclosure.

FIG. 9 is an exploded perspective view of the sound apparatus illustrated in FIG. 8 according to an embodiment of the present disclosure.

FIG. 10 illustrates a sound apparatus according to another embodiment of the present disclosure.

FIG. 11 illustrates a sound apparatus according to another embodiment of the present disclosure.

FIG. 12 illustrates a sound apparatus according to another embodiment of the present disclosure.

FIG. 13 is an exploded perspective view of the sound apparatus illustrated in FIG. 12 according to another embodiment of the present disclosure.

FIG. 14 illustrates a sound apparatus according to another embodiment of the present disclosure.

FIG. 15 illustrates a sound apparatus according to another embodiment of the present disclosure.

FIG. 16 is an exploded perspective view of the sound apparatus illustrated in FIG. 15 according to another embodiment of the present disclosure.

FIG. 17 illustrates a sound apparatus according to another embodiment of the present disclosure.

FIG. 18 illustrates a sound apparatus according to another embodiment of the present disclosure.

FIG. 19 illustrates a sound apparatus according to another embodiment of the present disclosure.

FIG. 20 illustrates a sound apparatus according to another embodiment of the present disclosure.

FIG. 21 illustrates a sound apparatus according to another embodiment of the present disclosure.

FIG. 22 illustrates a method of connecting a sound apparatus to a coupling part illustrated in FIG. 21 according to another embodiment of the present disclosure.

FIG. 23 illustrates a sound apparatus according to another embodiment of the present disclosure.

FIG. 24 illustrates a method of connecting a sound apparatus to a coupling part illustrated in FIG. 23 according to another embodiment of the present disclosure.

FIG. 25 illustrates a sound apparatus according to another embodiment of the present disclosure.

FIG. 26 is an exploded perspective view of the sound apparatus illustrated in FIG. 25 according to another embodiment of the present disclosure.

FIG. 27 illustrates a sound apparatus according to another embodiment of the present disclosure.

FIG. 28 illustrates a sound apparatus according to another embodiment of the present disclosure.

FIG. 29 illustrates an internal of a sound apparatus according to another embodiment of the present disclosure.

FIG. 30 illustrates a sound apparatus according to another embodiment of the present disclosure.

FIG. 31 illustrates a coupling part according to another embodiment of the present disclosure.

FIG. 32 illustrates a sound apparatus according to another embodiment of the present disclosure.

FIG. 33 illustrates a method of connecting a sound apparatus to a coupling part illustrated in FIG. 32 according to another embodiment of the present disclosure.

FIG. 34 illustrates a sound apparatus according to another embodiment of the present disclosure.

FIG. 35 illustrates a method of connecting a sound apparatus to a coupling part illustrated in FIG. 34 according to another embodiment of the present disclosure.

FIG. 36 illustrates a vehicular apparatus according to an embodiment of the present disclosure.

FIG. 37 illustrates a vehicular apparatus according to an embodiment of the present disclosure.

FIG. 38 illustrates a sound generating apparatus disposed at a roof of the vehicular apparatus illustrated in FIGS. 36 and 37 according to an embodiment of the present disclosure.

FIG. 39 illustrates a sound generating apparatus disposed at a roof and a seat of the vehicular apparatus illustrated in FIGS. 36 and 37 according to an embodiment of the present disclosure.

FIG. 40 illustrates a sound output characteristic of an apparatus according to an embodiment of the present disclosure and an experimental example.

Throughout the drawings and the detailed description, unless otherwise described, the same drawing reference numerals should be understood to refer to the same elements, features, and structures. The sizes, lengths, and thicknesses of layers, regions and elements, and depiction of thereof can be exaggerated for clarity, illustration, and convenience.

### DETAILED DESCRIPTION OF THE EMBODIMENTS

Advantages and features of the present disclosure, and implementation methods thereof, are clarified through the aspects described with reference to the accompanying drawings. The present disclosure may, however, be embodied in different forms and should not be construed as limited to the example aspects set forth herein. Rather, these example aspects are examples and are provided so that this disclosure can be thorough and complete to assist those skilled in the art to understand the inventive concepts without limiting the protected scope of the present disclosure.

A shape, a size, a ratio, an angle, and a number disclosed in the drawings for describing embodiments of the present disclosure are merely an example, and thus, the present disclosure is not limited to the illustrated details. Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present disclosure are used, another part can be added unless “only” is used. The terms of a singular form can include plural forms unless referred to the contrary.

In construing an element, the element is construed as including an error range although there is no explicit description.

In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms. These terms are only used to distinguish one element from another and may not define order or sequence. For example, a first element could be termed a second element, and, similarly, a second element could be termed a first element, without departing from the scope of the present disclosure.

In describing elements of the present disclosure, the terms “first,” “second,” “A,” “B,” “(a),” “(b),” or the like can be used. These terms are intended to identify the corresponding element(s) from the other element(s), and these are not used to define the essence, basis, order, or number of the elements.

For the expression that an element is “connected,” “coupled,” or “contact,” to another element, the element may not only be directly connected, coupled, or contacted to another element, but also be indirectly connected, coupled, or contacted to another element with one or more intervening elements interposed between the elements, unless otherwise specified.

For the expression that an element is “contacts” or “overlaps” with another element, the element can not only directly contact, overlap, or the like with another element, but also indirectly contact or overlap with another element with one or more intervening elements disposed or interposed between the elements, unless otherwise specified.

The term “at least one” should be understood as including any and all combinations of one or more of the associated listed items. For example, the meaning of “at least one of a first item, a second item and a third item” denotes the combination of all items proposed from two or more of the first item, the second item and the third item as well as the first item, the second item or the third item. Further, the term “can” fully encompasses all the meanings and coverages of the term “may.”

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, example embodiments of a sound apparatus according to the present disclosure will be described in detail with reference to the accompanying drawings. All the components of each apparatus according to all embodiments of the present disclosure are operatively coupled and configured. For convenience of description, a scale of each of elements illustrated in the accompanying drawings differs from a real scale, and thus, is not limited to a scale illustrated in the drawings.

FIG. 1 illustrates a sound apparatus for vehicles according to an embodiment of the present disclosure.

With reference to FIG. 1, a sound apparatus 30 according to an embodiment of the present disclosure can be disposed or equipped at an inner portion of a vehicle 10 to output a sound S toward an interior space (or an indoor space) IS of the vehicle (or a vehicular apparatus) 10.

The vehicle 10 can be a vehicular apparatus which includes one or more seats and one or more windows. For example, the vehicle 10 can include a vehicle, a train, a ship, or an aircraft, or the like, but embodiments of the present disclosure are not limited thereto.

The vehicle 10 according to an embodiment of the present disclosure can include a main structure 110.

The main structure 110 of the vehicle 10 can include a main frame, a sub-frame, a side frame, a door frame, an under-frame, and a seat frame, or the like, but embodiments of the present disclosure are not limited thereto. For example, the main structure 110 can be a vehicle body, a vehicle structure, or a frame structure, or the like, but embodiments of the present disclosure are not limited thereto.

The vehicle 10 according to an embodiment of the present disclosure can further include an exterior material 120.

The exterior material 120 of the vehicle 10 can be configured to cover the main structure 110. For example, the exterior material 120 of the vehicle 10 can be configured to cover an outer portion of the main structure 110. In the following description, the exterior material 120 can be a vehicle exterior material 120, and can be used interchangeably.

The exterior material (or vehicle exterior material) 120 of the vehicle 10 can include a hood panel, a front fender panel, a dash panel, a pillar panel, a trunk panel, a roof panel (or ceiling), a floor panel, a door inner panel, and a door outer panel, or the like, but embodiments of the present disclosure are not limited thereto.

The exterior material 120 according to an embodiment of the present disclosure can include at least one or more of a planar portion (or a flat portion) and a curved portion (or a flexural portion or an uneven portion). For example, the exterior material 120 can have a structure corresponding to a structure of a corresponding main structure 110, or can have a structure which differs from a structure of a corresponding main structure 110.

The vehicle 10 according to an embodiment of the present disclosure can further include a vehicle interior material 130. In the following description, the vehicle interior material 130 can be an interior material 130, and can be used interchangeably.

The vehicle interior material 130 can include all elements (or components) configuring an inner portion of the vehicle 10, or can include all elements disposed at the interior space IS of the vehicle 10. For example, the vehicle interior material 130 can be an interior member or an interior finish material of the vehicle 10, but embodiments of the present disclosure are not limited thereto.

The vehicle interior material 130 according to an embodiment of the present disclosure can be configured to cover one or more of main structure 110 and the exterior material 120 in the interior space (or an inner portion) IS of the vehicle 10. For example, the vehicle interior material 130 can cover one or more of main structure 110 and the exterior material 120 in the interior space IS of the vehicle 10 and can be configured to be exposed at the interior space IS of the vehicle 10.

The vehicle interior material 130 according to an embodiment of the present disclosure can be configured to be exposed at the inner portion and/or the interior space IS of the vehicle 10 in the inner portion and/or the interior space IS of the vehicle 10. For example, the vehicle interior material 130 can be configured to cover one or more surfaces (or an interior surfaces) of at least one or more of a main frame (or a vehicle body), a side frame (or a side body), a door frame (or a door body), a handle frame (or a steering hub), and a seat frame, which are exposed at the interior space IS of the vehicle 10.

The vehicle interior material 130 according to an embodiment of the present disclosure can include a dashboard, a pillar interior material (or a pillar trim), a floor interior material (or a floor carpet), a roof interior material (or a headliner), a door interior material (or a door trim), a handle interior material (or a steering cover), a seat interior material, a rear package interior material (or a back seat shelf), an overhead console (or an illumination interior material), a rear view mirror, a glove box, and a sun visor, or the like, but embodiments of the present disclosure are not limited thereto.

The vehicle interior material 130 according to an embodiment of the present disclosure can include one or more of metal, wood, rubber, plastic, glass, fiber, cloth, paper, a mirror, leather, and carbon, but embodiments of the present disclosure are not limited thereto. The vehicle interior material 130 including a plastic material can be an injection material which is implemented by an injection process using a thermoplastic resin or a thermosetting resin, but embodiments of the present disclosure are not limited thereto. The vehicle interior material 130 including a fiber material can include at least one or more of a plastic composite fiber, a carbon fiber (or an aramid fiber), and a natural fiber, but embodiments of the present disclosure are not limited thereto. The vehicle interior material 130 including the fiber material can include a textile sheet, a knit sheet, or a nonwoven fabric, or the like, but embodiments of the present disclosure are not limited thereto. For example, the paper can be cone paper for speakers. For example, the cone paper can be pulp or foamed plastic, or the like, but embodiments of the present disclosure are not limited thereto. The vehicle interior material 130 including a leather material can include natural leather or artificial leather, but embodiments of the present disclosure are not limited thereto.

The vehicle interior material 130 according to an embodiment of the present disclosure can include at least one or more of a planar portion (or a flat portion) and a curved portion (or a flexural portion or an uneven portion). For example, the vehicle interior material 130 can have a structure corresponding to a structure (or an inner surface structure) of a corresponding main structure 110, or can have a structure which differs from a structure of a corresponding main structure 110.

According to an embodiment of the present disclosure, the sound apparatus 30 can be disposed at the vehicle interior material 130. The sound apparatus 30 can vibrate the vehicle interior material 130 to generate a sound S based on a vibration of the vehicle interior material 130. For example, the sound apparatus 30 can directly vibrate the vehicle interior material 130 to generate the sound S based on a vibration of the vehicle interior material 130. For example, the sound apparatus 30 can be configured to vibrate the vehicle interior material 130 to output the sound S toward the inner portion or the interior space IS of the vehicle 10. Thus, the sound apparatus 30 can use the vehicle interior material 130 as a sound vibration plate, a sound diaphragm, or an acoustic diaphragm. The vehicle interior material 130 can be a vibration plate, a sound vibration plate, or a sound generating plate for outputting the sound S. For example, the vehicle interior material 130 can have a size which is greater than the sound apparatus 30, but embodiments of the present disclosure are not limited thereto.

According to an embodiment of the present disclosure, the sound apparatus 30 can be disposed at at least one or more of a dashboard, a pillar interior material, a floor interior material, a roof interior material, a door interior material, a handle interior material, and a seat interior material, or can be connected (or coupled) to at least one or more of a rear package interior material, an overhead console, a rear view mirror, a glove box, and a sun visor.

The vehicle 10 according to an embodiment of the present disclosure can include one or more sound apparatuses 30 disposed at or connected to at least one or more regions (or portions) of the vehicle interior material 130. The one or more sound apparatuses 30 can vibrate the at least one or more regions (or portions) of the vehicle interior material 130 to output a realistic sound S and/or stereo sound including a multichannel toward the interior space IS of the vehicle 10.

According to an embodiment of the present disclosure, the sound apparatus 30 can be configured at a region between the vehicle interior material 130 and the main structure 110, or a region between the vehicle interior material 130 and the exterior material 120. The sound apparatus 30 can be disposed at a region between the vehicle interior material 130 and the main structure 110, or a region between the vehicle interior material 130 and the exterior material 120, and can indirectly or directly vibrate one or more of the region between the vehicle interior material 130 and the main structure 110 and the region between the vehicle interior material 130 and the exterior material 120 to output sound S.

According to an embodiment of the present disclosure, the sound apparatus 30 can be disposed at one or more of a region (or a first space) between the main structure 110 and the exterior material 120, a region (or a second space) between the main structure 110 and the vehicle interior material 130, the exterior material 120, and the vehicle interior material 130. For example, the sound apparatus 30 can be disposed at one or more of the region (or first space) between the main structure 110 and the exterior material 120, the region (or second space) between the main structure 110 and the vehicle interior material 130, the exterior material 120, and the vehicle interior material 130, and can be configured to output a sound. For example, the sound apparatus 30 can be disposed at one or more of the region (or first space) between the main structure 110 and the exterior material 120, the region (or second space) between the main structure 110 and the vehicle interior material 130, the exterior material 120, and the vehicle interior material 130, and can indirectly or directly vibrate one or more of the main structure 110, the exterior material 120, and the vehicle interior material 130 to output sound.

According to an embodiment of the present disclosure, the sound apparatuses 30 can output a sound in a region between the exterior material 120 and the vehicle interior material 130 of the vehicle 10. For example, the sound apparatus 30 can be disposed at at least one or more of a region (or a third space) between the exterior material 120 and the vehicle interior material 130, the exterior material 120 and the vehicle interior material 130. For example, the sound apparatus 30 can be disposed at the region between the exterior material 120 and the vehicle interior material 130, and can indirectly or directly vibrate one or more of the exterior material 120 and the vehicle interior material 130 to output sound. For example, the sound apparatuses 30 can be connected or coupled to one or more of the exterior material 120 and the vehicle interior material 130 in a region between the exterior material 120 and the vehicle interior material 130, and can indirectly or directly vibrate one or more of the exterior material 120 and the vehicle interior material 130 to output sound. For example, the at least one or more of the exterior material 120 and the vehicle interior material 130 can output a sound S based on driving (or vibration) of the sound apparatus 30.

According to an embodiment of the present disclosure, one or more of the exterior material 120 and the vehicle interior material 130 of the vehicle 10 can be a vibration plate, a sound vibration plate, or a sound generating plate, or the like configured to output a sound S. For example, each of the exterior material 120 and the vehicle interior material 130 configured to output the sound can have a size (or an area) which is greater than that of the sound apparatus 30, and thus, can perform a function of a large-area vibration plate, a large-area sound vibration plate, or a large-area sound generating plate, thereby enhancing a sound characteristic and/or a sound pressure level characteristic of a sound band including a low-pitched sound band generated by the sound apparatus 30. For example, a frequency of a sound of the low-pitched sound band can be 300 Hz or less, 400 Hz or less, or 500 Hz or less, but embodiments of the present disclosure are not limited thereto.

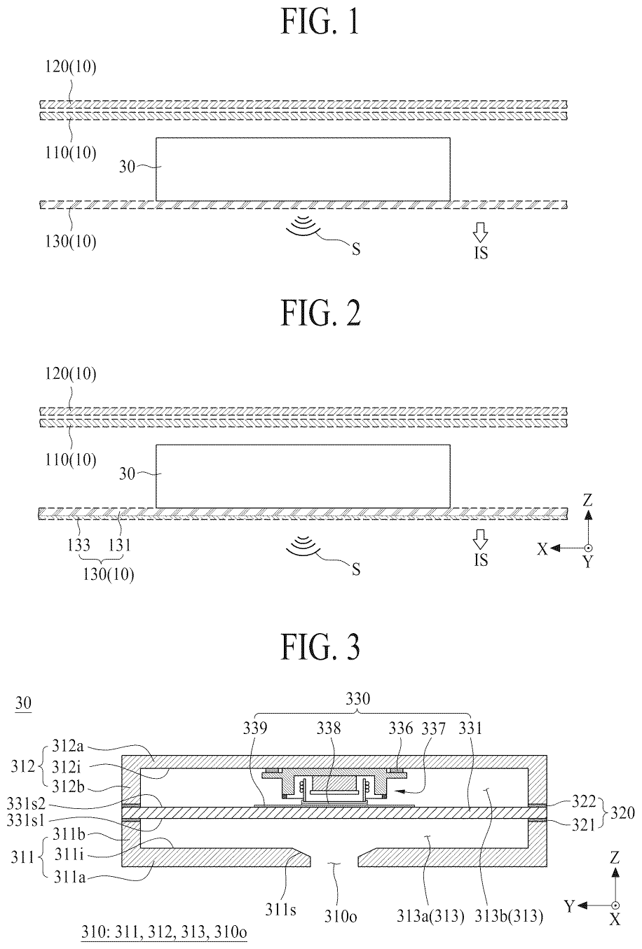

FIG. 2 illustrates a sound apparatus for vehicles according to another embodiment of the present disclosure. Particularly, FIG. 2 illustrates an embodiment implemented by modifying the vehicle interior material 130 on which the sound apparatus described above with reference to FIG. 1 is disposed. Therefore, in the following description, repetitive descriptions of other elements other than a vehicle interior material 130 can be omitted or will be briefly given.

With reference to FIG. 2, the sound apparatus 30 according to another embodiment of the present disclosure can vibrate a vehicle interior material 130 to output a sound S.

The vehicle interior material 130 according to an embodiment of the present disclosure can include one or more materials of metal, wood, rubber, plastic, carbon, glass, fiber, cloth, paper, a mirror, and leather, but embodiments of the present disclosure are not limited thereto.

The vehicle interior material 130 according to another embodiment of the present disclosure can include a base member 131 and a surface member 133. For example, the base member 131 can be an injection material, a first interior material, an inner interior material, or a rear interior material, but embodiments of the present disclosure are not limited thereto. The surface member 133 can be a second interior material, an outer interior material, a front interior material, an outer surface member, a reinforcement member, or a decoration member, but embodiments of the present disclosure are not limited thereto.

The base member 131 can include a plastic material. The base member 131 according to an embodiment of the present disclosure can include an injection material. For example, the base member 131 can be an injection material which is implemented by an injection process using a thermoplastic resin or a thermosetting resin, but embodiments of the present disclosure are not limited thereto. The vehicle interior material 130 or the base member 131 can be configured to cover an inner portion of a vehicle 10. For example, the vehicle interior material 130 or the base member 131 can be configured to cover one or more of the main structure 110 and the exterior material 120 in an interior space IS of the vehicle 10. For example, the vehicle interior material 130 or the base member 131 can be configured to cover one surface (or an inner surface) of at least one or more of a main frame, a side frame, a door frame, and a handle frame, which are exposed at the interior space IS of the vehicle 10.

The base member 131 can include at least one or more of a planar portion and a curved portion. For example, the base member 131 can have a structure corresponding to a structure (or a rear structure) of a corresponding main structure 110, or can have a structure which differs from a structure of a corresponding main structure 110.

The surface member 133 can be disposed on the base member 131. For example, the surface member 133 can be disposed to cover the base member 131. The surface member 133 can cover the base member 131 at the inner portion or the interior space IS of the vehicle 10 and can be configured to be exposed at the inner portion or the interior space IS of the vehicle 10. For example, the surface member 133 can be disposed at or coupled to a front surface (or an interior surface) of the base member 131 exposed at the interior space IS of the vehicle 10.

The vehicle interior material 130 or the surface member 133 according to an embodiment of the present disclosure can include one or more materials of plastic, glass, fiber, leather, cloth, rubber, a mirror, wood, paper, carbon, and metal, but embodiments of the present disclosure are not limited thereto. For example, the surface member 133 can be a fiber material. For example, the surface member 133 including the fiber material can include at least one or more of a synthetic fiber, a carbon fiber (or an aramid fiber), and a natural fiber, but embodiments of the present disclosure are not limited thereto. For example, the surface member 133 including the fiber material can be a textile sheet, a knit sheet, or a nonwoven fabric, but embodiments of the present disclosure are not limited thereto. For example, the surface member 133 including the fiber material can be a fabric member, but embodiments of the present disclosure are not limited thereto.

The synthetic fiber can be a thermoplastic resin and can include a polyolefin-based fiber which is an eco-friendly material which does not relatively release a harmful substance. For example, the polyolefin-based fiber can include a polyethylene fiber, a polypropylene fiber, or a polyethylene terephthalate fiber, but embodiments of the present disclosure are not limited thereto. The polyolefin-based fiber can be a fiber of a single resin or a fiber of a core-shell structure, but embodiments of the present disclosure are not limited thereto. The natural fiber can be a composite fiber of one or two or more of a jute fiber, a kenaf fiber, an abaca fiber, a coconut fiber, and a wood fiber, but embodiments of the present disclosure are not limited thereto.

The sound apparatus 30 can be covered by the vehicle interior material 130. The sound apparatus 30 can be configured to vibrate the vehicle interior material 130 including the base member 131 and the surface member 133 to output a sound S toward the inner portion and/or the interior space IS of the vehicle 10.

The sound apparatus 30 according to another embodiment of the present disclosure can output the sound S toward the interior space IS of the vehicle 10 using the vehicle interior material 130 as a vibration plate or a sound vibration plate and can output a realistic sound S or stereo sound including a multichannel toward the interior space IS of the vehicle 10.

According to another embodiment of the present disclosure, the sound apparatus 30 can be configured to be surrounded by an enclosure. A space can be provided between the sound apparatus 30 and the enclosure, and a sound (or a sound pressure level) can be output based on a vibration of the vehicle interior material 130 based on air between the sound apparatus 30 and the enclosure. However, there can be a problem where a sound of the low-pitched sound band is not output, and there can be a problem where the flatness of a sound pressure level is reduced because the number of peaks and dips occurring in a reproduction frequency band of a sound (or a sound pressure level) generated based on a vibration of the vehicle interior material 130 increases and each of a highest sound pressure level and a lowest sound pressure level occurring in a reproduction frequency band of a sound (or a sound pressure level) generated based on a vibration of the vehicle interior material 130 increases. The peak can be a phenomenon where a sound pressure level bounces in a specific frequency, and the dip can be a phenomenon where a low sound pressure level is generated as the occurrence of a sound having a specific frequency is reduced. The flatness of a sound characteristic can be a level of a deviation between a highest sound pressure and a lowest sound pressure in a specific frequency.

The inventors of the present disclosure have performed extensive research and experiments for implementing a sound apparatus and a vehicular apparatus including the same, in which a sound characteristic of the low-pitched sound band can be improved and a flatness characteristic of a sound pressure level can be enhanced. Based on the extensive research and experiments, the inventors of the present disclosure have invented a sound apparatus and a vehicular apparatus including the same, which can output a sound including a high-pitched sound band to the low-pitched sound band and can enhance a balance characteristic of a sound pressure level or the flatness characteristic of a sound pressure level. This will be described below in detail.

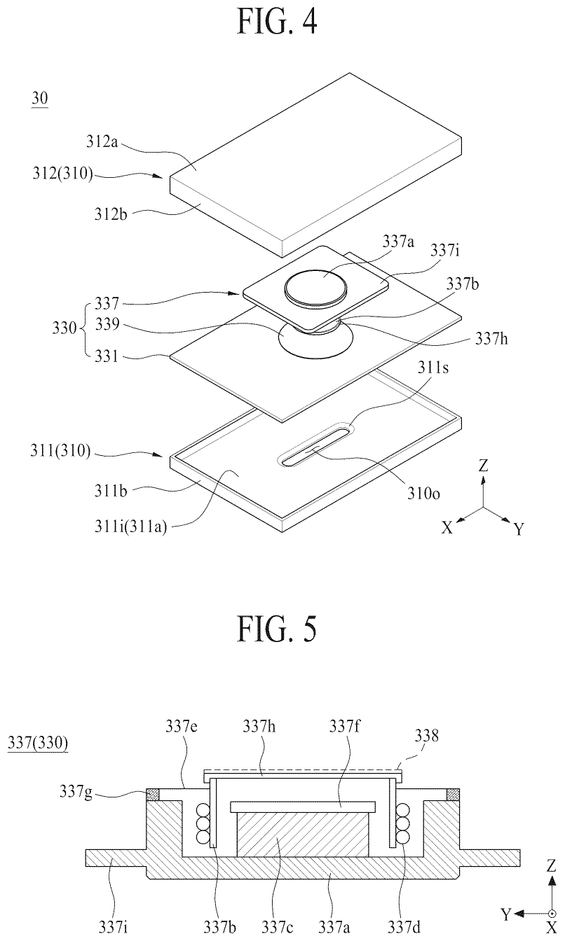

FIG. 3 illustrates a sound apparatus according to an embodiment of the present disclosure. FIG. 4 is an exploded perspective view of FIG. 3 according to an embodiment of the present disclosure.

With reference to FIGS. 3 and 4, the sound apparatus 30 (or a sound apparatus for vehicles) according to an embodiment of the present disclosure can be configured to vibrate a vibration object or a vehicle structure. For example, the sound apparatus 30 can be a sound generating apparatus, a sound output apparatus, a speaker apparatus, a car audio device, or an audio apparatus, but embodiments of the present disclosure are not limited thereto.

The sound apparatus 30 can be configured to be connected (or coupled) to the vibration object or the vehicle structure. For example, the sound apparatus 30 can be disposed at (or connected to) a portion of any one of the main structure 110, the exterior material 120, and the interior material 130 illustrated in FIG. 1 or 2 to generate (or output) a sound. For example, the sound apparatus 30 can vibrate any one of the main structure 110, the exterior material 120, and the interior material 130 illustrated in FIG. 1 or 2 to generate (or output) a sound.

The sound apparatus 30 according to an embodiment of the present disclosure can include an enclosure 310 and a sound generating module 330.

The enclosure 310 can be at the sound generating module 330. The enclosure 310 can be configured to support the sound generating module 330. The enclosure 310 can be configured to surround or cover the sound generating module 330. For example, the enclosure 310 can be configured to support the sound generating module 330 and surround the sound generating module 330. For example, the enclosure 310 can be configured to accommodate (or receive) the sound generating module 330. For example, the enclosure 310 can be a housing, a case, an outer case, a case member, a housing member, a cabinet, a sealing member, a sealing cap, a sealing box, a sound box, or the like, but embodiments of the present disclosure are not limited thereto.

The enclosure 310 can include an internal space 313. The internal space 313 can be configured to accommodate (or receive) the sound generating module 330. For example, the internal space 313 can be an accommodation space, a receiving space, a gap space, an air space, a vibration space, a sound space, a sound box, or a sealing space, or the like, but embodiments of the present disclosure are not limited thereto.

The enclosure 310 according to an embodiment of the present disclosure can include one or more materials of a metal material and a nonmetal material (or a composite nonmetal material), but embodiments of the present disclosure are not limited thereto. For example, the enclosure 310 can include one or more materials of a metal material, plastic, fiber, carbon, and wood, but embodiments of the present disclosure are not limited thereto. For example, the enclosure 310 can be configured in a metal material such as aluminum (Al) material, or configured in a plastic material such as plastic or styrene material, but embodiments of the present disclosure are not limited thereto. For example, the styrene material can be an ABS material. The ABS material can be acrylonitrile, butadiene, and styrene.

The enclosure 310 according to an embodiment of the present disclosure can include one or more enclosures (or enclosure members) 311 and 312. For example, the enclosure 310 can include a first enclosure 311 and a second enclosure 312.

The first enclosure (or a first enclosure member) 311 can be configured at a first surface (or a rear surface or a lower surface) of the sound generating module 330. The first enclosure 311 can be configured to support the first surface of the sound generating module 330. For example, the first enclosure 311 can be configured to cover the first surface of the sound generating module 330. For example, the first enclosure 311 can be configured to support a portion of the sound generating module 330. For example, the first enclosure 311 can be configured to cover at least a portion of the first surface of the sound generating module 330. For example, the first enclosure 311 can be configured to be connected or coupled to a portion of the sound generating module 330.

The first enclosure 311 according to an embodiment of the present disclosure can include a first plate 311a and a first sidewall 311b.

The first plate 311a can be configured at the first surface of the sound generating module 330. The first plate 311a can be configured to cover the first surface of the sound generating module 330. The first plate 311a can be disposed or configured spaced apart from the first surface of the sound generating module 330.

The first sidewall 311b can be connected to an edge portion (or a periphery portion) of the first plate 311a. The first sidewall 311b can be vertically connected to the edge portion of the first plate 311a. For example, the first sidewall 311b can be vertically connected to a first edge portion (or an inner edge portion or a first periphery portion) of the first plate 311a facing the first surface of the sound generating module 330. The first sidewall 311b can be configured to support a portion of the sound generating module 330. For example, the first sidewall 311b can be configured to be connected or coupled to a portion of the sound generating module 330.

The first sidewall 311b can be disposed between the first surface of the sound generating module 330 and the first plate 311a. The first sidewall 311b can provide a space 313b on an inner surface 311i of the first enclosure 311 or an inner surface 311i of the first plate 311a. Accordingly, the first surface of the sound generating module 330 can be spaced apart from the inner surface 311i of the first plate 311a by the first sidewall 311b.

The second enclosure (or a second enclosure member) 312 can be configured at a second surface, which is opposite to the first surface, of the sound generating module 330. The second enclosure 312 can be configured to support the second surface of the sound generating module 330. The second enclosure 312 can be configured to cover the second surface of the sound generating module 330. For example, the second enclosure 312 can be configured to support a portion of the sound generating module 330. For example, the second enclosure 312 can be configured to cover an entire second surface of the sound generating module 330. For example, the second enclosure 312 can be configured to surround the entire second surface of the sound generating module 330. For example, the second enclosure 312 can be connected or coupled to a portion of the sound generating module 330.

The second enclosure 312 according to an embodiment of the present disclosure can include a second plate 312a and a second sidewall 312b.

The second plate 312a can be configured to support the sound generating module 330. The second plate 312a can be configured to cover the second surface of the sound generating module 330. The second plate 312a can be configured to support the sound generating module 330 or support a portion of the second surface of the sound generating module 330.

The second sidewall 312b can be connected to an edge portion (or a periphery portion) of the second plate 312a. The second sidewall 312b can be vertically connected to the edge portion of the second plate 312a. For example, the second sidewall 312b can be vertically connected to a second edge portion (or an inner edge portion or a second periphery portion) of the second plate 312a facing the second surface of the sound generating module 330. The second sidewall 312b can be configured to support a portion of the sound generating module 330. For example, the second sidewall 312b can be configured to be connected or coupled to a portion of the sound generating module 330.

According to an embodiment of the present disclosure, the internal space 313 of the enclosure 310 can be between the first enclosure 311 and the second enclosure 312. For example, the internal space 313 of the enclosure 310 can be provided at a region between the first enclosure 311 and the sound generating module 330, and can be provided at a region between the second enclosure 312 and the sound generating module 330.

According to an embodiment of the present disclosure, the internal space 313 of the enclosure 310 can include a first space 313a and a second space 313b.

The first space 313a and the second space 313b can be spatially separated from each other by the sound generating module 330, but embodiments of the present disclosure are not limited thereto.

The first space 313a can include a space which is provided between the first enclosure 311 and the sound generating module 330. For example, the first space 313a can include a space which is provided between the first enclosure 311 and the first surface of the sound generating module 330. For example, the first space 313a can include a space which is provided between the inner surface 311i of the first plate 311a and the first surface of the sound generating module 330 by the first sidewall 311b of the first enclosure 311.

The second space 313b can include a space which is provided between the second enclosure 312 and the sound generating module 330. For example, the second space 313b can include a space which is surrounded by the second enclosure 312 among the second surface of the sound generating module 330. For example, the second space 313b can include a space which is surrounded by an inner surface 312i of the second plate 312a and the second sidewall 312b of the second enclosure 312 among the second surface of the sound generating module 330.

The sound generating module 330 can be configured to be accommodated (or received) into the internal space 313 of the enclosure 310. The sound generating module 330 can be configured to generate a sound (or a sound pressure level or a sound wave) in the internal space 313 of the enclosure 310. For example, the sound generating module 330 can be configured to be accommodated (or received) into the second space 313b of the internal space 313 of the enclosure 310. For example, the sound generating module 330 can be accommodated (or received) into the second space 313b of the internal space 313 of the enclosure 310 and can be configured to generate a sound (or a sound pressure level or a sound wave) in the first space 313a. For example, the sound generating module 330 can be a sound generating unit, a sound generating member, a sound reproduction module, a sound reproduction unit, a car audio module, a car audio unit, a speaker module, or a speaker unit, but embodiments of the present disclosure are not limited thereto.

The sound generating module 330 according to an embodiment of the present disclosure can be configured to generate or output a sound or a vibration. For example, the sound generating module 330 can be configured to output a sound or a vibration toward an interior space of a vehicle, based on driving (or vibration). For example, a sound or a vibration generated based on driving (or vibration) of the sound generating module 330 can be directly output to the interior space of the vehicle.

The sound generating module 330 according to another embodiment of the present disclosure can generate a sound, based on a vibration of a vibration object or a vehicle structure. For example, the sound generating module 330 can be configured to vibration the vehicle interior material. For example, the sound generating module 330 can generate or output a sound or a vibration, based on a vibration (or displacement) of the vehicle interior material. For example, a sound (or a sound wave) generated based on driving (or vibration) of the sound generating module 330 can vibrate the vehicle interior material, and a sound or a vibration generated based on a vibration of the vehicle interior material can be directly output to the interior space of the vehicle.

The sound generating module 330 according to another embodiment of the present disclosure can generate a sound, based on a vibration of the enclosure 310 and the vibration object (or the vehicle structure). For example, the sound generating module 330 can be configured to vibrate or indirectly vibrate the enclosure 310 and the vibration object (or the vehicle structure). For example, the sound generating module 330 can generate or output a sound or a vibration, based on a vibration (or displacement) of the enclosure 310 and the vehicle interior material. For example, a sound (or a sound wave) generated in the internal space 313 of the enclosure 310 based on driving (or vibration) of the sound generating module 330 can vibrate the enclosure 310, a vibration of the enclosure 310 can vibrate the vehicle interior material, and a sound or a vibration generated based on a vibration of the vehicle interior material can be output to the interior space of the vehicle.

According to another embodiment of the present disclosure, a portion of a sound (or a sound wave or a vibration) generated in the internal space 313 of the enclosure 310 based on driving (or vibration) of the sound generating module 330 can be directly output to the interior space of the vehicle, and the other of the sound (or the sound wave or the vibration) generated or output based on driving (or vibration) of the sound generating module 330 can vibrate one or more of the enclosure 310 and the vehicle interior material. A sound or a vibration generated based on the vibration of one or more of the enclosure 310 and the vehicle interior material can be output to the interior space of the vehicle.

The sound generating module 330 according to an embodiment of the present disclosure can include a vibration member 331 and a vibration apparatus 337.

The vibration member 331 can generate a vibration or can output a sound (or a sound wave or a sound pressure level) based on the driving (or vibration) of the vibration apparatus 337. For example, the vibration member 331 can be a diaphragm, a vibration plate, a vibration substrate, a vibration object, a vibration panel, a sound plate, a sound panel, a passive vibration plate, a passive vibration member, a passive vibration panel, a sound output plate, or a sound vibration plate, but embodiments of the present disclosure are not limited thereto.

The vibration member 331 can include a single nonmetal material or a composite nonmetal material. For example, the single nonmetal material or the composite nonmetal material of the vibration member 331 can include one or more materials of wood, rubber, plastic, carbon, glass, fiber, cloth, paper, mirror, and leather, but embodiments of the present disclosure are not limited thereto. For example, the paper can be cone paper for speakers. For example, the cone paper can be pulp or foamed plastic, or the like, but embodiments of the present disclosure are not limited thereto. For example, the vibration member 331 can be configured in a same material as the enclosure 310 or can be configured in a different material from the enclosure 310.

The vibration member 331 according to an embodiment of the present disclosure can be configured in a plastic material such as plastic material or styrene material, but embodiments of the present disclosure are not limited thereto.

The plastic material of the vibration member 331 can be configured in polyethylene terephthalate, polycarbonate, polyimide, polypropylene, polyarylate, polyethersulfone, polyethylene naphthalate, polysulfone, cyclo-olefin copolymer, or carbon fiber reinforced plastic (CFRP), or the like, but embodiments of the present disclosure are not limited thereto.

The styrene material of the vibration member 331 can be an ABS material. The ABS material can be acrylonitrile, butadiene, and styrene.

The vibration member 331 according to an embodiment of the present disclosure can include a porous material. For example, the vibration member 331 can include a micro cellular plastic material. For example, the vibration member 331 can be configured in a polyethylene terephthalate material or a polycarbonate material. For example, the vibration member 331 can be configured in a Micro Cellular polyethylene terephthalate (MCPET) material. The vibration member 331 configured in the MCPET can have capability to reproduce a high original sound because having a low density and an excellent elastic force, thereby enhancing the quality of a sound.

According to an embodiment of the present disclosure, the vibration member 331 can include a tetragonal shape, but embodiments of the present disclosure are not limited thereto. For example, the vibration member 331 can have a rectangular shape including a long side and a short side. For example, the vibration member 331 can include a first surface 331s1 and a second surface 331s2 different from (or opposite to) the first surface 331s1. For example, in the vibration member 331, the first surface 331s1 can be a rear surface, a backside surface, or a lower surface, and the second surface 331s2 can be a front surface or an upper surface. The first surface 331s1 of the vibration member 331 can be the first surface of the sound generating module 330.

The vibration member 331 can be supported by the first enclosure 311 and the second enclosure 312 of the enclosure 310. For example, the vibration member 331 can be configured to be supported by the first enclosure 311. The vibration member 331 can be disposed or configured between the first enclosure 311 and the second enclosure 312. The vibration member 331 can be configured to divide (or separate) the internal space 313 of the enclosure 310 into a first space 313a and a second space 313b. For example, the internal space 313 of the enclosure 310 can be divided (or separated) into the first space 313a and the second space 313b by the vibration member 331. For example, the first space 313a of the internal space 313 can be provided between the first enclosure 311 and the vibration member 331 and can be covered by the vibration member 331. The second space 313b of the internal space 313 can be provided between the second enclosure 312 and the vibration member 331.

The vibration apparatus 337 can be disposed or configured at the second space 313b of the internal space 313 of the enclosure 310 to vibrate (or displace) the vibration member 331. For example, the vibration apparatus 337 can be disposed or configured between the second enclosure 310 and the vibration member 331. For example, the vibration apparatus 337 can be disposed or configured between the second plate 312a of the second enclosure 312 and the second surface 331s2 of the vibration member 331.

The vibration apparatus 337 can be supported by or coupled to the enclosure 310 and connected or coupled to the vibration member 331. For example, the vibration apparatus 337 can be supported by or coupled to the second enclosure 312 and connected or coupled to the vibration member 331. For example, the vibration apparatus 337 can be supported by or coupled to the second plate 312a of the second enclosure 312 and can be connected or coupled to the second surface 331s2 of the vibration member 331. For example, the second surface 331s2 of the vibration member 331 at a periphery of the vibration apparatus 337 can be the second surface of the sound generating module 330.

The vibration apparatus 337 can vibrate (or displace or drive) based on a driving signal (or a vibration driving signal or a voice signal) applied thereto to vibrate (or displace or drive) the vibration member 331.

The vibration apparatus 337 according to an embodiment of the present disclosure can be a coil-type vibration apparatus or a coil-type actuator. For example, the vibration apparatus 337 can be configured to vibrate with a current (or a voice current) applied based on Fleming's left hand rule. For example, the vibration apparatus 337 can include a sound generator, a sound generating device, a vibration generating device, a sound wave generating device, a vibration generator, a vibration source, or a sound wave generator, or the like, but embodiments of the present disclosure are not limited thereto. For example, the vibration apparatus 337 can be configured with a sound actuator, a sound exciter, or a sound transducer or including a coil (or a voice coil) and a magnet.

The sound apparatus 30 or the sound generating module 330 according to an embodiment of the present can further include a fixing member 336.

The fixing member 336 can be configured to fix the vibration apparatus 337 to the enclosure 310. For example, the fixing member 336 can be configured to fix the vibration apparatus 337 to the second enclosure 312 or the second plate 312a of the second enclosure 312. Accordingly, the vibration apparatus 337 can be fixed (or supported) or connected (or coupled) to the second enclosure 312 or the second plate 312a of the second enclosure 312 by the fixing member 336.

The fixing member 336 according to an embodiment of the present can be an adhesive member (or a second adhesive member). The adhesive member can be disposed or connected between at least a portion of the vibration apparatus 337 and the second enclosure 312 (or the second plate 312a of the second enclosure 312). Accordingly, the vibration apparatus 337 can be fixed (or supported) or connected (or coupled) to the second enclosure 312 (or the second plate 312a) by the adhesive member. For example, the adhesive member can be configured in an adhesive, a double-sided tape, a double-sided sponge tape, a double-sided porous tape, or a double-sided cushion tape, or the like, but embodiments of the present disclosure are not limited thereto.

The fixing member 336 according to another embodiment of the present can include a plurality of screws (or a plurality of bolts). The plurality of screws can pass through at least a portion of the vibration apparatus 337 and can be fastened to the second enclosure 312 or the second plate 312a of the second enclosure 312. Therefore, the vibration apparatus 337 can be fixed (or supported) or connected (or coupled) to the second enclosure 312 or the second plate 312a of the second enclosure 312 by the plurality of screws.

The sound apparatus 30 or the sound generating module 330 according to an embodiment of the present can further include an adhesive member (or a first adhesive member) 338.

The adhesive member 338 can be disposed (or interposed) between the vibration member 331 and the vibration apparatus 337. The adhesive member 338 can be configured to connect (or couple) the vibration apparatus 337 to the vibration member 331. For example, the adhesive member 338 can be disposed or connected between the vibration apparatus 337 and the second surface 331s2 of the vibration member 331. Accordingly, the vibration apparatus 337 can be connected (or coupled) to the vibration member 331 by the adhesive member 338. For example, the vibration apparatus 337 can be attached to the vibration member 331 or the second surface 331s2 of the vibration member 331 by the adhesive member 338. For example, the adhesive member 338 can be configured in a double-sided tape, a double-sided foam tape, a double-sided pad, a double-sided foam pad, a conductive double-sided tape, a conductive double-sided foam tape, or a conductive adhesive, or the like, but embodiments of the present disclosure are not limited thereto.

The sound apparatus 30 or the sound generating module 330 according to an embodiment of the present can further include a heat dissipation plate 339.

The heat dissipation plate 339 can be disposed or connected between the vibration apparatus 337 of the sound generating module 330 and the vibration member 331. The heat dissipation plate 339 can be attached to the second surface 331s2 of the vibration member 331 to overlap the vibration apparatus 337 and can be coupled (or connected) to the vibration apparatus 337. The heat dissipation plate 339 can be connected (or coupled) to the vibration apparatus 337 by the adhesive member 338. For example, the vibration apparatus 337 can be attached or connected (or coupled) to the heat dissipation plate 339 by the adhesive member 338. The heat dissipation plate 339 can dissipate (or diffuse) heat generated when driving (or vibration) the vibration apparatus 337, toward the vibration member 331 and can thus prevent a reduction in performance of the vibration apparatus 337.

The heat dissipation plate 339 can be configured to have a size (or area) which is relatively greater than the vibration apparatus 337. The heat dissipation plate 339 can be formed of a metal material having high heat conductivity such as one material of aluminum (Al), copper (Cu), silver (Ag), and magnesium (Mg) or an alloy thereof or the like, but embodiments of the present disclosure are not limited thereto. For example, the heat dissipation plate 339 can be a heat diffusion member, a heat diffusion sheet, a heat diffusion layer, a heat diffusion plate, a heat sink, a heat dissipation sheet, or a heat dissipation layer, or the like, but embodiments of the present disclosure are not limited thereto.

The sound apparatus 30 according to an embodiment of the present disclosure can further include a coupling member 320.

The coupling member 320 can be configured to connect or couple the vibration member 331 and the enclosure 310 to each other. For example, the coupling member 320 can be between an edge portion (or a periphery portion) of the vibration member 331 and the enclosure 310. The coupling member 320 can include a first coupling member 321 and a second coupling member 322.

The first coupling member 321 can be between the vibration member 331 and the first enclosure 311. The first coupling member 321 can be connected or coupled between the edge portion of the vibration member 331 and the first enclosure 311. For example, the first sidewall 311b of the first enclosure 311 can be connected or coupled to the first surface 331s1 of the vibration member 331 by the first coupling member 321. For example, the first sidewall 311b of the first enclosure 311 can be connected or coupled to an edge portion of the first surface 331s1 of the vibration member 331 by the first coupling member 321.

The second coupling member 322 can be between the vibration member 331 and the second enclosure 312. The second coupling member 322 can be connected or coupled between the edge portion of the vibration member 331 and the second enclosure 312. For example, the second sidewall 312b of the second enclosure 312 can be connected or coupled to the second surface 331s2 of the vibration member 331 by the second coupling member 322. For example, the second sidewall 312b of the second enclosure 312 can be connected or coupled to an edge portion of the second surface 331s2 of the vibration member 331 by the second coupling member 322.

According to an embodiment of the present disclosure, the coupling member 320 can be configured to minimize or prevent the transfer of a vibration of the vibration member 331 to the first sidewall 311b of the first enclosure 311. The coupling member 320 can include a material characteristic suitable for blocking (or isolating or reducing) the transfer of a vibration of the vibration member 331 to the first sidewall 311b of the first enclosure 311. For example, the coupling member 320 can include a material having elasticity. For example, the coupling member 320 can include a material having elasticity for vibration absorption (or impact absorption). The coupling member 320 according to an embodiment of the present disclosure can be configured in silicone materials, polyurethane materials, or polyolefin materials, but embodiments of the present disclosure are not limited thereto. For example, the coupling member 320 can include one or more of an adhesive, a double-sided adhesive, a double-sided tape, a double-sided adhesive tape, a double-sided foam tape, a double-sided adhesive foam tape, a double-sided pad, a double-sided foam pad, a double-sided adhesive foam pad, and a double-sided cushion tape, but embodiments of the present disclosure are not limited thereto.

The sound apparatus 30 or the enclosure 310 according to an embodiment of the present disclosure can further include an opening part 310o.

The opening part 310o can be configured at the first enclosure 311 to overlap the sound generating module 330 with respect to a thickness direction Z (or a vertical direction) of the sound apparatus 30. The opening part 310o can be configured to pass through (or vertically pass through) the first enclosure 311 along a thickness direction Z (or a vertical direction) of the enclosure 310. For example, the opening part 310o can face or directly face the first surface of the sound generating module 330. The opening part 310o can be connected to (or communicated with) the internal space 313. For example, the opening part 310o can be connected to the first space 313a. For example, the internal space 313 of the enclosure 310 can include a space connected to the opening part 310o. For example, the internal space 313 of the enclosure 310 can include the first space 313a connected to the opening part 310o.

The opening part 310o can be configured to decrease an air pressure of the internal space 313 of the enclosure 310. The opening part 310o can be configured to decrease an air pressure of the first space 313a of the first enclosure 311 or an air pressure of the first space 313a provided between the vibration member 331 and the first enclosure 311. Therefore, a band of the low-pitched sound band can expand, and thus, a sound characteristic of the low-pitched sound band can be improved. For example, because a pressure (or air pressure) of the first space 313a is reduced by the opening part 310o, the amount of displacement (or a bending force) of the vibration member 331 disposed between the vibration member 331 and the first enclosure 311 can increase, and thus, a band of the low-pitched sound band can expand, thereby enhancing a sound characteristic and/or a sound pressure level characteristic of the low-pitched sound band. Accordingly, a sound (or a sound pressure level) of the low-pitched sound band generated based on vibration (or displacement) of the vibration apparatus 337 can be improved.

According to an embodiment of the present disclosure, the opening part 310o can be disposed to correspond to a center portion of the sound generating module 330. For example, the opening part 310o can be disposed to correspond to a center portion of the vibration apparatus 337. For example, the opening part 310o can include a line shape passing through the center portion of the vibration apparatus 337 or can include a rectangular shape. For example, the opening part 310o can be a hole, a slot, or a slit, but embodiments of the present disclosure are not limited thereto. For example, the opening part 310o can be a sound emission portion, a first sound emission port, a sound output part, a sound output port, a sound output hole, a duct hole, or a vent hole, but embodiments of the present disclosure are not limited thereto.

The opening part 310o can be a space where a sound (or a sound wave) generated in the internal space 313 of the enclosure 310 based on a vibration of the sound generating module 330 is output to an external space of the enclosure 310, for example, the interior space of the vehicle. For example, vibration or sound generated by vibration (or displacement) of the vibration member 331 based on vibration of the vibration apparatus 337 can be output (or emitted) into the interior space of the vehicle through the opening part 310o.

The first enclosure 311 of the enclosure 310 can further include a slope surface (or an inclined surface) 311s. The slope surface 311s can be configured to be inclined between the opening part 310o and the inner lateral surface 311i of the first enclosure 311. The slope surface 311s can be configured to guide a sound, generated based on a vibration of the sound generating module 330, to the interior space of the vehicle. Accordingly, the sound generated based on the vibration of the sound generating module 330 can be output to the interior space of the vehicle, and a sound characteristic and/or a sound pressure level characteristic of a sound including the low-pitched sound band can be more enhanced. For example, the slope surface 311s can be a guide surface or a sound guide surface, but embodiments of the present disclosure are not limited thereto.

According to another embodiment of the present disclosure, the vibration or the sound generated based on the vibration of the vibration member 331 based on the vibration of the vibration apparatus 337 can be transferred (or output or discharged) to the vehicle interior material through the opening part 310o, and the vehicle interior material can vibrate based on a vibration or a sound transferred through the opening part 310o to output a sound to the interior space of the vehicle. Accordingly, a sound can be generated based on a vibration of the vehicle interior material having a size which is greater than that of the sound apparatus 30, thereby enhancing a sound characteristic and/or a sound pressure level characteristic of a pitched sound band including a low-pitched sound band generated based on driving (or vibration) of the sound apparatus 30.

FIG. 5 is a cross-sectional view illustrating the vibration apparatus of the sound generating module illustrated in FIGS. 3 and 4 according to an embodiment of the present disclosure.

With reference to FIGS. 3 to 5, the vibration apparatus 337 according to an embodiment of the present disclosure can include a base frame 337a, a magnetic circuit part including a bobbin 337b, and a damper 337e. For example, the vibration apparatus 337 can include the base frame 337a, the bobbin 337b, a magnet 337c, a coil 337d, and the damper 337e.

The base frame 337a can be a main body of the vibration apparatus 337. The base frame 337a can support the magnet 337c. The base frame 337a can include a metal material having magnetism like iron (Fe). The base frame 337a can be referred to as a base plate, a lower plate, or a yoke, or the like, but embodiments of the present disclosure are not limited thereto.

The base frame 337a can include a groove portion which accommodates the magnet 337c and the bobbin 337b. The groove portion can be formed concavely from an upper surface of the base plate 337a to have a shape corresponding to a shape of each of the magnet 337c and the bobbin 337b.

The magnetic circuit part can be disposed at the base frame 337a and can be configured to vibrate (or displace) the vibration member 331. For example, the magnetic circuit part can include the magnet 337c, the bobbin 337b, and the coil 337d, which are disposed at the base frame 337a. For example, the magnetic circuit part can be a magnetic vibration part or a magnetic vibration unit, but embodiments of the present disclosure are not limited thereto.

The magnetic circuit part according to an embodiment of the present disclosure can have an external magnetic type structure or a dynamic magnetic type structure where the magnet 337c is disposed outward from the coil 337d (or the bobbin 337b), or can have an internal magnetic type structure or micro type structure where the magnet 337c is disposed inward from the coil 337d (or the bobbin 337b). The vibration apparatus 337 including the magnetic circuit part having the internal magnetic type structure can have a totally small size and a low leakage magnetic flux. The vibration apparatus 337 according to an embodiment of the present disclosure can have the external magnetic type structure or the internal magnetic type structure, and hereinafter, an example where the vibration apparatus 337 has the internal magnetic type will be described.

The magnet 337c can be accommodated or inserted into the groove portion of the base frame 337a. The magnet 337c can be a permanent magnet capable of being accommodated or inserted into the bobbin 337b.

The bobbin 337b can be disposed on the base frame 337a to surround around the magnet 337c. For example, the bobbin 337b can include a structure formed of a material obtained by processing pulp or paper, Al or magnesium (Mg) or an alloy thereof, or synthetic resin such as polyimide or the like. For example, the bobbin 337b can be implemented with a polyimide film which is relatively good in heat dissipation characteristic and is relatively lightweight.

The bobbin 337b can have a circular shape or an oval shape, but embodiments of the present disclosure are not limited thereto. For example, the oval shape of the bobbin 337b can have an elliptical shape, a rectangular shape with rounded corners, or non-circular curved shape having a width different from its height, but embodiments of the present disclosure are not limited thereto. For example, the bobbin 337b having the oval shape can improve a sound of a high-pitched sound band than the bobbin 337b having the circular shape and can decrease the occurrence of heat caused by a vibration, and thus, can have an excellent heat dissipation characteristic.

The bobbin 337b can be connected (or coupled) to the vibration member 331 by the adhesive member 338. For example, a front surface (or a front end portion) of the bobbin 337b can be attached to the second surface 331s2 of the vibration member 331 by the adhesive member 338. For example, when the sound apparatus 30 includes the heat dissipation plate 339 attached to the second surface 331s2 of the vibration member 331, the bobbin 337b can be connected to the heat dissipation plate 339 by the adhesive member 338.

The coil 337d can be wound to surround an outer circumference surface of the bobbin 337b and can be supplied with a sound-generating current (or a voice current) from the outside. The coil 337d can be lowered or raised together with the bobbin 337b. The coil 337d can be referred to as a voice coil. When a current is applied to the coil 337d, a whole portion of the bobbin 337b can move upward and downward according to Fleming's left hand rule based on an application magnetic field generated around the coil 337d and an external magnetic field generated around the magnet 337c, and a sound (or a sound wave) or a vibration can be generated by a vibration of the vibration member 331 based on a vertical movement (or vibration) of the bobbin 337b.

The damper 337e can be connected between the base frame 337a and the bobbin 337b. For example, the damper 337e can be a spider, a suspension, or an edge, or the like, but embodiments of the present disclosure are not limited thereto.

According to an embodiment of the present disclosure, one end (or one side) of the damper 337e can be connected to the base frame 337a, and the other end (or the other side) of the damper 337e can be connected to an outer surface of the bobbin 337b. The damper 337e can have a creased structure between the one end and the other end (or the other side) thereof and can be contracted and relaxed based on a vertical motion (or a vertical movement) of the bobbin 337b to control a vibration of the bobbin 337b. The damper 337e can limit a vibration distance of the bobbin 337b with a restoring force. For example, when the bobbin 337b vibrates by a certain distance or more or vibrates by a certain distance or less, the bobbin 337b can be restored to an original position by the restoring force of the damper 337e.

The vibration apparatus 337 according to an embodiment of the present disclosure can further include a center pole 337f and an edge frame 337g.

The center pole 337f can be accommodated or inserted into the bobbin 337b and can be configured to guide raising or lowering of the bobbin 337b. For example, since the center pole 337f can be accommodated or inserted into the bobbin 337b, an outer circumference surface of the center pole 337f can be surrounded by the bobbin 337b. For example, the center pole 337f can be an elevation guider or pole pieces, or the like, but embodiments of the present disclosure are not limited thereto.

The edge frame 337g can be disposed at a front edge (or a front periphery) of the base frame 337a. The edge frame 337g can be configured to support the one end of the damper 337e. For example, the damper 337e can be connected between the edge frame 337g and the bobbin 337b. The edge frame 337g according to an embodiment of the present disclosure can be provided at the front edge of the base frame 337a to have a certain height and the same shape as that of the bobbin 337b. The edge frame 337g according to another embodiment of the present disclosure can be provided at the front edge of the base frame 337a to have a certain height and can include a hollow part that is a same shape as that of the bobbin 337b.

According to an embodiment of the present disclosure, in the vibration apparatus 337, at least a portion of the base frame 337a can be fixed (or supported) or connected (or coupled) to the second enclosure 312 of the enclosure 310 (or the second plate 312a of the second enclosure 312) by the fixing member 336. As an embodiment, the fixing member 336 can include an adhesive member which is disposed (or interposed) between at least a portion of the base frame 337a and the second enclosure 312 of the enclosure 310 (or the second plate 312a of the second enclosure 312). As another embodiment, the fixing member 336 can include a plurality of screws which pass through at least a portion of the base frame 337a and are fastened to the second enclosure 312 of the enclosure 310 (or the second plate 312a of the second enclosure 312).

The sound apparatus 30 or the vibration apparatus 337 according to an embodiment of the present disclosure can further include an extension portion 337i.

The extension portion 337i can extend (or protrude) from a lateral surface of the base frame 337a. The extension portion 337i can be fixed (or supported) or connected (or coupled) to the second enclosure 312 of the enclosure 310 or the second plate 312a of the second enclosure 312 by the fixing member 336.

According to an embodiment of the present disclosure, when the fixing member 336 is an adhesive member (or a second adhesive member), the adhesive member can be disposed or connected between the extension portion 337i of the vibration apparatus 337 and the second enclosure 312 (or the second plate 312a of the second enclosure 312). Accordingly, the vibration apparatus 337 can be fixed (or supported) or connected (or coupled) to the second enclosure 312 or the second plate 312a of the second enclosure 312 by the adhesive member.

According to another embodiment of the present disclosure, when the fixing member 336 is a plurality of screws (or a plurality of bolts), the plurality of screws can pass through the extension portion 337i of the vibration apparatus 337 and can be fastened to the second enclosure 312 (or the second plate 312a of the second enclosure 312). Accordingly, the vibration apparatus 337 can be fixed (or supported) or connected (or coupled) to the second enclosure 312 or the second plate 312a of the second enclosure 312 by the plurality of screws.

According to another embodiment of the present disclosure, since the vibration apparatus 337 is disposed (or interposed) between the vibration member 331 and the second enclosure 312 (or the second plate 312a of the second enclosure 312), the vibration apparatus 337 should have a relatively thin thickness so as to thinly reduce a thickness of the sound apparatus 30 or slim the sound apparatus 30, and due to this, when a height (or a thickness) of the bobbin 337b is reduced, a sound pressure level can be lowered. Therefore, so as to solve a problem where a sound pressure level is lowered due to a reduction in height of the bobbin 337b, the inventors have designed a structure where an area of the damper 337e disposed around the bobbin 337b is wide. When an area of the damper 337e is enlarged, the inventors have recognized that a space where a line for applying a current to the coil 337c is disposed is narrowed, causing interference between the line and the damper 337e. Therefore, through various experiments, the inventors of the present disclosure have configured the damper 337e which is formed of a conductor and performs a function of the line.

The damper 337e according to another embodiment of the present disclosure can include a metal material electrically connected to the coil 337c. For example, the damper 337e can be configured in a metal material such as stainless steel or copper (Cu), or the like, but embodiments of the present disclosure are not limited thereto.

The sound apparatus 30 or the vibration apparatus 337 according to an embodiment of the present disclosure can further include a protection member 337h.

The protection member 337h can be configured to protect the bobbin 337b from an impact or prevent the deformation of the bobbin 337b caused by an impact. The protection member 337h can be configured to protect the bobbin 337b and transfer a vibration of the bobbin 337b to the vibration member 331. The protection member 337h can vibrate together with the bobbin 337b. The protection member 337h can be disposed (or interposed) between the vibration member 331 and the bobbin 337b. The protection member 337h can be configured on the front surface (or the front end portion) of the bobbin 337b to protect the front surface (or the front end portion) of the bobbin 337b. The protection member 337h can transmit raising or lowering (or vibration) of the bobbin 337b to the vibration member 331. The protection member 337h according to an embodiment of the present disclosure can have a ring shape connected to (or attached at) the front surface of the bobbin 337b, a circular plate shape (or a disc shape) covering an entire front surface of the bobbin 513b2, or a cap shape surrounding the front surface and an upper outer surface of the bobbin 337b. For example, the protection member 337h can be a bobbin protection member, an intermediate member, or a bobbin ring, but embodiments of the present disclosure are not limited thereto.

The protection member 337h can be connected (or coupled) to the vibration member 331 by the adhesive member 338. For example, the protection member 337h can be attached to the second surface 331s2 of the vibration member 331 by the adhesive member 338. For example, when the sound apparatus 30 includes the heat dissipation plate 339 attached to the second surface 331s2 of the vibration member 331, the protection member 337h can be connected to the heat dissipation plate 339 by the adhesive member 338.

According to an embodiment of the present disclosure, a vibration width (or a displacement width or a driving width) of the vibration apparatus 337 based on a coil type can be relatively greater than a vibration width (or a displacement width or a driving width) of a vibration apparatus based on a piezoelectric type, and thus, the vibration apparatus 337 based on the coil type can enhance a sound characteristic and/or a sound pressure level characteristic of a pitched sound band including a low-pitched sound band generated based on a vibration of the vibration member 331. Accordingly, the sound apparatus 30 according to an embodiment of the present disclosure can vibrate the vibration member 331 to output a sound, based on a vibration of the vibration apparatus 337 of the coil type where a sound characteristic and/or a sound pressure level characteristic of a low-pitched sound band are/is relatively better than a piezoelectric-type vibration apparatus, thereby enhancing a sound characteristic and/or a sound pressure level characteristic of a pitched sound band including a low-pitched sound band.

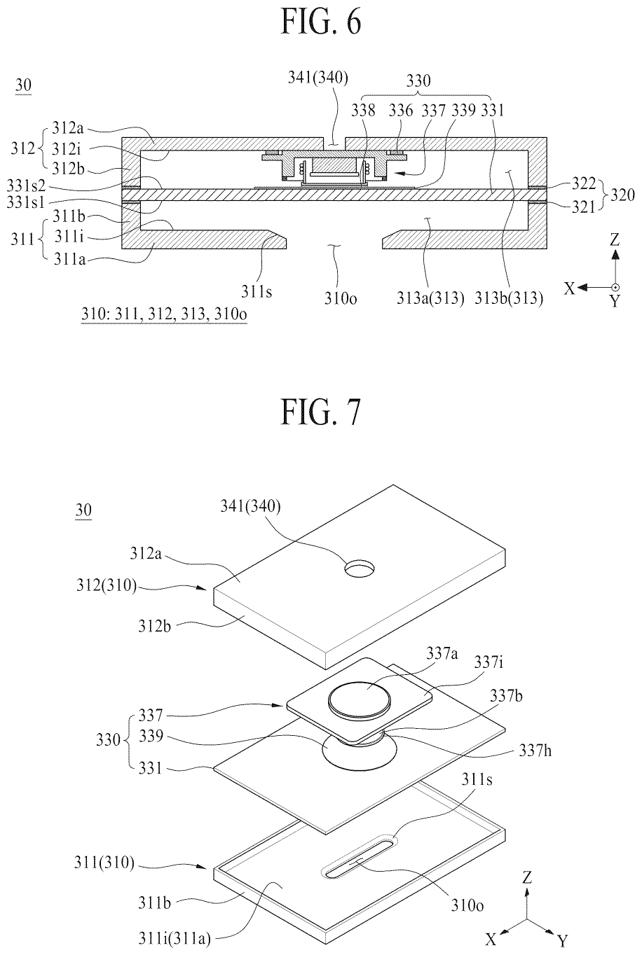

FIG. 6 illustrates a sound apparatus according to another embodiment of the present disclosure. FIG. 7 is an exploded perspective view of the sound apparatus illustrated in FIG. 6 according to an embodiment of the present disclosure.

With reference to FIGS. 6 and 7, a sound apparatus 30 according to another embodiment of the present disclosure can include an enclosure 310, a sound generating module 330, and a coupling member 320. Descriptions of the enclosure 310, the sound generating module 330, and the coupling member 320 can be substantially a same as the descriptions of FIGS. 3 to 5, and thus, like reference numerals refer to like elements and repeated descriptions are omitted or will be briefly given below.

The sound apparatus 30 or the enclosure 310 according to another embodiment of the present disclosure can further include a heat dissipation part 340.

The heat dissipation part 340 can be configured to dissipate heat, occurring due to driving (or vibration) of the sound generating module 330, to an outside. For example, the heat dissipation part 340 can be configured to dissipate heat, occurring due to driving (or vibration) of the vibration apparatus 337 in the sound generating module 330, to the outside of the enclosure 310.

The heat dissipation part 340 according to an embodiment of the present disclosure can be configured to pass through a portion of the enclosure 310 which overlaps the vibration apparatus 337. The heat dissipation part 340 can be configured to pass through a portion of the second enclosure 312 of the enclosure 310 which is connected to the vibration apparatus 337 and overlaps the vibration apparatus 337. For example, the heat dissipation part 340 can be configured to vertically pass through a portion of the second plate 312b of the second enclosure 312 which is connected to the vibration apparatus 337 and overlaps the vibration apparatus 337. For example, the heat dissipation part 340 can include one or more holes 341.

The one or more holes (or heat dissipation holes) 341 can be configured to pass through a portion of the second plate 312b of the second enclosure 312 overlapping or facing the base frame 337a of the vibration apparatus 337. The one or more holes 341 can be configured to expose at least a portion of the base frame 337a of the vibration apparatus 337 at an external space of the enclosure 310. For example, at least a portion of a rear surface of the base frame 337a of the vibration apparatus 337 can be directly exposed at the external space of the enclosure 310 through the one or more holes 341 of the heat dissipation part 340.

The one or more holes 341 can include any one of a circular shape, an oval shape, and a slit shape, but embodiments of the present disclosure are not limited thereto. A size (or an area) of the heat dissipation part 340 including the one or more holes 341 can be smaller than a size (or an area) of the vibration apparatus 337, but embodiments of the present disclosure are not limited thereto. For example, a total size (or area) of the heat dissipation part 340 including the one or more holes 341 can be smaller than a size (or an area) of the bobbin 337b of the vibration apparatus 337.

According to an embodiment of the present disclosure, heat generated based on driving (or vibration) of the vibration apparatus 337 can be dissipated to the external space of the enclosure 310 through the one or more holes 341, thereby preventing the performance of the vibration apparatus 337 from being reduced by heat occurring when driving (or vibrating) the vibration apparatus 337.

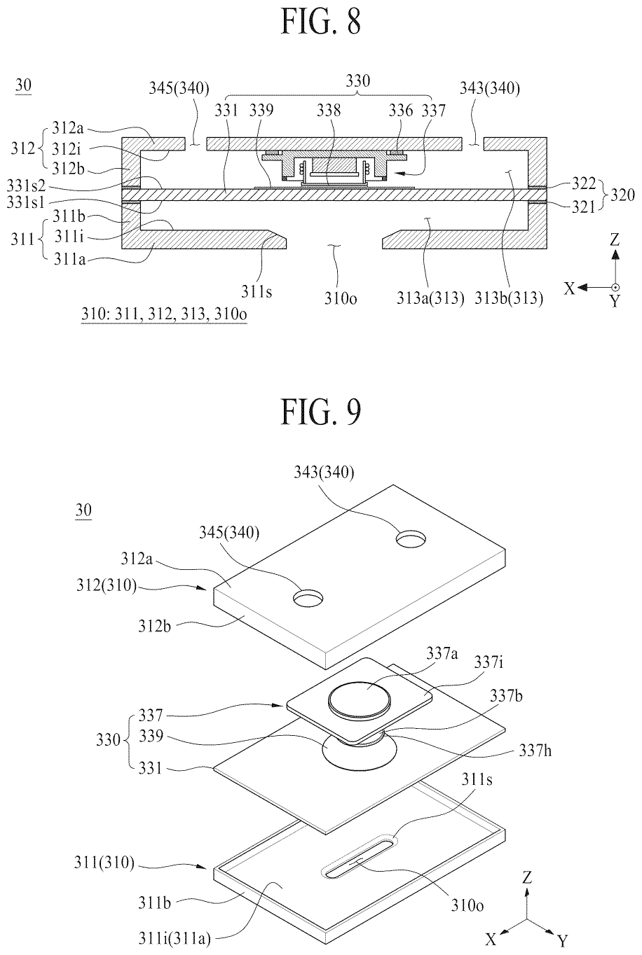

FIG. 8 illustrates a sound apparatus according to another embodiment of the present disclosure. FIG. 9 is an exploded perspective view of the sound apparatus illustrated in FIG. 8 according to an embodiment of the present disclosure.

With reference to FIGS. 8 and 9, a sound apparatus 30 according to another embodiment of the present disclosure can include an enclosure 310, a sound generating module 330, and a coupling member 320. Descriptions of the enclosure 310, the sound generating module 330, and the coupling member 320 can be substantially a same as the descriptions of FIGS. 3 to 5, and thus, like reference numerals refer to like elements and repeated descriptions are omitted or will be briefly given below.

The sound apparatus 30 according to another embodiment of the present disclosure can further include a heat dissipation part 340.

The heat dissipation part 340 according to another embodiment of the present disclosure can be spaced apart from the vibration apparatus 337 and can be configured to pass through a portion of the enclosure 310 facing the vibration member 331. For example, the heat dissipation part 340 can be configured to pass through a portion of the second enclosure 312 of the enclosure 310 facing the vibration member 331 at a periphery of the vibration apparatus 337. For example, the heat dissipation part 340 can be configured to vertically pass through a portion of the second plate 312b of the second enclosure 312 facing the vibration member 331 at a periphery of the vibration apparatus 337. For example, the heat dissipation part 340 can include one or more first holes 343 and one or more second holes 345.

The one or more first holes (or first heat dissipation holes) 343 and the one or more second holes (or second heat dissipation holes) 345 can be formed (or disposed) in parallel with the vibration apparatus 337 therebetween. For example, the one or more first holes 343 can be formed (or disposed) at a region between the second enclosure 312 and a first lateral surface of the vibration apparatus 337. The one or more second holes 345 can be formed (or disposed) at a region between the second enclosure 312 and a second lateral surface, which is opposite to a first lateral surface, of the vibration apparatus 337. For example, the heat dissipation part 340 can include a pair of holes (or a pair of heat dissipation holes) 343 and 345 which are parallel to each other with the vibration apparatus 337 therebetween.

The one or more first holes 343 and the one or more second holes 345 can be configured to vertically pass through a portion of the second plate 312b of the second enclosure 312 facing the vibration member 331 at a periphery of the vibration apparatus 337. Accordingly, a second internal space 313b among the internal space 313 of the enclosure 310 can be connected to (or communicated with) the external space of the enclosure 310 through the one or more first holes 343 and the one or more second holes 345.

The one or more first holes 343 and the one or more second holes 345 can include any one of a circular shape, an oval shape, and a slit shape, but embodiments of the present disclosure are not limited thereto. A size (or an area) of the heat dissipation part 340 including the one or more first holes 343 and the one or more second holes 345 can be smaller than a size (or an area) of the vibration apparatus 337, but embodiments of the present disclosure are not limited thereto. For example, a total size (or area) of the heat dissipation part 340 including the one or more first holes 343 and the one or more second holes 345 can be smaller than a size (or an area) of the bobbin 337b of the vibration apparatus 337.

According to an embodiment of the present disclosure, heat generated based on driving (or vibration) of the vibration apparatus 337 can be dissipated to the external space of the enclosure 310 through the one or more first holes 343 and the one or more second holes 345, thereby preventing the performance of the vibration apparatus 337 from being reduced by heat occurring when driving (or vibrating) the vibration apparatus 337.

According to an embodiment of the present disclosure, the heat dissipation part 340 can be a path through which air of the internal space 313 of the enclosure 310 as well as heat occurring in the vibration apparatus 337 is dissipated to the external space of the enclosure 310. For example, in a case where a lot of air in the internal space 313 of the enclosure 310 is dissipated through the heat dissipation part 340, a sound characteristic and/or a sound pressure level characteristic of the sound apparatus 30 can be reduced. Accordingly, the one or more first holes 343 and the one or more second holes 345 of the heat dissipation part 340 can have a size (or area) which minimizes the amount of air dissipated from the internal space 313 of the enclosure 310 to the external space of the enclosure 310 and dissipates, to the external space of the enclosure 310, heat occurring in the vibration apparatus 337 and/or heat of the internal space 313 of the enclosure 310.

According to an embodiment of the present disclosure, heat generated based on driving (or vibration) of the vibration apparatus 337 can be dissipated to the external space of the enclosure 310 through the one or more first holes 343 and the one or more second holes 345, thereby preventing the performance of the vibration apparatus 337 from being reduced by heat occurring when driving (or vibrating) the vibration apparatus 337.

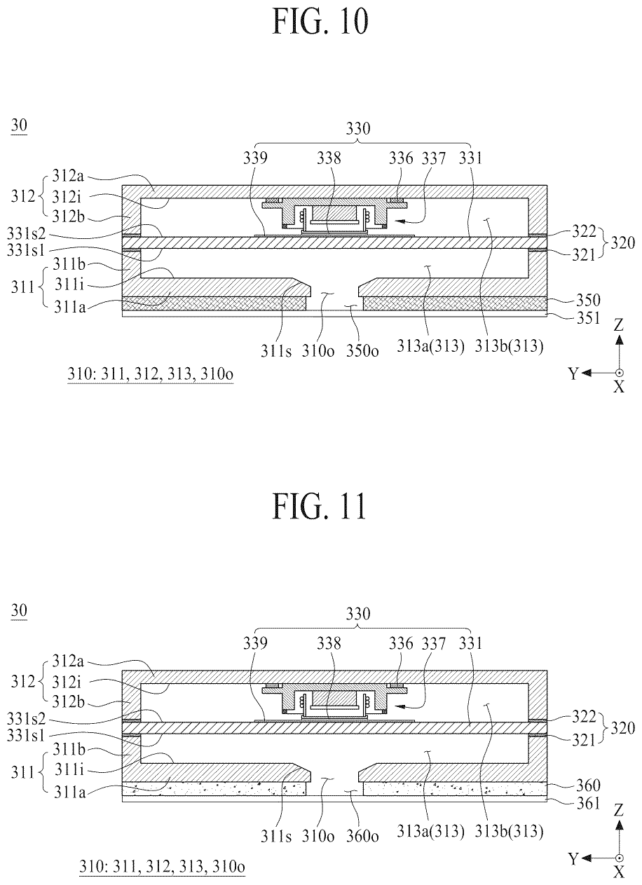

FIG. 10 illustrates a sound apparatus according to another embodiment of the present disclosure.

With reference to FIG. 10, a sound apparatus 30 according to another embodiment of the present disclosure can include an enclosure 310, a sound generating module 330, and a coupling member 320. Descriptions of the enclosure 310, the sound generating module 330, and the coupling member 320 can be substantially a same as the descriptions of FIGS. 3 to 9, and thus, like reference numerals refer to like elements and repeated descriptions are omitted or will be briefly given.

The sound apparatus 30 according to another embodiment of the present disclosure can further include a connection member 350.

The connection member 350 can be provided or configured between a vibration object and the sound apparatus 30. The connection member 350 can be provided or configured at a rear surface of the sound apparatus 30. For example, the connection member 350 can be provided or configured at a rear surface of the enclosure 310. For example, the connection member 350 can be provided or configured at a rear surface of the first enclosure 311. For example, the connection member 350 can be disposed between a vehicle interior material (or a mount object) and the enclosure 310. For example, the connection member 350 can be disposed between the vehicle interior material (or the mount object) and the first enclosure 311. For example, the mount object can be a structure with the sound apparatus 30 or the enclosure 310 mounted thereon. For example, the connection member 350 can be provided or configured between the sound apparatus 30 (or the vehicle interior material 130) and the enclosure 310 illustrated in FIG. 1 or 2. For example, the connection member 350 can be a first connection member, a first intermediate member, a first buffer member, or a first pad member, but embodiments of the present disclosure are not limited thereto.

The connection member 350 can be configured to transfer a vibration of the first enclosure 311 based on a vibration of the sound generating module 330 to the vehicle interior material 130. Accordingly, the vehicle interior material 130 can vibrate based on a vibration transferred through the connection member 350 to generate (or output) a sound.

According to another embodiment of the present disclosure, the first enclosure 311 can include an inner surface 311i and an outer surface. The inner surface 311i of the first enclosure 311 can face a vibration member 331. The outer surface of the first enclosure 311 can be a surface which is opposite to the inner surface 311i of the first enclosure 311. The connection member 350 can be connected to a periphery of an opening part 310o of the outer surface of the first enclosure 311.

According to another embodiment of the present disclosure, the connection member 350 can be configured as a stiff material (or a hard material). The connection member 350 can have high elasticity (or a Young's modulus) and can include a material which is high in tensile strength. For example, the connection member 350 can include rubber, but embodiments of the present disclosure are not limited thereto. For example, the rubber can be ethylene propylene rubber or urethane rubber, but embodiments of the present disclosure are not limited thereto. For example, the ethylene propylene rubber can be ethylene propylene diene monomer (EPDM), but embodiments of the present disclosure are not limited thereto. For example, a hardness of the EPDM can be 40 to 90, but embodiments of the present disclosure are not limited thereto. For example, a tensile strength of the EPDM can be 50 kg/cm² to 200 kg/cm², but embodiments of the present disclosure are not limited thereto.

According to an embodiment of the present disclosure, the connection member 350 can further include a hole 3500. For example, the connection member 350 can further include a hole 3500 which is connected to the opening part 310o in the enclosure 310 or the first enclosure 311. The hole 3500 can be disposed to correspond to (or overlap) the opening part 310o. Accordingly, a sound based on a vibration of the sound generating module 330 can be output to an interior space of a vehicle by (or through) the opening part 310o and the hole 3500. The hole 3500 can have a same shape as the opening part 310o, but embodiments of the present disclosure are not limited thereto. For example, the hole 3500 can be a through hole, a first through hole, an opening part, an opening hole, a slit, a slot, a connection hole, or an intermediate hole, but embodiments of the present disclosure are not limited thereto

According to an embodiment of the present disclosure, the connection member 350 can be protected by a release film (or a protection film) 351. The release film 351 can be attached to an adhesive surface of the connection member 350. In a case where the sound apparatus 30 including the connection member 350 is mounted on the vehicle interior material (or the mount object) 130, the release film 351 can be released (or removed) from the connection member 350.

The connection member 350 according to an embodiment of the present disclosure can be disposed (or interposed) between the vehicle interior material 130 and the sound apparatus 30. Accordingly, a shaking sound (or a trilling sound) may not occur between the vehicle interior material 130 and the sound apparatus 30, and thus, a sound characteristic and/or a sound pressure level characteristic of the sound apparatus 30 can be improved. In addition, the connection member 350 can reduce the heat generated when the sound generation module 330 vibrates. Furthermore, because the sound apparatus 30 is coupled to or mounted on the vehicle interior material 130 by the coupling part 500, a shaking sound (or a trilling sound) may not occur between the sound apparatus 30 and the vehicle interior material 130, and thus, a sound characteristic and/or a sound pressure level characteristic of the sound apparatus 30 can be improved.

FIG. 11 illustrates a sound apparatus according to another embodiment of the present disclosure.

With reference to FIG. 11, a sound apparatus 30 according to another embodiment of the present disclosure can include an enclosure 310, a sound generating module 330, and a coupling member 320. Descriptions of the enclosure 310, the sound generating module 330, and the coupling member 320 can be substantially a same as the descriptions of FIGS. 3 to 9, and thus, like reference numerals refer to like elements and repeated descriptions are omitted or will be briefly given.

The sound apparatus 30 according to another embodiment of the present disclosure can further include a soft member (or a ductile member) 360.

The soft member 360 can be provided or configured between a vibration object and the sound apparatus 30. The soft member 360 can be provided or configured at a rear surface of the sound apparatus 30. For example, the soft member 360 can be provided or configured at a rear surface of the enclosure 310. For example, the soft member 360 can be provided or configured at a rear surface of the first enclosure 311. For example, the soft member 360 can be disposed between a vehicle interior material (or a mount object) and the enclosure 310. For example, the soft member 360 can be disposed between the vehicle interior material (or the mount object) and the first enclosure 311. For example, the mount object can be a structure with the sound apparatus 30 or the enclosure 310 mounted thereon. For example, the soft member 360 can be provided or configured between the sound apparatus 30 (or the vehicle interior material 130) and the enclosure 310 illustrated in FIG. 1 or 2. For example, the soft member 360 can be a second connection member, a second intermediate member, a second buffer member, or a second pad member, but embodiments of the present disclosure are not limited thereto.

According to another embodiment of the present disclosure, the first enclosure 311 can include an inner surface 311i and an outer surface. The inner surface 311i of the first enclosure 311 can face a vibration member 331. The outer surface of the first enclosure 311 can be a surface which is opposite to the inner surface 311i of the first enclosure 311. The soft member 360 can be connected to a periphery of an opening part 310o of the outer surface of the first enclosure 311.

According to an embodiment of the present disclosure, the soft member 360 can be configured as a material which differs from a connection member 350 described above with reference to FIG. 6. An elasticity (or a Young's modulus) of the soft member 360 can be configured as a material which differs from an elasticity (or a Young's modulus) of the connection member 350. For example, the soft member 360 can be configured as a material having low elasticity. The soft member 360 can be configured as a smooth material (or a soft material). For example, the soft member 360 can be ethylene propylene rubber or urethane rubber, but embodiments of the present disclosure are not limited thereto. For example, the ethylene propylene rubber can be ethylene propylene diene monomer (EPDM), and as a foaming rate is changed in EPDM, the ethylene propylene rubber can be configured as EPDM having low elasticity, but embodiments of the present disclosure are not limited thereto. For example, the soft member 360 can include a single-sided tape, a single-sided sponge tape, a single-sided porous tape, a single-sided cushion tape, a double-sided tape, a double-sided sponge tape, a double-sided porous tape, or a double-sided cushion tape, or the like, but embodiments of the present disclosure are not limited thereto.

According to an embodiment of the present disclosure, the soft member 360 can further include a hole 3600. For example, the soft member 360 can further include a hole 3600 which is connected to the opening part 310o. The hole 3600 can be disposed to correspond to the opening part 310o. Accordingly, a sound based on a vibration of the sound generating module 330 can be output to an interior space IS of a vehicle 10 by (or through) the opening part 310o and the hole 3600. The hole 3600 can have a same shape as the opening part 310o, but embodiments of the present disclosure are not limited thereto. For example, the hole 3600 can be a through hole, a first through hole, an opening part, an opening hole, a slit, a slot, a connection hole, or an intermediate hole, but embodiments of the present disclosure are not limited thereto. The soft member 360 according to an embodiment of the present disclosure can absorb an external impact, and thus, can protect the sound apparatus 30 from the external impact.

According to an embodiment of the present disclosure, the soft member 360 can be protected by a release film (or a protection film) 361. The release film 361 can be attached to an adhesive surface of the soft member 360. In a case where the sound apparatus 30 including the soft member 360 is mounted on the vehicle interior material (or the mount object) 130, the release film 361 can be released (or removed) from the soft member 360.

The soft member 360 according to an embodiment of the present disclosure can absorb an external impact, and thus, can prevent the damage of the sound generating module 330. Accordingly, the durability and reliability of the sound apparatus 30 can be enhanced.

According to another embodiment of the present disclosure, the soft member 360 can be configured at the enclosure 310 instead of the connection member 350 described above with reference to FIG. 7, or can be stacked on the connection member 350. For example, the connection member 350 and the soft member 360 can be disposed between the first enclosure 311 and the vehicle interior material (or the mount object) 130. For example, the connection member 350 can be connected to the first enclosure 311, and the soft member 360 can be disposed between the connection member 350 and the vehicle interior material (or the mount object) 130.

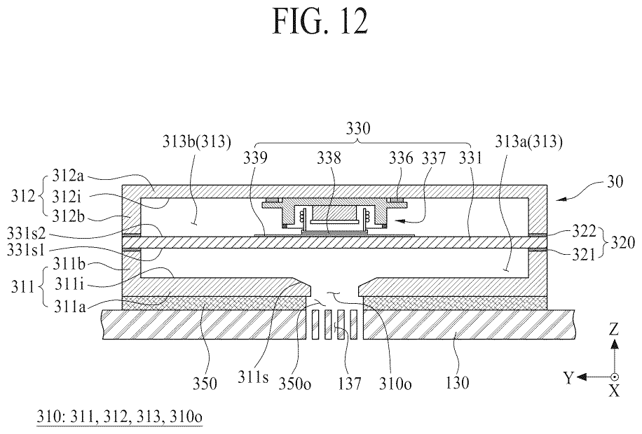

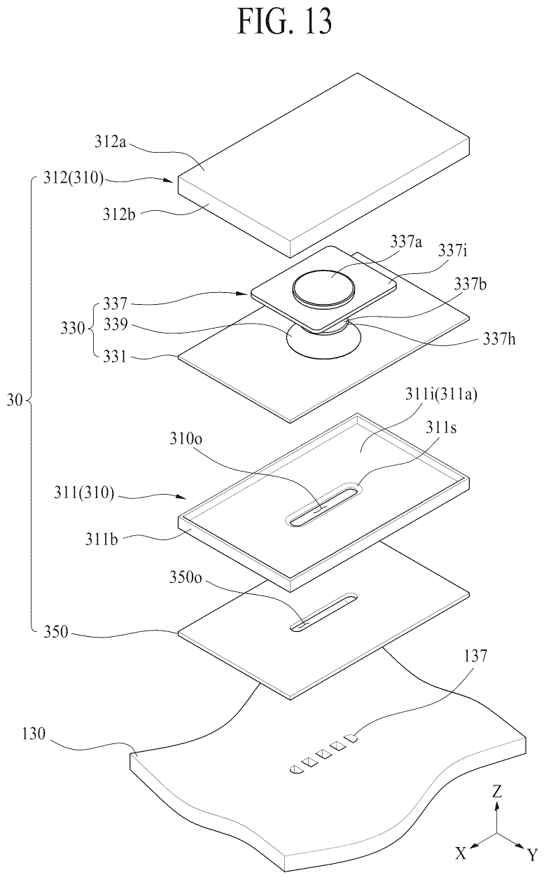

FIG. 12 illustrates a sound apparatus according to another embodiment of the present disclosure. FIG. 13 is an exploded perspective view of the sound apparatus illustrated in FIG. 12 according to another embodiment of the present disclosure.

With reference to FIGS. 12 and 13, a sound apparatus 30 according to another embodiment of the present disclosure can include an enclosure 310, a sound generating module 330, and a coupling member 320. Descriptions of the enclosure 310, the sound generating module 330, and the coupling member 320 can be substantially a same as the descriptions of FIGS. 3 to 10, and thus, like reference numerals refer to like elements and repeated descriptions are omitted or will be briefly given below.

The sound apparatus 30 according to another embodiment of the present disclosure can further include a connection member 350. A description of the connection member 350 can be substantially a same as the description of FIG. 9, and thus, repeated descriptions are omitted or will be briefly given below.

The connection member 350 according to another embodiment of the present disclosure can be disposed at a rear surface of the enclosure 310. The connection member 350 can be disposed between a vehicle interior material 130 and the enclosure 310. For example, the connection member 350 can be disposed between the vehicle interior material 130 and the first enclosure 311. For example, the vehicle interior material 130 can be connected or coupled to the enclosure 310 by the connection member 350. For example, the vehicle interior material 130 can be connected or coupled to a rear surface of the first enclosure 311 by the connection member 350. Accordingly, the sound apparatus 30 or the enclosure 310 can be connected or coupled to the vehicle interior material 130 by the connection member 350.

According to an embodiment of the present disclosure, the connection member 350 can include a relatively stiff material (or a hard material), and thus, can transfer a vibration of a first enclosure 311, based on a vibration of a vibration apparatus, to a vehicle interior material 130. Accordingly, the vehicle interior material 130 can vibrate based on a vibration transferred through the connection member 350 to generate a sound. For example, when the connection member 350 includes the relatively stiff material (or the hard material), the vehicle interior material 130 connected to the connection member 350 can be a vibration plate for generating (or outputting) a sound. For example, when the connection member 350 includes the relatively stiff material (or the hard material), a vibration of the first enclosure 311 can be transmitted to the vehicle interior material 130 more efficiently.

According to an embodiment of the present disclosure, the connection member 350 can further include a hole 3500. For example, the connection member 350 can further include the hole 3500 which is connected to an opening part 310o in the enclosure 310. The hole 3500 can be disposed to correspond to the opening part 310o. The hole 3500 can have a same shape as the opening part 310o, but embodiments of the present disclosure are not limited thereto.

According to an embodiment of the present disclosure, the vehicle interior material 130 can further include one or more holes 137. The vehicle interior material 130 can include a plurality of holes 137. For example, one hole 137 can correspond to (or overlap) the opening part 310o and the hole 3500. For example, one hole 137 can have a size which is greater than or equal to the opening part 310o and have a same size as the hole 3500. For example, the plurality of holes 137 can be disposed at equal or different intervals (or distances). The hole 137 can be disposed to correspond to (or overlap) the opening part 310o and/or the hole 3500. For example, the hole 137 can be accommodated in (or within) the opening part 310o and/or the hole 3500. For example, the hole 137 can be a through hole, a third through hole, an opening part, an opening hole, a slit, a slot, a sound hole, a sound emission hole, or a sound output hole, but embodiments of the present disclosure are not limited thereto.

According to an embodiment of the present disclosure, a sound generated based on a vibration of the sound generating module 330 can be output to an interior space of a vehicle through the opening part 310o, the hole 3500, and the hole 137. In addition, the sound apparatus 30 or the enclosure 310 can vibrate the vehicle interior material 130 by the connection member 350 to output a sound based on a vibration of the vehicle interior material 130 to the interior space of the vehicle.

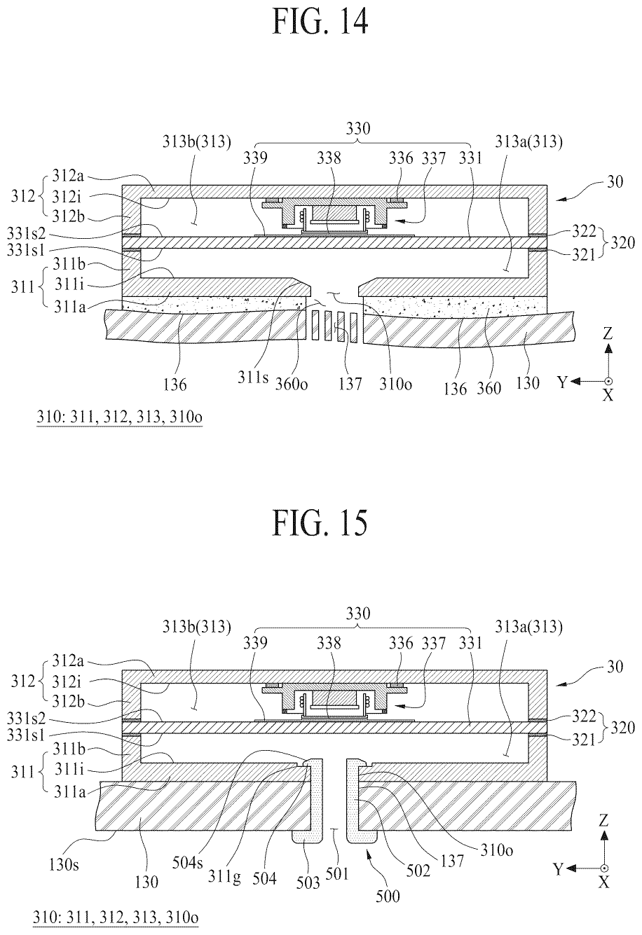

FIG. 14 illustrates a sound apparatus according to another embodiment of the present disclosure.

With reference to FIG. 14, a sound apparatus 30 according to another embodiment of the present disclosure can include an enclosure 310, a sound generating module 330, and a coupling member 320. Descriptions of the enclosure 310, the sound generating module 330, and the coupling member 320 can be substantially a same as the descriptions of FIGS. 3 to 9 and 11, and thus, like reference numerals refer to like elements and repeated descriptions are omitted or will be briefly given below.

The sound apparatus 30 according to another embodiment of the present disclosure can further include a soft member 360. A description of the soft member 360 can be substantially a same as the description of FIG. 11, and thus, repeated descriptions are omitted or will be briefly given below.

The soft member 360 according to another embodiment of the present disclosure can be disposed at a rear surface of the enclosure 310. For example, the soft member 360 can be disposed between a vehicle interior material 130 and the enclosure 310. For example, the soft member 360 can be disposed between the vehicle interior material 130 and the first enclosure 311. For example, the vehicle interior material 130 can be connected to or coupled to the enclosure 310 by the soft member 360. For example, the vehicle interior material 130 can be connected to or coupled to a rear surface of the first enclosure 311 by the soft member 360. Accordingly, the sound apparatus 30 or the enclosure 310 can be connected to or coupled to the vehicle interior material 130 by the soft member 360.

The vehicle interior material 130 according to another embodiment of the present disclosure can include one or more curved portions (or flexural portions or uneven portions) 136. The soft member 360 can be configured to correspond to the one or more curved portions 136. The soft member 360 can contact with the one or more curved portions 136. For example, the vehicle interior material 130 can include one or more curved portions 136 which contacts the soft member 360. The soft member 360 can contact an entire vibration region of the vehicle interior material 130. The soft member 360 can directly contact an entire vibration region of the vehicle interior material 130. The soft member 360 can directly contact the one or more curved portions 136.

According to an embodiment of the present disclosure, the soft member 360 can directly contact the one or more curved portions 136 without a separate adhesive member or a separate intermediate member (or medium). For example, the soft member 360 can directly contact the entire vibration region of the vehicle interior material 130 without a separate adhesive member or a separate intermediate member (or medium). A vibration generated by the sound generating module 330 can be transferred, by the soft member 360, to the entire vibration region of the vehicle interior material 130 including the one or more curved portions 136 and a planar portion. Accordingly, a sound can be generated (or output) based on a vibration of the entire vibration region of the vehicle interior material 130, thereby enhancing a sound characteristic and/or a sound pressure level characteristic of a sound band including a low-pitched sound band generated by the sound generating module 330.

According to an embodiment of the present disclosure, the soft member 360 can include a relatively smooth material (or a soft material), for a connection (or coupling) with the vehicle interior material 130 including the one or more curved portions 136 and the planar portion. For example, when the one or more curved portions 136 includes the vibration region of the vehicle interior material 130, the soft member 360 can include the relatively smooth material. For example, the soft member 360 which is configured in the relatively smooth material can be a ductile member, a porous member or a buffer member, or the like, but embodiments of the present disclosure are not limited thereto.

According to an embodiment of the present disclosure, the soft member 360 can be configured as a single-sided tape, a single-sided sponge tape, a single-sided porous tape, a single-sided cushion tape, a double-sided tape, a double-sided sponge tape, a double-sided porous tape, or a double-sided cushion tape, or the like, which are configured the relatively smooth material, but embodiments of the present disclosure are not limited thereto. The soft member 360 can be filled in the one or more curved portions 136 of the vehicle interior material 130, or can be configured to cover or completely cover the one or more curved portions 136 of the vehicle interior material 130.

According to an embodiment of the present disclosure, the soft member 360 can be disposed between the enclosure 310 and the one or more curved portions 136 of the vehicle interior material 130. The soft member 360 can be disposed between the first enclosure 311 and the one or more curved portions 136 of the vehicle interior material 130. For example, the sound apparatus 30 or the first enclosure 311 can be connected or coupled to the one or more curved portions 136 of the vehicle interior material 130 by the soft member 360. Accordingly, the soft member 360 can be filled in the one or more curved portions 136 of the vehicle interior material 130 or can cover the one or more curved portions 136 of the vehicle interior material 130 and can absorb an external impact, thereby protecting the sound apparatus 30.

According to an embodiment of the present disclosure, the soft member 360 can further include a hole 3600. For example, the soft member 360 can further include the hole 3600 which is connected to the opening part 310o in the sound generating module 330 (or enclosure 310 or the first enclosure 311). The hole 3600 can be disposed to correspond to the opening part 310o. The hole 3600 can have a same shape as the opening part 310o, but embodiments of the present disclosure are not limited thereto.

According to an embodiment of the present disclosure, the vehicle interior material 130 can further include a hole 137. The hole 137 can include one hole or a plurality of holes. For example, one hole 137 can correspond to (or overlap) the opening part 310o and the hole 3600. For example, one hole 137 can have a size which is greater than or equal to the opening part 310o, and have a same size as the hole 3600. The hole 137 can be disposed to correspond to (or overlap) the opening part 310o and/or the hole 3600. For example, the hole 137 can be accommodated in (or within) the opening part 310o and/or the hole 3600.

According to an embodiment of the present disclosure, a sound generated based on a vibration of the sound generating module 330 can be output to an interior space of a vehicle through the opening part 310o, the hole 3600, and the hole 137. In addition, the sound apparatus 30 or the enclosure 310 can vibrate the vehicle interior material 130 by the soft member 350 to output a sound based on a vibration of the vehicle interior material 130 to the interior space of the vehicle. Furthermore, since an external impact applied to the sound apparatus 30 or the enclosure 310 can be absorbed by the soft member 360, and thus, sound apparatus 30 can be protected from the external impact.

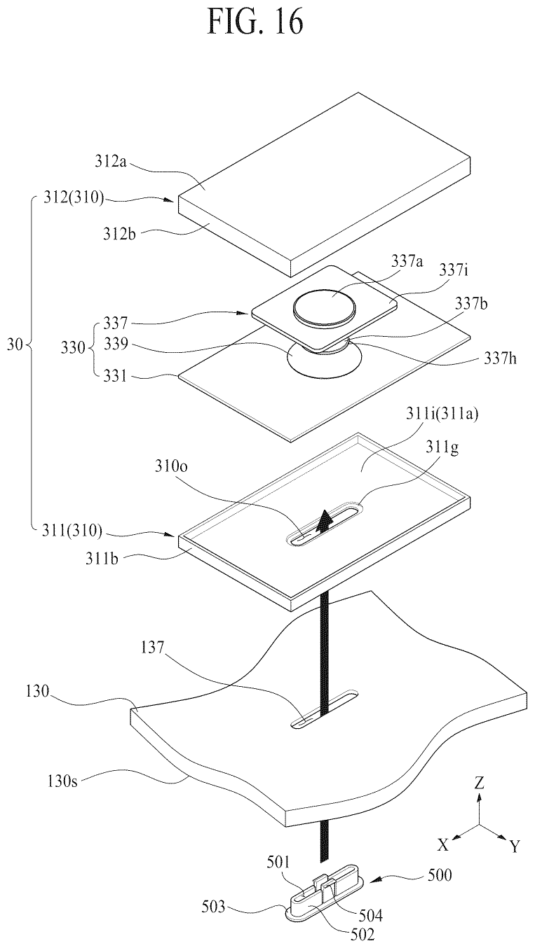

FIG. 15 illustrates a sound apparatus according to another embodiment of the present disclosure. FIG. 16 is an exploded perspective view of the sound apparatus illustrated in FIG. 15 according to another embodiment of the present disclosure. Particularly, FIG. 16 illustrates a method of connecting a sound apparatus to a coupling part according to another embodiment of the present disclosure.

With reference to FIGS. 15 and 16, a sound apparatus 30 according to another embodiment of the present disclosure can include an enclosure 310, a sound generating module 330, and a coupling member 320. Descriptions of the enclosure 310, the sound generating module 330, and the coupling member 320 can be substantially a same as the descriptions of FIGS. 3 to 14, and thus, like reference numerals refer to like elements and repeated descriptions are omitted or will be briefly given below.

In a case where a sound apparatus 30 is connected to a vehicle interior material 130, the sound apparatus 30 can be connected to the vehicle interior material 130 by an adhesive. In a case where the sound apparatus 30 is connected to the vehicle interior material 130 by the adhesive, there can be a problem where it is difficult to perform a rework or replacement when a defect or a breakdown of the sound apparatus 30 occurs, and there can be a problem where the damage of the sound apparatus 30 occurs in performing a rework or replacement. Accordingly, the inventors of the present disclosure have performed extensive research and experiments for facilitating the rework or replacement of the sound apparatus 30 connected to the vehicle interior material 130 and preventing the damage of the sound apparatus 30. Based on the extensive research and experiments, the inventors of the present disclosure have invented a sound apparatus where the rework or replacement of the sound apparatus 30 connected to the vehicle interior material 130 is easily performed, and the damage of the sound apparatus 30 does not occur in performing a rework or replacement. This will be described below.

The sound apparatus 30 according to another embodiment of the present disclosure can further include a coupling part 500.

The coupling part 500 can be configured to couple the enclosure 310 to the vehicle interior material 130 (or the mount object) with the enclosure 310 mounted thereon. The coupling part 500 can be configured to connect or couple the enclosure 310 to the vehicle interior material 130. The coupling part 500 can be configured to fix the enclosure 310 mounted on the vehicle interior material 130. For example, the sound apparatus 30 or the enclosure 310 can be connected or coupled to the vehicle interior material 130 by the coupling part 500. A sound based on a vibration of the sound generating module 330 can be output to an interior space of a vehicle through the coupling part 500. For example, the coupling part 500 can be a coupling means, a coupling structure, a cover structure, a sound cover member, a sound guide member, a waveguide, or a sound emission member, or the like, but embodiments of the present disclosure are not limited thereto.

According to an embodiment of the present disclosure, the coupling part 500 can be accommodated or inserted into an opening part 310o of the enclosure 310 or the first enclosure 311. The coupling part 500 can be accommodated or inserted into a hole 137 of the vehicle interior material 130. The coupling part 500 can be accommodated or inserted into the opening part 310o and the hole 137 of the first enclosure 311. For example, the hole 137 of the vehicle interior material 130 can be connected to the opening part 310o. For example, the coupling part 500 can be configured to be coupled to the enclosure 310 or the first enclosure 311 through the hole 137 of the vehicle interior material 130 and the opening part 310o.

The coupling part 500 according to an embodiment of the present disclosure can further include a hollow part 501. For example, the hollow part 501 can be connected to the internal space 313 of the enclosure 310. For example, the hollow part 501 can be connected to the internal space 313 through the opening part 310o of the enclosure 310. For example, the hollow part 501 can be connected to the internal space 313 of the enclosure 310 through the opening part 310o of the first enclosure 311 of the enclosure 310. For example, the hollow part 501 can be connected to the first space 313a of the enclosure 310 through the opening part 310o of the first enclosure 311. For example, the hollow part 501 can be configured to have a shape corresponding to the opening part 310o of the first enclosure 311. A sound based on a vibration of the sound generating module 330 can be output to an interior space of a vehicle by (or through) the hollow part 501. For example, the hollow part 501 can be a sound emission port or a sound output port, but embodiments of the present disclosure are not limited thereto.

The coupling part 500 according to an embodiment of the present disclosure can further include a hollow member 502 and a latch member 503.

The hollow member 502 can include the hollow part 501. The hollow member 502 can be connected or coupled to a hole 137 of the vehicle interior material 130. The hollow member 502 can be connected or coupled to the hole 137 of the vehicle interior material 130 and an opening part 310o of the enclosure 310. For example, the hollow member 502 can be connected or coupled to the hole 137 of the vehicle interior material 130 and the opening part 310o of the first enclosure 311. For example, the hollow member 502 can be accommodated or inserted into the opening part 310o of the first enclosure 311 through the hole 137 of the vehicle interior material 130. For example, the hollow member 502 can be connected or coupled to the enclosure 310 or the first enclosure 311 through the hole 137 of the vehicle interior material 130.

The latch member 503 can be configured to be connected or coupled to the vehicle interior material 130 (or a mount object). For example, the latch member 503 can be configured to be connected or coupled to the vehicle interior material 130 mounted with the enclosure 310. The latch member 503 can be connected or coupled to a periphery of the hole 137 of the vehicle interior material 130. The latch member 503 can be connected or coupled to an inner surface 130s of the vehicle interior material 130 at a periphery of the hole 137 of the vehicle interior material 130. For example, the inner surface 130s of the vehicle interior material 130 can be a first surface, an interior surface, a rear surface, or a lower surface. For example, the latch member 503 can be a latch or the like, but embodiments of the present disclosure are not limited thereto.

The latch member 503 can extend or protrude from an outer surface of one side (or one outer surface) of the hollow member 502 to have a certain width. For example, the one outer surface of the hollow member 502 can be adjacent to the inner surface 130s of the vehicle interior material 130. For example, the other side of the hollow member 502 can be accommodated in the opening part 310o of the enclosure 310. For example, the latch member 503 can extend or protrude from the outer surface of one side of the hollow member 502 to be parallel or face the inner surface 130s of the vehicle interior material 130. For example, the latch member 503 can be configured to have a plate shape corresponding to a shape of the hollow member 502 or the protrusion part 315.

The latch member 503 can cover the inner surface 130s of the vehicle interior material 130 at the periphery of the hole 137 of the vehicle interior material 130. For example, the latch member 503 can be in contact with or in close contact with the inner surface 130s of the vehicle interior material 130 at the periphery of the hole 137 of the vehicle interior material 130. Accordingly, the periphery of the hole 137 of the vehicle interior material 130 can be disposed or interposed between the latch member 503 and the enclosure 310.

The coupling part 500 according to an embodiment of the present disclosure can further include a hook member 504.

The first enclosure 311 can include an inner surface 311i and an outer surface. The inner surface 311i of the first enclosure 311 can face a vibration member 331. The outer surface of the first enclosure 311 can be a surface which is opposite to the inner surface 311i of the first enclosure 311.

The hook member 504 can be connected to a first side of the hollow member 502. The hook member 504 can be coupled to the inner surface 311i of the enclosure 310 facing the vibration member 331 at the sound generating module 330 or the sound apparatus 30. The hook member 504 can be coupled to the inner surface 311i of the enclosure 310 at the internal space 313 of the enclosure 310. The hook member 504 can be accommodated or inserted into the opening part 310o of the first enclosure 311. For example, the hook member 504 can be accommodated or inserted into the opening part 310o of the first enclosure 311 through the vehicle interior material 130. For example, the latch member 503 can be connected to a second side of the hollow member 502. The latch member 503 can be coupled to the inner surface 130s of the vehicle interior material 130. For example, the latch member 503 can be coupled to the inner surface 130s of the vehicle interior material 130 exposed to the interior space of the vehicle.

The enclosure 310 or the first enclosure 311 can further include a groove portion 311g. For example, the groove portion 311g can be configured at the inner surface 311i in the internal space 313. For example, the groove portion 311g can be configured at a periphery of the opening part 310o of an inner surface 311i in the internal space 313.

The hook member 504 can be configured to correspond to the groove portion 311g of the first enclosure 311 or the enclosure 310. For example, the hook member 504 can be connected or coupled to the groove portion 311g of the first enclosure 311 or the enclosure 310. For example, the hook member 504 can be accommodated (or inserted) into the opening part 310o through the vehicle interior material 130 and can be connected or coupled to the groove portion 311g. For example, the hook member 504 can be accommodated (or inserted) into the opening part 310o through the vehicle interior material 130 and can be connected or coupled to the groove portion 311g by a hook coupling scheme.

The hook member 504 can include a slope surface 504s. For example, the groove portion 311g and the slope surface 504s can be a fastening guide surface between the coupling part 500 and the enclosure 310. For example, the hook member 504 can be a protrusion or a protrusion part, but embodiments of the present disclosure are not limited thereto. For example, the groove portion 311g can be a concave portion or the like, but embodiments of the present disclosure are not limited thereto.

With reference to FIG. 16, the coupling part 500 can be connected or coupled to the enclosure 310 or the sound apparatus 30 through the hole 137 of the vehicle interior material 130 and an opening part 310o of the enclosure 310. For example, the coupling part 500 can be accommodated or inserted into the opening part 310o of the first enclosure 311 through (an arrow direction) the hole 137 of the vehicle interior material 130 at the interior space of the vehicle. For example, the hook member 504 of the coupling part 500 can be connected or coupled to the opening part 310o of the first enclosure 311. For example, the hook member 504 of the coupling part 500 can be inserted (or accommodated) into the opening part 310o of the first enclosure 311 and can be connected or coupled to a groove portion 311g of the first enclosure 311. For example, the hollow member 502 of the coupling part 500 is inserted (or accommodated) into the opening part 310o of the first enclosure 311, and thus, the hook member 504 of the coupling part 500 is pushed (or compressed) to a center (or inner side) of the hollow part 501 by an elastic force and can then be elastically restored onto the groove portion 311g of the first enclosure 311 by an elastic restoring force and can be connected or coupled to the opening part 310o of the first enclosure 311. For example, when the coupling part 500 is inserted into the opening part 310o of the first enclosure 311, the slope surface 504s of the hook member 504 can facilitate the insertion of the coupling part 500 and the compression of the hook member 504. For example, the hook member 504 can be connected or coupled to the groove portion 311g of the first enclosure 311. For example, the hook member 504 can be coupled to the groove portion 311g of the first enclosure 311 by a hook coupling scheme.

According to an embodiment of the present disclosure, the sound apparatus 30 can be connected or coupled to the vehicle interior material 130 by the coupling part 500, and thus, the rework or replacement of the sound apparatus 30 connected with the vehicle interior material 130 can be easily performed, thereby preventing the damage of the sound generating module 330 in performing the rework or replacement. According to an embodiment of the present disclosure, because the coupling part 500 is provided, the sound apparatus 30 can be easily attached or mounted on a narrow area (or space) between the vehicle interior material 130 and a vehicular structure. According to an embodiment of the present disclosure, because the sound apparatus 30 is coupled to or mounted on the vehicle interior material 130 by the coupling part 500, a shaking sound (or a trilling sound) may not occur between the sound apparatus 30 and the vehicle interior material 130, and thus, a sound characteristic and/or a sound pressure level characteristic of the sound apparatus 30 can be improved.

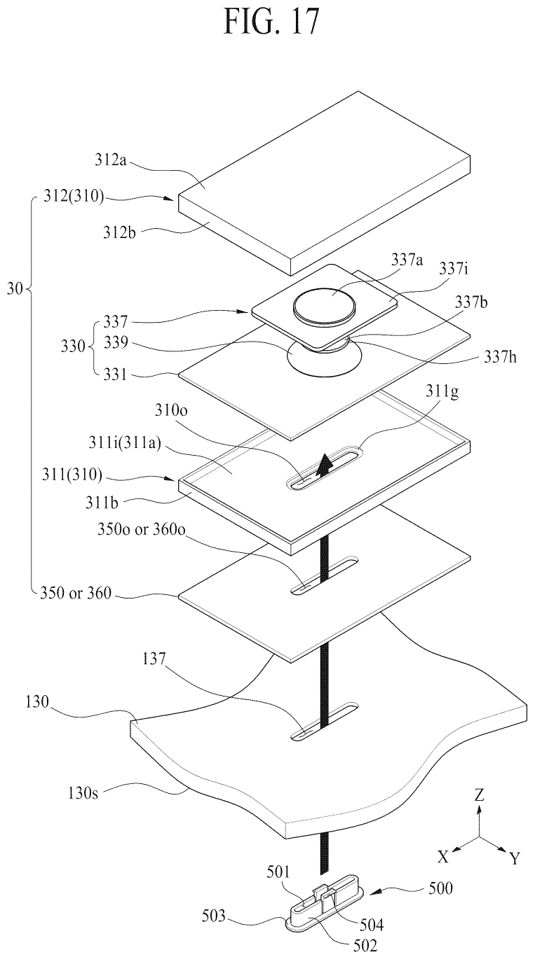

The sound apparatus 30 according to another embodiment of the present disclosure can further include the connection member 350 illustrated in FIG. 17.

With reference to FIG. 17, the connection member 350 can be between the vehicle interior material 130 and the enclosure 310. The connection member 350 can be between the vehicle interior material 130 and a first enclosure 311. The connection member 350 can include a hole 3500. For example, the hole 3500 can be between the hole 137 of the vehicle interior material 130 and an opening part 310o of the enclosure 310. For example, the hole 3500 can be between the hole 137 of the vehicle interior material 130 and the opening part 310o of the first enclosure 311. The hole 3500 can be connected to the opening part 310o of the enclosure 310. For example, the hole 3500 can be connected to the opening part 310o of the first enclosure 311. The hole 3500 can be disposed to correspond to the opening part 310o.

The coupling part 500 can be connected or coupled to the enclosure 310 or the sound apparatus 30 through (an arrow direction) the hole 137 of the vehicle interior material 130 at the interior space of the vehicle. For example, the hollow member 502 can be accommodated or inserted into the opening part 310o of the enclosure 310 through the hole 137 of the vehicle interior material 130 and the hole 3500 of the connection member 350. For example, the coupling part 500 can be accommodated or inserted into the opening part 310o of the first enclosure 311 through the hole 137 of the vehicle interior material 130 and the hole 3500 of the connection member 350 at the interior space of the vehicle. For example, the hollow member 502 of the coupling part 500 can be inserted (or accommodated) (an arrow direction) into the opening part 310o of the first enclosure 311, and thus, the hook member 504 of the coupling part 500 is pushed (or compressed) to a center (or an inner side) of the hollow part 501 by an elastic force and can then be elastically restored onto the groove portion 311g of the first enclosure 311 by an elastic restoring force and can be connected or coupled to the opening part 310o of the first enclosure 311. For example, the hook member 504 can be coupled to the groove portion 311g of the first enclosure 311 by a hook coupling scheme.

The sound apparatus 30 according to another embodiment of the present disclosure can further include a soft member 360 instead of the connection member 350 illustrated in FIG. 17.

The soft member 360 can be between the vehicle interior material 130 and the enclosure 310. The soft member 360 can be between the vehicle interior material 130 and a first enclosure 311. The soft member 360 can include a hole 3600. For example, the hole 3600 can be between the hole 137 of the vehicle interior material 130 and an opening part 310o of the enclosure 310. For example, the hole 3600 can be between the hole 137 of the vehicle interior material 130 and the opening part 310o of the first enclosure 311. The hole 3600 can be connected to the opening part 310o of the enclosure 310. For example, the hole 3600 can be connected to the opening part 310o of the first enclosure 311. The hole 3600 can be disposed to correspond to the opening part 310o.

The coupling part 500 can be connected or coupled to the enclosure 310 or the sound apparatus 30 through (an arrow direction) the hole 137 of the vehicle interior material 130 at the interior space of the vehicle. For example, the hollow member 502 can be accommodated into the opening part 310o through the hole 137 of the vehicle interior material 130 and the hole 3600. For example, the coupling part 500 can be accommodated or inserted into the opening part 310o of the first enclosure 311 through the hole 137 of the vehicle interior material 130 and the hole 3600 of the soft member 360 at the interior space of the vehicle. For example, the hook member 504 of the coupling part 500 can be connected or coupled to the opening part 310o of the first enclosure 311. For example, the hollow member 502 of the coupling part 500 can be inserted (or accommodated) (an arrow direction) into the opening part 310o of the first enclosure 311, and thus, the hook member 504 of the coupling part 500 is pushed (or compressed) to a center (or an inner side) of the hollow part 501 by an elastic force and can then be elastically restored onto the groove portion 311g of the first enclosure 311 by an elastic restoring force and can be connected or coupled to the opening part 310o of the first enclosure 311. For example, the hook member 504 can be coupled to the groove portion 311g of the first enclosure 311 by a hook coupling scheme.

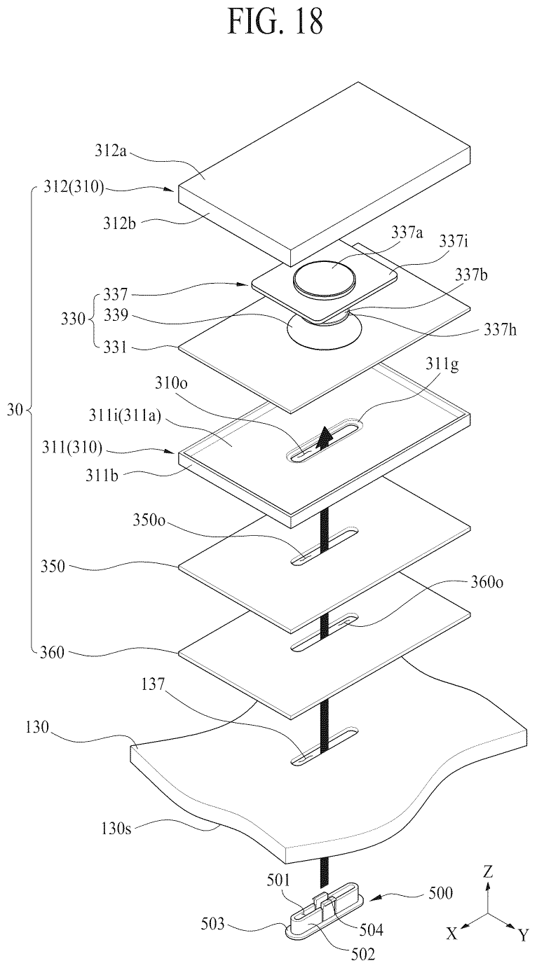

The sound apparatus 30 according to another embodiment of the present disclosure can further include a connection member 350 and a soft member 360 illustrated in FIG. 18.

With reference to FIG. 18, the coupling part 500 can be connected or coupled to the enclosure 310 or the sound apparatus 30 through (an arrow direction) the hole 137 of the vehicle interior material 130, the hole 3600 of the soft member 360, the hole 3500 of the connection member 350, and the opening part 310o of the enclosure 310. For example, the hollow member 502 can be accommodated into the opening part 310o of the enclosure 310 through the hole 137 of the vehicle interior material 130, the hole 3600 of the soft member 360, and the hole 3500 of the connection member 350. For example, the coupling part 500 can be can be connected or coupled to the enclosure 310 (or the first enclosure 311) through the hole 137 of the vehicle interior material 130, the hole 3600 of the soft member 360, the hole 3500 of the connection member 350, and the opening part 310o of the enclosure 310.

The method of connecting the vehicle interior material 130 and the sound apparatus 30 involves configuring the connection member 350 and the soft member 360 together, in descriptions given above with reference to FIG. 17, and thus, the repeated descriptions are omitted or will be briefly given below.

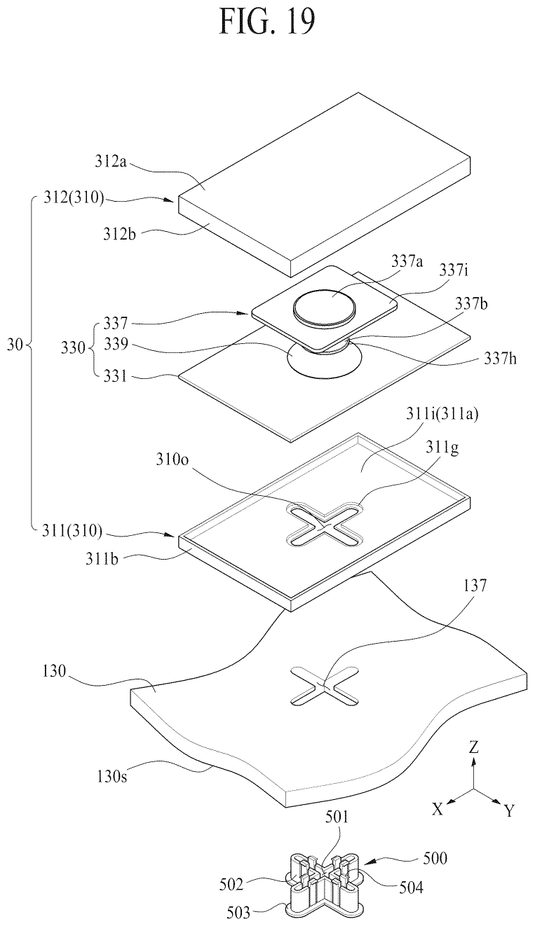

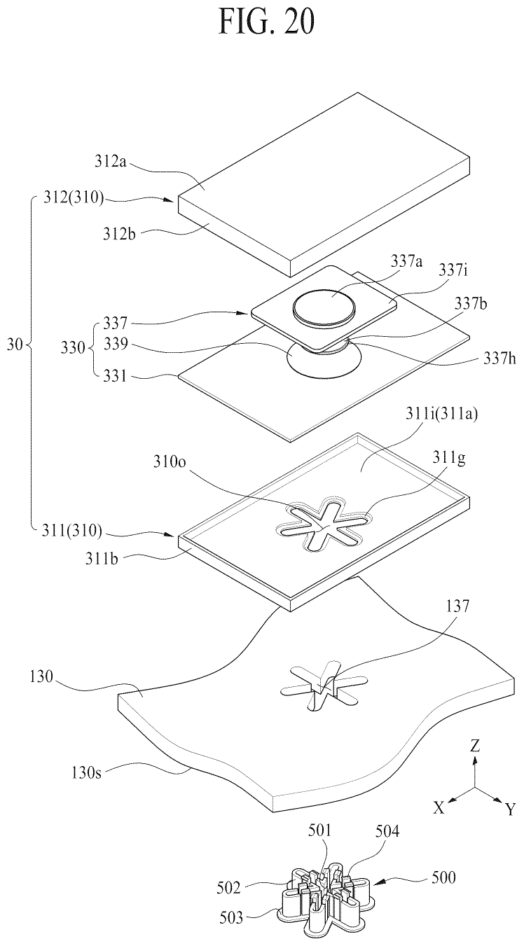

FIG. 19 illustrates a sound apparatus according to another embodiment of the present disclosure. FIG. 20 illustrates a sound apparatus according to another embodiment of the present disclosure.

With reference to FIGS. 19 and 20, a sound apparatus 30 according to another embodiment of the present disclosure can include an enclosure 310 and a sound generating module 330. Descriptions of the enclosure 310 and the sound generating module 330 can be substantially a same as the descriptions given above with reference to FIGS. 3 to 14, and thus, like reference numerals refer to like elements and repeated descriptions are omitted or will be briefly given below.

The sound apparatus 30 according to another embodiment of the present disclosure can include a coupling part 500 connected to a vehicle interior material 130. A description of the coupling part 500 can be substantially a same as the descriptions given above with reference to FIGS. 15 to 18, and thus, like reference numerals refer to like elements and repeated descriptions are omitted or will be briefly given below.

With reference to FIG. 19, the enclosure 310 according to another embodiment of the present disclosure can include an opening part 310o. For example, a first enclosure 311 can include the opening part 310o. The opening part 310o of the enclosure 310 or the first enclosure 311 can include two (or a pair of) opening lines (or line holes) intersecting with each other. The opening part 310o of the enclosure 310 or the first enclosure 311 can include a “+”-shape (or a cross shape). A vehicle interior material 130 can include a hole 137. The hole 137 can be disposed to correspond to the opening part 310o. For example, the hole 137 can be disposed to correspond to a shape of the opening part 310o. For example, a shape of the hole 137 can be a same as the shape of the opening part 310o, but embodiments of the present disclosure are not limited thereto. For example, the shape of the hole 137 can be a “+”-shape (or a cross shape).

The coupling part 500 according to another embodiment of the present disclosure can include a hollow part 501. The hollow part 501 can be disposed to correspond to the opening part 310o. For example, the hollow part 501 can be disposed to correspond to a shape of the opening part 310o. A shape of the hollow part 501 can be a same as the shape of the opening part 310o, but embodiments of the present disclosure are not limited thereto. For example, the shape of the hollow part 501 can be a “+”-shape (or a cross shape). A hook member 504 can be changed based on a shape of the hollow part 501. For example, the hook member 504 can include a plurality of hook members or latches, based on a “+”-shape (or a cross shape) of the hollow part 501.

With reference to FIG. 20, the opening part 310o of the enclosure 310 or the first enclosure 311 according to another embodiment of the present disclosure can include three opening lines (or line holes) intersecting with each other. The opening part 310o of the enclosure 310 or the first enclosure 311 can include a “*”-shape (an asterisk shape). The vehicle interior material 130 can include a hole 137. The hole 137 can be disposed to correspond to the opening part 310o. For example, the hole 137 can be disposed to correspond to a shape of the opening part 310o. For example, a shape of the hole 137 can be a same as the shape of the opening part 310o, but embodiments of the present disclosure are not limited thereto. For example, the shape of the hole 137 can be a “*”-shape (or an asterisk shape).

The hollow part 501 according to another embodiment of the present disclosure can be disposed to correspond to the opening part 310o. For example, the hollow part 501 can be disposed to correspond to a shape of the opening part 310o. A shape of the hollow part 501 can be a same as the shape of the opening part 310o, but embodiments of the present disclosure are not limited thereto. For example, the shape of the hollow part 501 can be a “*”-shape (or an asterisk shape). The hook member 504 can be changed based on a shape of the hollow part 501. For example, the hook member 504 can include a plurality of hook members or latches, based on a “*”-shape (or an asterisk shape) of the hollow part 501.

According to an embodiment of the present disclosure, because the opening part 310o is configured in a “+”-shape (or a cross shape) or a “*”-shape (or an asterisk shape), the amount of emitted sound in the sound apparatus 30 can increase, and a sense of beauty of an external appearance can be enhanced. Further, the hook member 504 can cover the hole 137 of the vehicle interior material 130, and thus, can minimize the penetration of dusts or foreign materials from the outside, thereby protecting the sound apparatus 30.

In FIGS. 19 and 20, the sound apparatus 30 according to another embodiment of the present disclosure can further include one or more of the connection member 350 and the soft member 360 described above with reference to FIGS. 15 to 17 or FIG. 18. For example, a shape of a hole 3500 of the connection member 350 can be disposed to correspond to a shape of the opening part 310o of the enclosure 310. For example, the shape of the hole 3500 of the connection member 350 can be a “+”-shape (or a cross shape) or a “*”-shape (or an asterisk shape). For example, a shape of a hole 3600 of the soft member 360 can be disposed to correspond to a shape of the opening part 310o of the enclosure 310. For example, the shape of the hole 3600 of the soft member 360 can be a “+”-shape (or a cross shape) or a “*”-shape (or an asterisk shape).

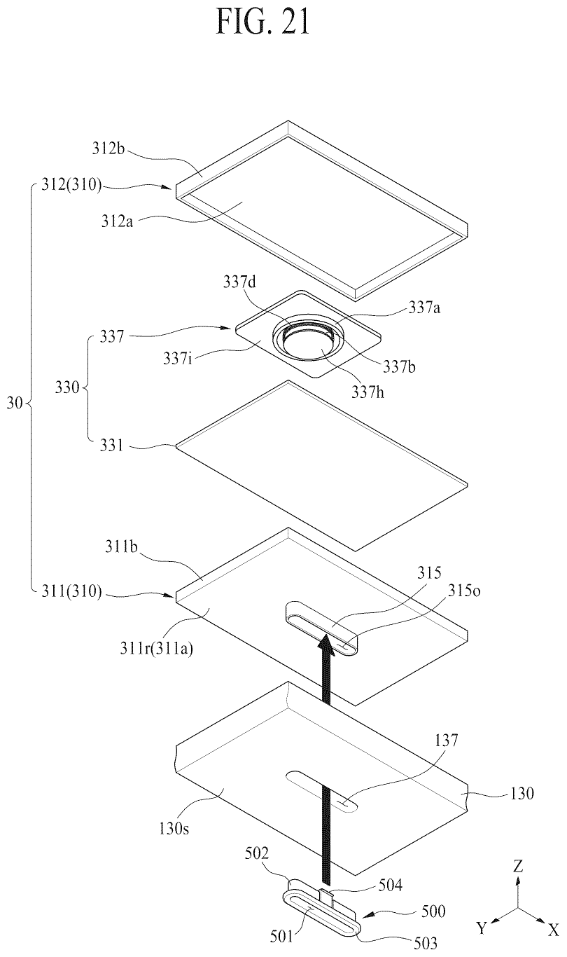

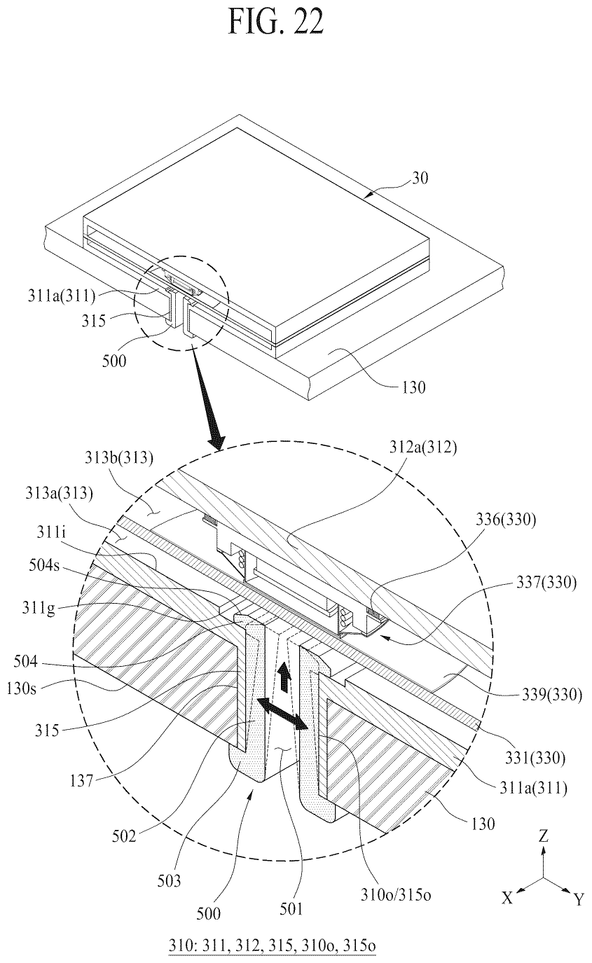

FIG. 21 illustrates a sound apparatus according to another embodiment of the present disclosure. FIG. 22 illustrates a method of connecting a sound apparatus to a coupling part illustrated in FIG. 21 according to another embodiment of the present disclosure.

With reference to FIGS. 21 and 22, a sound apparatus 30 according to another embodiment of the present disclosure can include an enclosure 310 and a sound generating module 330. Descriptions of the enclosure 310 and the sound generating module 330 can be substantially a same as the descriptions of FIGS. 3 to 14, and thus, like reference numerals refer to like elements and repeated descriptions are omitted or will be briefly given below.

According to another embodiment of the present disclosure, the enclosure 310 can include a protrusion part 315. A first enclosure 311 can include the protrusion part 315. The protrusion part 315 can protrude from a rear surface (or an outer surface) 311r of the first enclosure 311. The protrusion part 315 can protrude from the enclosure 310 or the first enclosure 311 to surround the opening part 310o. For example, the protrusion part 315 can protrude from a rear surface (or outer surface) 311r of a first plate 311a of the first enclosure 311 to surround the opening part 310o. Therefore, the protrusion part 315 can include a hollow hole (or a hole or an opening hole) 3150 connected to the opening part 310o. The hollow part 501 can be accommodated into the hollow hole 3150 of the protrusion part 315 and can connected to the internal space 313 through the hollow hole 3150 and the opening part 310o. The protrusion part 315 can be configured to be accommodated into the hole 137 in the vehicle interior material 130. For example, the coupling part 500 can be accommodated or inserted into the hole 137, the hollow hole 3150, and the opening part 310o. For example, the hook member 504 can be accommodated or inserted into the opening part 310o of the first enclosure 311 or the enclosure 310 through the vehicle interior material 130 (or mount object) and the protrusion part 315. The hook member 504 can be connected or coupled to an inner surface 311i of the first enclosure 311 or the enclosure 310. For example, the hook member 504 can be connected or coupled to a groove portion 311g of the enclosure 310 at the internal space 313 of the enclosure 310. For example, the hook member 504 can be coupled (or connected) to the groove portion 311g of the enclosure 310 by a hook coupling scheme at the internal space 313 of the enclosure 310.

According to an embodiment of the present disclosure, the first enclosure 311 or the first plate 311a can include an inner surface and an outer surface 311r. The inner surface 311i of the first enclosure 311 or the first plate 311a can face a vibration member 331. The outer surface 311r of the first enclosure 311 can be a surface which is opposite to the inner surface 311i of the first enclosure 311. For example, the protrusion part 315 can protrude from the outer surface 311r of the first enclosure 311 or the first plate 311a. The protrusion part 315 can protrude from the outer surface 311r of the first enclosure 311 or the first plate 311a to include the hollow hole 3150 connected to (or overlapping) the opening part 310o.

According to an embodiment of the present disclosure, the sound apparatus 30 can include a coupling part 500 connected to a vehicle interior material 130. A description of the coupling part 500 can be substantially a same as the description of FIGS. 18 to 20, and thus, like reference numerals refer to like elements and repeated descriptions are omitted or will be briefly given below.

The coupling part 500 can include a hollow part 501. The hollow part 501 can be connected or coupled to the protrusion part 315. The protrusion part 315 can surround an opening part 310o of the enclosure 310. For example, the protrusion part 315 can surround the opening part 310o of the first enclosure 311. The protrusion part 315 can include a hollow hole 3150 corresponding (or connected) to the opening part 310o of the first enclosure 311. For example, the hollow part 501 can be connected to an internal space 313 of the enclosure 310 through the protrusion part 315 and the opening part 310o. For example, the hollow part 501 can be connected to the internal space 313 of the enclosure 310 through the hollow hole 3150 of the protrusion part 315 and the opening part 310o. For example, the coupling part 500 can be accommodated into and coupled to the protrusion part 315 and can be configured to be coupled to one surface of the vehicle interior material 130 exposed at an interior space. For example, the coupling part 500 can be coupled to the protrusion part 315 and can be connected to the internal space 313 of the enclosure 310 through the opening part 310o. For example, the coupling part 500 can be connected or coupled to the enclosure 310 at the internal space 313 of the enclosure 310 through the protrusion part 315 and the opening part 310o.

According to an embodiment of the present disclosure, the coupling part 500 can include a hollow member 502 and a latch member 503.

The hollow member 502 can include the hollow part 501. The hollow member 502 can be inserted (or accommodated) into the protrusion part 315. The hollow member 502 can be inserted (or accommodated) into the hollow hole 3150 of the protrusion part 315. The hollow member 502 can be inserted (or accommodated) into the protrusion part 315 and can be connected or coupled to the opening part 310o of the enclosure 310 or the first enclosure 311.

The latch member 503 can be connected to the hollow member 502. The latch member 503 can be configured to be coupled to the vehicle interior material 130 (or the mount object). For example, the latch member 503 can be configured to be coupled to the vehicle interior material 130 (or the mount object) in which the enclosure 310 is mounted. For example, the latch member 503 can be configured to be coupled the vehicle interior material 130 (or the mount object) in which the first enclosure 311 is mounted.

According to an embodiment of the present disclosure, the vehicle interior material 130 can include a first surface and a second surface different from (or opposite to) the first surface. The first surface can be a surface facing the enclosure 310. A hole 137 can be configured at the first surface and the second surface. For example, the hole 137 can be configured to pass through the first surface and the second surface. For example, the latch member 503 can be configured to pass through the hole 137 and can be configured to be coupled to an inner surface 130s of the vehicle interior material 130.

According to an embodiment of the present disclosure, the coupling part 500 can include a hook member 504.

The hook member 504 can pass through the vehicle interior material 130 (or the mount object) and the protrusion part 315 and can be accommodated or inserted into the opening part 310o of the first enclosure 311. The hook member 504 can be connected or coupled to the inner surface 311i of the first enclosure 311. The hook member 504 can be connected or coupled to the inner surface 311i of the enclosure 310 at the internal space 313 of the enclosure 310. For example, the hook member 504 can be connected or coupled to the inner surface 311i of the first enclosure 311 facing the vibration member 331 in the sound generating module 330. For example, the hook member 504 can be connected or coupled to a groove portion 311g of the first enclosure 311. For example, the hook member 504 can be connected or coupled to the groove portion 311g of the first enclosure 311 by a hook coupling scheme.

The hook member 504 can be connected to a first side of the hollow member 502. The hook member 504 can be coupled to the inner surface 311i or the groove portion 311g of the enclosure 310 facing the vibration member 331 in the sound generating module 330. The hook member 504 can be coupled to the inner surface 311i or the groove portion 311g of the enclosure 310 at the internal space 313 of the enclosure 310. For example, the latch member 503 can be connected to a second side of the hollow member 502. The latch member 503 can be coupled to an inner surface 130s of the vehicle interior material 130 which is exposed at an interior space of a vehicle.

With reference to FIG. 21, the coupling part 500 can be connected or coupled to the protrusion part 315 of the enclosure 310 through (an arrow direction) the first hole 137 of the vehicle interior material 130. For example, the coupling part 500 can be connected or coupled to the protrusion part 315 of the first enclosure 311 through the first hole 137 of the vehicle interior material 130.

With reference to FIG. 22, the hook member 504 of the coupling part 500 can be connected or coupled to the protrusion part 315 of the first enclosure 311. For example, the hollow member 502 of the coupling part 500 can be inserted (or accommodated) (a vertical arrow direction) into the opening part 310o (or the hollow hole 3150 of the protrusion part 315) of the first enclosure 311, and thus, the hook member 504 of the coupling part 500 is pushed (or compressed) (a horizontal arrow direction) to a center (or an inner side) (a dotted-line direction) of the hollow part 501 by an elastic force and can then be elastically restored onto the groove portion 311g of the first enclosure 311 by an elastic restoring force and can be connected or coupled to the opening part 310o (or the hollow hole 3150 of the protrusion part 315) of the first enclosure 311. For example, when the coupling part 500 is inserted into the opening part 310o (or the hollow hole 3150 of the protrusion part 315) of the first enclosure 311, the slope surface 504s of the hook member 504 can facilitate the insertion of the coupling part 500 and the compression of the hook member 504. For example, the hook member 504 can be connected or coupled to the groove portion 311g of the first enclosure 311. For example, the hook member 504 can be coupled to the groove portion 311g of the first enclosure 311 by a hook coupling scheme.

According to an embodiment of the present disclosure, the sound apparatus 30 can be connected or coupled to the vehicle interior material 130 by the coupling part 500. According to an embodiment of the present disclosure, the enclosure 310 can include the protrusion part 315, and thus, the coupling part 500 can be easily connected or coupled to the protrusion part 315. Accordingly, a connection process or a coupling process between the vehicle interior material 130 and the sound apparatus 30 can be simplified.

The sound apparatus 30 according to another embodiment of the present disclosure can further include one or more of the connection member 350 and the soft member 360 described above with reference to FIG. 17 or 18. For example, one or more of the connection member 350 and the soft member 360 can be disposed to correspond to the hollow hole 3150 of the protrusion part 315 of the enclosure 310. For example, one or more of the hole 3500 of the connection member 350 and the hole 3600 of the soft member 360 can be disposed to correspond to the hollow hole 3150 of the protrusion part 315 of the enclosure 310.

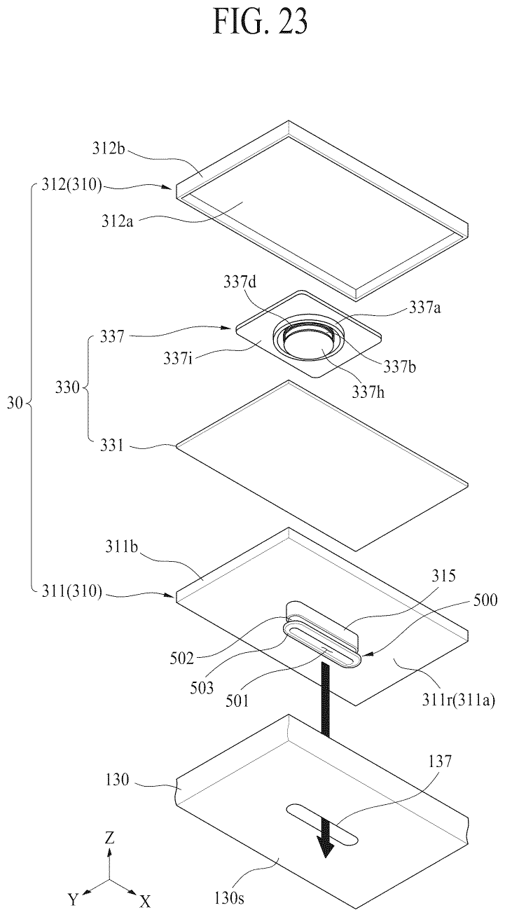

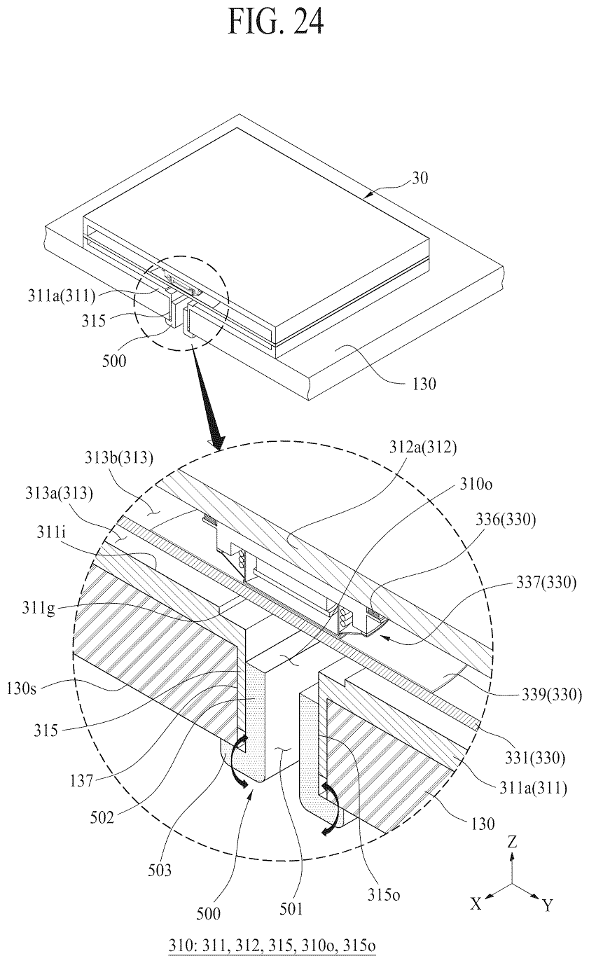

FIG. 23 illustrates a sound apparatus according to another embodiment of the present disclosure. FIG. 24 illustrates a method of connecting a sound apparatus to a coupling part illustrated in FIG. 23 according to another embodiment of the present disclosure.

With reference to FIGS. 23 and 24, a sound apparatus 30 according to another embodiment of the present disclosure can include an enclosure 310 and a sound generating module 330. Descriptions of the enclosure 310 and the sound generating module 330 can be substantially a same as the descriptions of FIGS. 3 to 17, and thus, like reference numerals refer to like elements and repeated descriptions are omitted or will be briefly given below.

According to an embodiment of the present disclosure, the enclosure 310 can include a protrusion part 315. A first enclosure 311 can include the protrusion part 315. The protrusion part 315 can protrude from a rear surface (or an outer surface) 311r of the first enclosure 311. The protrusion part 315 can protrude from a rear surface (or outer surface) 311r of a first plate 311a of the first enclosure 311 to surround the opening part 310o.

The first enclosure 311 can include an inner surface 311i and an outer surface 311r. The inner surface 311i of the first enclosure 311 can face a vibration member 331. The outer surface 311r of the first enclosure 311 can be a surface which is opposite to the inner surface 311i of the first enclosure 311. For example, the protrusion part 315 can protrude from the rear surface (or outer surface) 311r of the first enclosure 311 or the first plate 311a. For example, descriptions of the protrusion part 315 can be substantially a same as the description of FIGS. 21 and 22, and thus, like reference numerals refer to like elements and repeated descriptions are omitted or will be briefly given below.

The sound apparatus 30 according to another embodiment of the present disclosure can include a coupling part 500 connected to a vehicle interior material 130.

The coupling part 500 can be connected or coupled to the protrusion part 315. Thus, the coupling part 500 can be configured (or integrated) as one body with the protrusion part 315. For example, the coupling part 500 and the protrusion part 315 can be configured by a double injection molding process using different materials, but embodiments of the present disclosure are not limited thereto. According to an embodiment of the present disclosure, the coupling part 500 and the protrusion part 315 can be configured as one part (or one component), thereby realizing an effect of uni-materialization. Descriptions of the coupling part 500 can be substantially a same as the description of FIGS. 15 and 16, and thus, like reference numerals refer to like elements and repeated descriptions are omitted or will be briefly given below.

The coupling part 500 can include a hollow part 501. The hollow part 501 can be connected or coupled to the protrusion part 315. The protrusion part 315 can surround an opening part 310o of the enclosure 310. For example, the protrusion part 315 can surround the opening part 310o of the first enclosure 311. The protrusion part 315 can include an opening hole (or a hollow hole) 3150 corresponding (or connected) to the opening part 310o of the first enclosure 311. For example, the hollow part 501 can be connected to an internal space 313 of the enclosure 310 through the opening hole 3150 of the protrusion part 315 and the opening part 310o. For example, the hollow part 501 can be connected to the internal space 313 of the first enclosure 311 through the opening hole 3150 of the protrusion part 315 and the opening part 310o. For example, the hollow part 501 can be connected to the internal space 313 of the enclosure 310 through the opening part 310o of the enclosure 310. For example, the coupling part 500 can be configured to be coupled to the enclosure 310 through the hole 137 of the vehicle interior material 130, the opening hole 3150 of the protrusion part 315, and the opening part 310o of the enclosure 310. The hole 137 of the vehicle interior material 130 can be connected to the opening part 310o.

According to an embodiment of the present disclosure, the coupling part 500 can include a hollow member 502 and a latch member 503.

The hollow member 502 can include the hollow part 501. The hollow member 502 can be inserted (or accommodated) into the protrusion part 315. The hollow member 502 can be inserted (or accommodated) into the opening hole 3150 of the protrusion part 315. The hollow member 502 can be inserted (or accommodated) into the opening hole 3150 of the protrusion part 315 and can be connected or coupled to the opening part 310o of the enclosure 310 or the first enclosure 311.

The latch member 503 can be connected to the hollow member 502. The latch member 503 can be configured to be coupled to the vehicle interior material 130. For example, the latch member 503 can be configured to be coupled to the vehicle interior material 130 in which the enclosure 310 is mounted. For example, the latch member 503 can be configured to be coupled the vehicle interior material 130 in which the first enclosure 311 is mounted. For example, the latch member 503 can be configured to be coupled to an inner surface 130s of the vehicle interior material 130 through the opening hole 3150 of the protrusion part 315.

The latch member 503 according to an embodiment of the present disclosure can be configured as a flexible material, but embodiments of the present disclosure are not limited thereto. For example, the latch member 503 can be configured as rubber, but embodiments of the present disclosure are not limited thereto.

According to an embodiment of the present disclosure, the coupling part 500 and the protrusion part 315 can be connected or coupled to the hole 137 of the vehicle interior material 130 through (an arrow direction) the hollow part 501. For example, the latch member 503 can be configured as the flexible material, and thus, a sound generating module 330 or the sound apparatus 30 can be connected or coupled to the hole 137 of the vehicle interior material 130 by the movement (or folding and unfolding) (an arrow direction) of the latch member 503.

According to an embodiment of the present disclosure, the sound apparatus 30 can be connected or coupled to the vehicle interior material 130 by the coupling part 500. According to an embodiment of the present disclosure, in the enclosure 310, the protrusion part 315 can be configured as one body with the coupling part 500, and thus, a connection process or a coupling process between the vehicle interior material 130 and the sound apparatus 30 can be simplified. According to an embodiment of the present disclosure, the protrusion part 315 and the coupling part 500 can be configured as one part, thereby realizing an effect of uni-materialization.

The sound apparatus 30 according to another embodiment of the present disclosure can further include one or more of the connection member 350 and the soft member 360 described above with reference to FIG. 17 or 18. For example, one or more of the connection member 350 and the soft member 360 can be disposed to correspond to the hollow hole 3150 of the protrusion part 315 of the enclosure 310. For example, one or more of the hole 3500 of the connection member 350 and the hole 3600 of the soft member 360 can be disposed to correspond to the hollow hole 3150 of the protrusion part 315 of the enclosure 310.

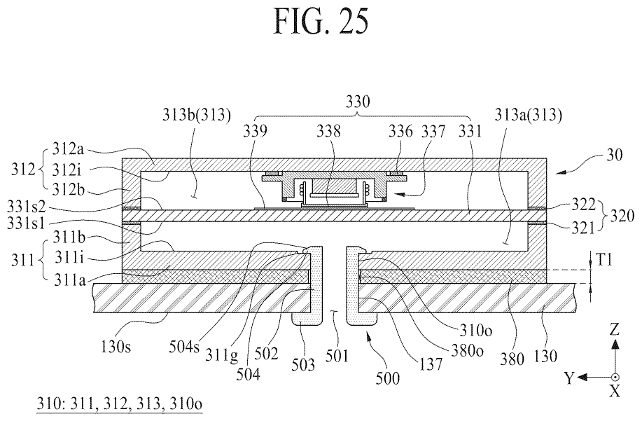

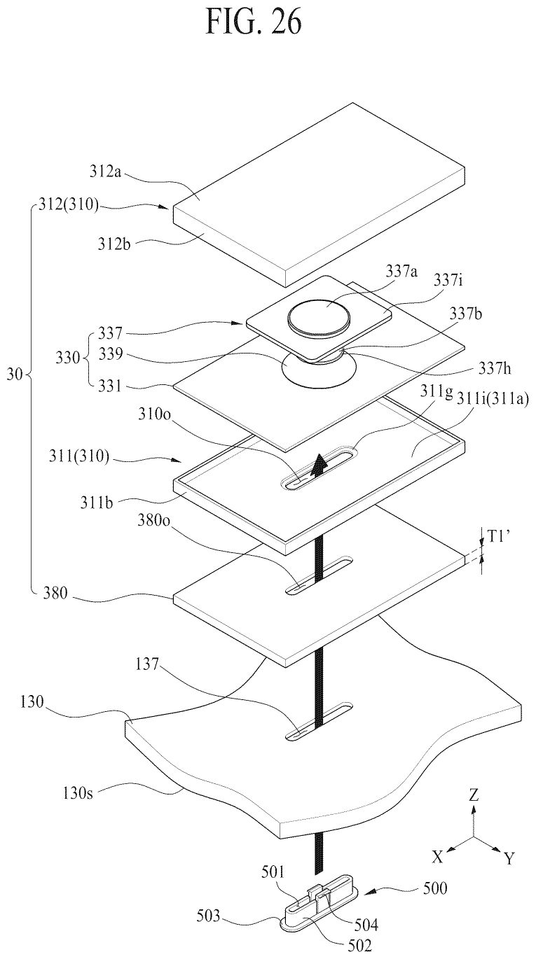

FIG. 25 illustrates a sound apparatus according to another embodiment of the present disclosure. FIG. 26 is an exploded perspective view of the sound apparatus illustrated in FIG. 25 according to another embodiment of the present disclosure.

Particularly, FIGS. 25 and 26 illustrate an embodiment where a connection member is additionally configured at the sound apparatus described above with reference to FIGS. 15 and 16. In the following description, therefore, the connection member will be described in detail, the other elements can be substantially a same as that of descriptions described above with reference to FIGS. 15 and 16, and thus, like reference numerals refer to like elements and repeated descriptions can be omitted or will be briefly given below. Therefore, descriptions above with reference to FIGS. 15 and 16 can be included in descriptions of FIGS. 25 and 26.

With reference to FIGS. 25 and 26, in the sound apparatus 30 according to another embodiment of the present disclosure, the connection member 380 can be provided or configured between the vehicle interior material 130 and the sound generating module 330. The connection member 380 can be configured between the first enclosure 311 of the enclosure 310 and the vehicle interior material 130. For example, the first enclosure 311 can include an inner surface 311i and an outer surface. The inner surface 311i of the first enclosure 311 can face a vibration member 331. The outer surface of the first enclosure 311 can be a surface which is opposite to the inner surface 311i of the first enclosure 311. For example, the connection member 380 can be connected to the outer surface of the first enclosure 311. The connection member 380 can be a second coupling member, a third intermediate member, a third buffer member, or a third pad member, but embodiments of the present disclosure are not limited thereto.

The connection member 380 can be configured in a material which differs from that of a coupling member 320 of the sound apparatus 30. For example, the connection member 380 can be configured in a material which differs from that of the first coupling member 321 of the coupling member 320. For example, the connection member 380 can be configured in a material having an adhesive force which differs from that of the first coupling member 321. Because the connection member 380 configures in a material having an adhesive force which differs from that of the first coupling member 321, a separation or detachment process (or rework) of the connection member 380 from the vehicle interior material 130 can be easily performed in a separation or detachment process (or rework) of the sound apparatus 30 attached on the vehicle interior material 130. Accordingly, a process of attaching or mounting the sound apparatus 30 on the vehicle interior material 130 or a process of separating or attaching/detaching the sound apparatus 30 from the vehicle interior material 130 can be easily performed.

The connection member 380 can be coupled (or attached) to a rear surface of the enclosure 310 and can contact (or surface-contact) an inner surface of the vehicle interior material 130, but embodiments of the present disclosure are not limited thereto. For example, in a case where the connection member 380 is coupled (or attached) to the rear surface of the enclosure 310 and simply contacts (or surface-contacts) the inner surface of the vehicle interior material 130, a process of separating or detaching (or rework) the connection member 380 from the vehicle interior material 130 without damage of the sound apparatus 30 or the vehicle interior material 130 can be easily performed in a process of separating and detaching (or rework) the sound apparatus 30 from the vehicle interior material 130. For example, the inner surface of the vehicle interior material 130 can be a second surface, an exterior surface (or an outdoor surface), a front surface, or an upper surface.

According to another embodiment of the present disclosure, the connection member 380 can include a single-sided tape, a single-sided adhesive tape, a single-sided foam tape, a single-sided adhesive foam tape, a single-sided pad, a single-sided foam pad, a single-sided adhesive foam pad, a single-sided pad member, a single-sided cushion member, a single-sided cushion pad, or a single-sided cushion tape, or the like, but embodiments of the present disclosure are not limited thereto. For example, the connection member 380 can include rubber, but embodiments of the present disclosure are not limited thereto. For example, the rubber can be ethylene propylene diene rubber (or ethylene propylene diene M-class rubber), ethylene propylene rubber, or urethane rubber, but embodiments of the present disclosure are not limited thereto. For example, the ethylene propylene rubber can be ethylene propylene diene monomer (EPDM), but embodiments of the present disclosure are not limited thereto. For example, a hardness of the EPDM can be 40 to 90, but embodiments of the present disclosure are not limited thereto. For example, a tensile strength of the EPDM can be 50 kg/cm² to 200 kg/cm², but embodiments of the present disclosure are not limited thereto. For example, the connection member 380 can include high-elasticity rubber, but embodiments of the present disclosure are not limited thereto.

According to an embodiment of the present disclosure, because the connection member 380 includes rubber or the like, when a vibration of the enclosure 310 or the first enclosure 311 is transferred to the vehicle interior material 130, the loss of the vibration can be prevented or minimized, and thus, a sound characteristic and/or a sound pressure level characteristic of a low-pitched sound band can be further improved.

According to an embodiment of the present disclosure, the connection member 380 can further include a hole 3800. For example, the connection member 380 can further include a hole 3800 which is connected to the opening part 310o at the enclosure 310 or the first enclosure 311.

The hole 3800 can be disposed to correspond to (or overlap) the opening part 310o. The hole 3800 can have a same shape as the opening part 310o, but embodiments of the present disclosure are not limited thereto. For example, the hole 3800 can have a same shape as that of the opening part 310o and can have a size which is greater than that of the opening part 310o. Accordingly, a sound based on a vibration of the sound generating module 330 can be output to an interior space IS of a vehicle by (or through) the opening part 310o and the hole 3800. For example, the hole 3800 can be a through hole, a fourth through hole, an opening part, an opening hole, a slit, a slot, a connection hole, or an intermediate hole, but embodiments of the present disclosure are not limited thereto.

According to an embodiment of the present disclosure, the hole 3800 can correspond to (or overlap) the hole 137 of the vehicle interior material 130. The hole 3800 can be between the hole 137 of the vehicle interior material 130 and the opening part 310o of the enclosure 310. For example, the hole 3800 can be between the hole 137 of the vehicle interior material 130 and the opening part 310o of the first enclosure 311. The hole 3800 can be connected to the opening part 310o of the enclosure 310. For example, the hole 3800 can be connected to the opening part 310o of the first enclosure 311. The hole 3800 can be disposed to correspond to the opening part 310o. The hole 3800 of the connection member 380 can have a same size as that of each of the opening part 310o and the hole 137, or can have a size which is greater than that of each of the opening part 310o and the hole 137. Accordingly, a sound based on a vibration of the sound generating module 330 can be output to an interior space of a vehicle by (or through) the opening part 310o, the hole 3800, and the hole 137.

A thickness T1 of the connection member 380 can differ from that of at least one of the first coupling member 321 and the second coupling member 322. For example, the thickness T1 of the connection member 380 can be thicker than that of at least one of the first coupling member 321 and the second coupling member 322. The thickness T1 of the connection member 380 can be 0.5 mm or more, but embodiments of the present disclosure are not limited thereto. For example, the thickness T1 of the connection member 380 can be 0.5 mm to 3 mm, but embodiments of the present disclosure are not limited thereto.

According to another embodiment of the present disclosure, the connection member 380 can have a compressive force (or a contractive force) and an elastic restoring force and can be contracted or compressed by coupling between the coupling part 500 and the first enclosure 311. A length (or a thickness) of the connection member 380 can be smaller than or equal to a length (or a thickness) of the vehicle interior material 130. For example, the length (or the thickness) of the connection member 380 can be smaller than or equal to a length (or a thickness) of the first enclosure 311.

The connection member 380, as illustrated in FIG. 26, can have the initial thickness T1′ before compression (or contraction) and can be compressed (or contracted) to have a deformed thickness (or a compression thickness) T1 illustrated in FIG. 25, based on pressure applied from the enclosure 310 by coupling (or connection) between the coupling part 500 and the enclosure 310. For example, when the sound apparatus 30 is connected to the vehicle interior material 130 by the coupling part 500 or assembly and/or rework are/is completed, a thickness of the connection member 380 can be compressed from the initial thickness T1′ to the compression thickness T1, and thus, a vibration of the enclosure 310 can be efficiently transferred to the vehicle interior material 130. For example, when the sound apparatus 30 is separated (or detached) from the vehicle interior material 130 by the detachment of the coupling part 500, the connection member 380 can be restored from the deformed thickness (or the compression thickness) T1 to the initial thickness T1′ by an elastic restoring force.

The coupling part 500 can be connected or coupled to the sound apparatus 30 through (an arrow direction) the hole 137 of the vehicle interior material 130, the hole 3800 of the connection member 380, and the opening part 310o of the first enclosure 311. For example, the coupling part 500 can be connected or coupled to the opening part 310o of the first enclosure 311 through the hole 137 of the vehicle interior material 130 and the hole 3800 of the connection member 380, in the interior space of the vehicle. According to an embodiment of the present disclosure, the coupling part 500 can be connected or coupled to the sound apparatus 30 or the enclosure 310 through (an arrow direction) the hole 137 of the vehicle interior material 130 at the interior space of the vehicle. For example, the coupling part 500 can be accommodated or inserted into the hole 3800 of the connection member 380 and the opening part 310o of the first enclosure 311 through the hole 137 of the vehicle interior material 130 at the interior space of the vehicle. For example, the hook member 504 of the coupling part 500 can be connected or coupled to the opening part 310o of the first enclosure 311. For example, the hook member 504 of the coupling part 500 can be inserted (or accommodated) into the opening part 310o of the first enclosure 311 and can be connected or coupled to a groove portion 311g of the first enclosure 311 by a hook coupling scheme.

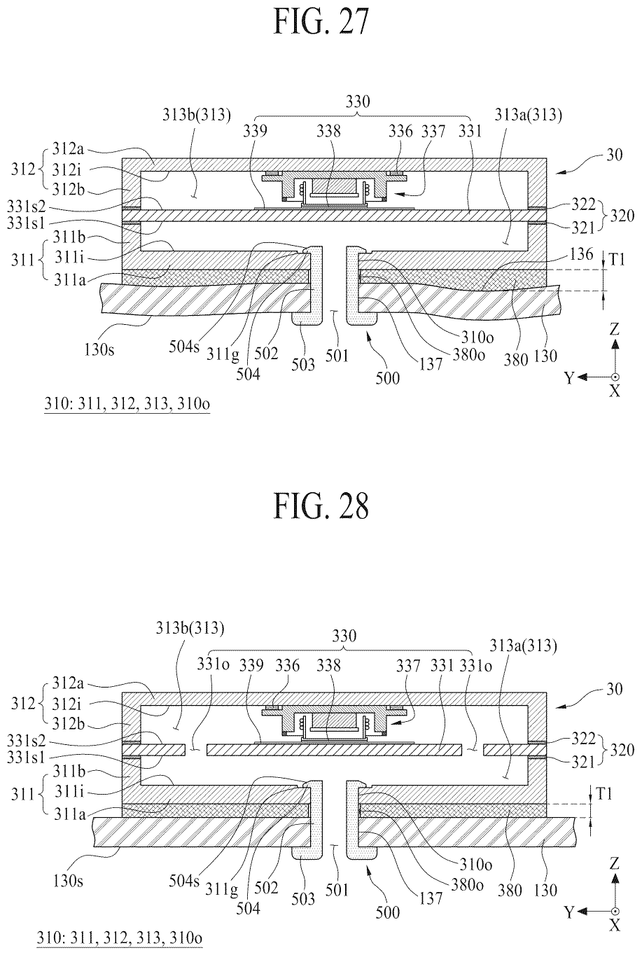

FIG. 27 illustrates a sound apparatus according to another embodiment of the present disclosure.

With reference to FIG. 27, the vehicle interior material 130 according to another embodiment of the present disclosure can include one or more curved portions (or flexural portions or uneven portions) 136. The connection member 380 can be configured to correspond to the one or more curved portions 136. The connection member 380 can contact with the one or more curved portions 136. The connection member 380 can directly contact with the one or more curved portions 136. For example, the connection member 380 can directly contact the one or more curved portions 136 without a medium or an intermediate member.

The sound apparatus 30 or the enclosure 310 can be connected or coupled to the one or more curved portions 136 of the vehicle interior material 130 by the connection member 380. For example, the connection member 380 can be disposed between the enclosure 310 and the one or more curved portions 136 of the vehicle interior material 130. For example, the connection member 380 can be disposed between the first enclosure 311 and the one or more curved portions 136 of the vehicle interior material 130. For example, the first enclosure 311 or a first plate 311a of the first enclosure 311 can be connected or coupled to the one or more curved portions 136 of the vehicle interior material 130 by the connection member 380.

A thickness T1 of the connection member 380 can differ from that of at least one of the first coupling member 321 and the second coupling member 322. For example, the thickness T1 of the connection member 380 can be thicker than that of at least one of the first coupling member 321 and the second coupling member 322. The thickness T1 of the connection member 380 can be 0.5 mm or more, but embodiments of the present disclosure are not limited thereto. For example, the thickness T1 of the connection member 380 can be 0.5 mm to 3 mm, but embodiments of the present disclosure are not limited thereto. For example, the connection member 380 can have the thickness T1 which is compressed (or contracted) from an initial thickness T1′ illustrated in FIG. 26 by a coupling force between the coupling part 500 and the first enclosure 311. Accordingly, the connection member 380 can surface-contact the vehicle interior material 130 including the one or more curved portions 136, based on the coupling force between the coupling part 500 and the first enclosure 311.

According to an embodiment of the present disclosure, a sound based on a vibration of the sound generating module 330 can be output to an interior space of a vehicle by (or through) the opening part 310o, the hole 3800, and the hole 137. In addition, a vibration of the enclosure 310 or the first enclosure 311 based on a sound (or sound pressure level or sound wave) based on a vibration of the sound generating module 330 can be efficiently transferred to the vehicle interior material 130 including the one or more curved portions 136 through the connection member 380 without loss of vibration, and the vehicle interior material 130 including the one or more curved portions 136 can vibrate based on the vibration of the enclosure 310 or the first enclosure 311 transferred through the connection member 380 to output to an interior space of a vehicle, and thus, a sound characteristic and/or a sound pressure level characteristic of a low-pitched sound band can be further improved.

The sound apparatus 30 according to another embodiment of the present disclosure can include the enclosure 310 and the connection member 380. Accordingly, a sound characteristic and/or a sound pressure level characteristic of a low-pitched sound band can be further improved, and an attachment or detachment process of the sound generating module 330 attached on the vehicle interior material 130 by the connection member 380 including a rubber material can be easily performed.

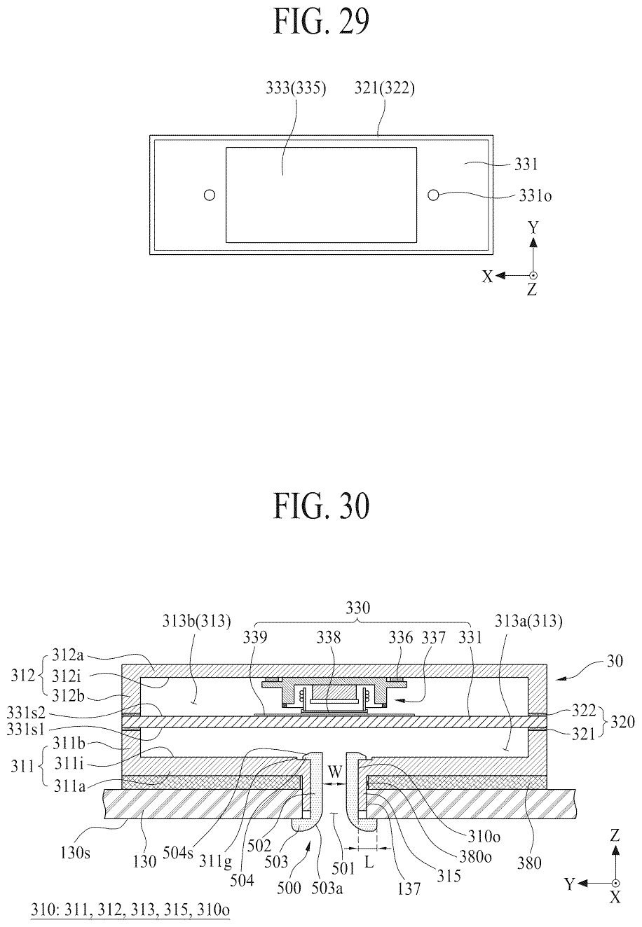

FIG. 28 illustrates a sound apparatus according to another embodiment of the present disclosure. FIG. 29 illustrates an internal of a sound apparatus according to another embodiment of the present disclosure.

Particularly, FIGS. 28 and 29 illustrate an embodiment where at least one hole is additionally configured at the sound apparatus 30 described above with reference to FIGS. 1 to 27. In the following description, therefore, at least one hole will be described in detail, the other elements can be substantially a same as that of descriptions described above with reference to FIGS. 1 to 27, and thus, like reference numerals refer to like elements and repeated descriptions can be omitted or will be briefly given below. Therefore, descriptions above with reference to FIGS. 1 to 27 can be included in descriptions of FIGS. 28 and 29.

With reference to FIGS. 28 and 29, a sound apparatus 30 according to another embodiment of the present disclosure can further include one or more holes 3310.

The one or more holes 3310 can be configured at a vibration member 331. The one or more holes 3310 can be configured to pass through the vibration member 331. The one or more holes 3310 can be configured to pass through the vibration member 331 along a thickness direction Z of the vibration member 331. For example, the one or more holes 3310 can be formed to vertically pass through the vibration member 331 along the thickness direction Z of the vibration member 331.

A sound generating module 330 according to an embodiment of the present disclosure can include the vibration member 331 including the one or more holes 3310 and vibration apparatus 337 configured at the vibration member 331.

The one or more holes 3310 can be configured to adjust a flow of air in an internal space 313 of the enclosure 310. For example, the one or more holes 3310 can perform control so that air flows in the internal spaces 313 of the enclosure 310 spatially separated from each other by the vibration member 331. For example, the one or more holes 3310 can be configured to adjust air flow between a first space 313a and a second space 313b spatially separated from each other by the vibration member 331 in the internal space 313 of the enclosure 310. For example, the one or more holes 3310 can be a through hole, a fifth through hole, an air hole, a vent hole, an air flow hole, a duct hole, a connection hole, a communication hole, or a space connection part, but embodiments of the present disclosure are not limited thereto.

The one or more holes 3310 according to an embodiment of the present disclosure can be configured in a polygonal shape such as a circular shape, an oval shape, or a tetragonal shape, but embodiments of the present disclosure are not limited thereto.

The one or more holes 3310 can be configured to decrease an air pressure of the internal space 313 of the enclosure 310. For example, the one or more holes 3310 can be configured to connect, with each other, the first space 313a and the second space 313b spatially separated from each other by the vibration member 331 at the internal space 313 of the enclosure 310. For example, the first space 313a and the second space 313b of the internal space 313 in the enclosure 310 can be connected to (or communicated with) each other through the one or more holes 3310. For example, the one or more holes 3310 can be configured to decrease an air pressure of the first space 313a of the first enclosure 311 or the first space 313a provided between the vibration member 331 and the first enclosure 311. Accordingly, a band (reproduction band) of a low-pitched sound band can expand, and thus, a sound characteristic and/or a sound pressure level characteristic of the low-pitched sound band can be improved. In addition, the sound generating module 330 can be more stably vibrated by the one or more holes 3310 in the vibration member 331, and thus, a sound characteristic and/or a sound pressure level characteristic can be further improved.

According to an embodiment of the present disclosure, the one or more holes 3310 can be disposed adjacent to vibration apparatus 337. For example, the one or more holes 3310 can be disposed at a periphery of each of the vibration apparatus 337. For example, the one or more holes 3310 can be disposed adjacent to a lateral surface of the vibration apparatus 337. For example, a distance between the one or more holes 3310 and the vibration apparatus 337 can be smaller than a distance between the one or more holes 3310 and a sidewall (or lateral surface) of the enclosure 310. For example, when the one or more holes 3310 is disposed at a position farther away from each of the vibration apparatus 337, a sound characteristic and/or a sound pressure level characteristic of a low-pitched sound band can be further improved.

According to an embodiment of the present disclosure, the one or more holes 3310 can be configured at the vibration member 331 adjacent to the vibration apparatus 337 with the vibration apparatus 337 therebetween. For example, the vibration member 331 can include a first periphery region adjacent a first lateral surface of the vibration apparatus 337 and a second periphery region, which is opposite to a second lateral surface opposite to the first lateral surface, of the vibration apparatus 337. For example, with respect to a first direction X, the vibration member 331 can include the first periphery region, a vibration region, and the second periphery region. For example, in the vibration member 331, each of the first and second periphery regions can be a hole region or a non-arrangement region of the vibration apparatus 337, and the vibration region can be an arrangement (or a disposition) region of the vibration apparatus 337. For example, the one or more holes 3310 can be configured in each of the first periphery region and the second periphery region of the vibration member 331 to have a symmetric structure (or a horizontal symmetric structure or a left-right symmetric structure) or an asymmetric structure (or horizontal asymmetric structure or a left-right asymmetric structure), with respect to the vibration apparatus 337.

According to an embodiment of the present disclosure, the vibration apparatus 337 can each include a long side and a short side. A distance (or separation distance or shortest distance) between the one or more holes 3310 and the short side of the vibration apparatus 337 can represent a ratio of a short-side length of the vibration apparatus 337. According to an embodiment of the present disclosure, a distance between the one or more holes 3310 and the vibration apparatus 337 can be 60% or less of the short-side length of the vibration apparatus 337.

The one or more holes 3310 can be disposed closer to the vibration apparatus 337 than a coupling member 320. The coupling member 320 can include a first coupling member 321 and a second coupling member 322. For example, the one or more holes 3310 can be disposed closer to the vibration apparatus 337 than the first coupling member 321 and the second coupling member 322. Accordingly, a sound characteristic and/or a sound pressure level characteristic of a low-pitched sound band can be enhanced.

According to an embodiment of the present disclosure, the one or more holes 3310 may not overlap an opening part 310o. For example, the one or more holes 3310 can be disposed to be spaced apart from the opening part 310o. Accordingly, a sound generated based on a vibration (or driving) of each of the vibration apparatus 337 in the second space 313b can be output to the first space 313a through the one or more holes 3310, and a sound characteristic and/or a sound pressure level characteristic of a low-pitched sound band can be enhanced.

According to an embodiment of the present disclosure, a sound generated at a rear surface of the vibration member 331 or the second space 313b of the enclosure 310 based on a vibration (or driving) of each of the vibration apparatus 337 can be output to the first space 313a through the one or more holes 3310 and can output (or radiated) through the opening part 310o of the first enclosure 311 and a hollow part 501 of a coupling part 500, and thus, a sound characteristic and/or a sound pressure level characteristic of a low-pitched sound band can be further enhanced.

According to another embodiment of the present disclosure, the one or more holes 3310 can be configured at the vibration member 331 to overlap the heat dissipation part 340 configured at the enclosure 310 described above with reference to FIGS. 8 and 9. For example, the one or more holes 3310 can be configured at the vibration member 331 to overlap each of one or more first holes 343 and one or more second holes 345 of the heat dissipation part 340 configured at the second enclosure 312 of the enclosure 310 with respect a thickness direction Z of the vibration member 331.

According to another embodiment of the present disclosure, the one or more holes 3310 can be configured at the vibration member 331 so as not to overlap with the heat dissipation part 340 configured at the enclosure 310 described above with reference to FIGS. 8 and 9. For example, the one or more holes 3310 can be configured at the vibration member 331 so as not to overlap with each of the one or more first holes 343 and the one or more second holes 345 of the heat dissipation part 340 configured at the second enclosure 312 of the enclosure 310 with respect a thickness direction Z of the vibration member 331.

The one or more holes 3310 can have a size smaller than that of the heat dissipation part 340. For example, the one or more holes 3310 can have a size smaller than the one or more first holes 343 and the one or more second holes 345 of the heat dissipation part 340.

The inventors of the present disclosure have recognized that a sound characteristic is changed based on a structure of the coupling part 500. Therefore, the inventors have performed various research and experiments on the structure of the coupling part 500. Based on the extensive research and experiments, the inventors have invented a sound apparatus including the coupling part 500 for enhancing a sound characteristic and/or a sound pressure level characteristic and a vehicular apparatus including the sound apparatus. This will be described below.

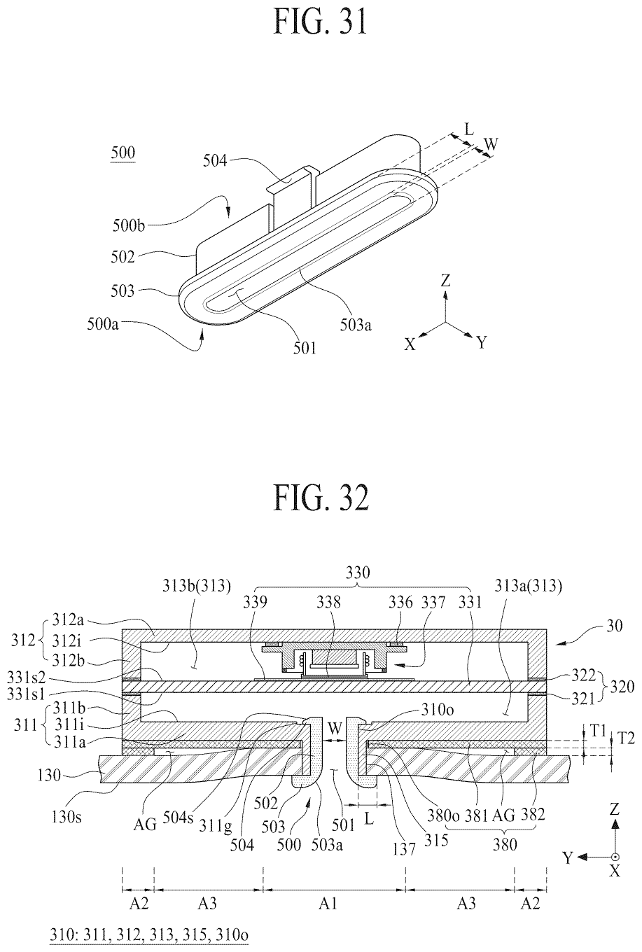

FIG. 30 illustrates a sound apparatus according to another embodiment of the present disclosure. FIG. 31 illustrates a coupling part according to another embodiment of the present disclosure.

Particularly, FIGS. 30 and 31 illustrate an embodiment implemented by modifying the coupling part 500 in the sound apparatus 30 described above with reference to FIGS. 15 to 29. In the following description, therefore, the coupling part 500 will be described in detail, the other elements can be substantially a same as that of descriptions described above with reference to FIGS. 15 to 29, and thus, like reference numerals refer to like elements and repeated descriptions can be omitted or will be briefly given below.

With reference to FIGS. 30 and 31, in the sound apparatus 30 according to another embodiment of the present disclosure, descriptions of the coupling part 500 can be substantially a same as the descriptions of FIGS. 15 to 29, and thus, like reference numerals refer to like elements and repeated descriptions are omitted or will be briefly given below.

The coupling part 500 according to another embodiment of the present disclosure can further include a chamfer portion 503a.

The coupling part 500 can include a hollow part 501 which is connected to an internal space 313 of an enclosure 310 and includes the chamfer portion 503a. The chamfer portion 503a can be configured at the hollow part 501. For example, the hollow part 501 can be connected to the internal space 313 of the enclosure 310 through an opening part 310o of the enclosure 310.

The vehicle interior material 130 can include a first surface and a second surface different from (or opposite to) the first surface. The first surface can be a surface facing the enclosure 310. The vehicle interior material 130 can include a hole 137 configured at the first surface and the second surface. For example, the hole 137 of the vehicle interior material 130 can be configured to pass through the first surface and the second surface. For example, the latch member 503 can be configured to pass through the hole 137 and couple to the inner surface 130s of the vehicle interior material 130. For example, the latch member 503 can include the chamfer portion 503a. For example, the latch member 503 can overlap the second surface 130s of the vehicle interior material 130.

The chamfer portion 503a according to another embodiment of the present disclosure can include a non-rectangular shape (or a non-right-angled shape). For example, the chamfer portion 503a can include one or more of a curve shape (or a round shape) and a slope surface. For example, the chamfer portion 503a can have a curvature. A sound characteristic and/or a sound pressure level characteristic can be changed based on a curvature of the chamfer portion 503a. For example, comparing with a case where the chamfer portion 503a has a rectangular shape, in a case where the chamfer portion 503a has a non-rectangular shape, it can be seen that peak and/or dip in a low-pitched sound band to a high-pitched sound band are/is improved, thereby enhancing a balance characteristic of a sound pressure level or a flatness characteristic of a sound pressure level. In addition, as a curvature of the chamfer portion 503a increases, a flatness characteristic of a sound pressure level and/or a sound pressure level characteristic in a high-pitched sound band can be further enhanced. Accordingly, because the coupling part 500 is configured to have a round shape or a slope surface, a sound characteristic and/or a sound pressure level characteristic in a sound band including a sound of a low-pitched sound band can be enhanced, and peak and/or dip in a high-pitched sound band can be improved, thereby enhancing a balance characteristic of a sound pressure level or a flatness characteristic of a sound pressure level.

With reference to FIG. 31, the coupling part 500 can include a first lateral portion (or a lower surface) 500a and a second lateral portion (or an upper surface) 500b. The second lateral portion 500b can be opposite to the first lateral portion 500a. For example, the chamfer portion 503a can be configured in a region between the second lateral portion 500b and the hollow part 501. For example, the chamfer portion 503a can be configured at a non-rectangular shape in a region (or corner region) between an inner surface (or an internal surface) of a hollow member 502 and an upper surface of the hook member 503. For example, the hollow part 501 can be connected to the internal space 313 through the opening part 310o of the enclosure 310.

According to another embodiment of the present disclosure, the hollow part 501 can have a “1”-shape (or a straight line shape), but embodiments of the present disclosure are not limited thereto. The hollow part 501 can have a “1”-shape parallel to a long-side direction of the enclosure 310 or a first direction X, but embodiments of the present disclosure are not limited thereto. For example, the hollow part 501 can have a slit shape including a short axis and a long axis, but embodiments of the present disclosure are not limited thereto. For example, the long axis of the hollow part 501 can be parallel to the long-side direction of the enclosure 310 or the first direction X, but embodiments of the present disclosure are not limited thereto. For example, the short axis of the hollow part 501 can be parallel to a second direction Y or a short-side direction of the enclosure 310, but embodiments of the present disclosure are not limited thereto. For example, the hollow part 501 can have a “*”-shape (or an asterisk shape) or a “+”-shape (or a cross shape) described above with reference to FIG. 19 or 20, but embodiments of the present disclosure are not limited thereto. A shape of the chamfer portion 503a can be identically applied based on various shapes of the hollow part 501.

According to another embodiment of the present disclosure, the coupling part 500 can include a hollow part 501 having a certain width (or first width) W. The hollow part 501 of the coupling part 500 can be configured to have a certain width W. For example, the width W of the hollow part 501 can be a short-axis length of the hollow part 501. The width W of the hollow part 501 or the short-axis length of the hollow part 501 can be 1 mm or more, but embodiments of the present disclosure are not limited thereto. For example, the width W of the hollow part 501 or the short-axis length of the hollow part 501 can be 1 mm to 5 mm or less, but embodiments of the present disclosure are not limited thereto.

According to an embodiment of the present disclosure, as the width W of the hollow part 501 increases, a sound pressure level can be enhanced, but dust or particles from the outside can flow into the internal space of the enclosure 310. According to an embodiment of the present disclosure, the width W of the hollow part 501 can be 1 mm or more, but embodiments of the present disclosure are not limited thereto. For example, the width W of the hollow part 501 can be 1 mm to 5 mm to reduce or minimize the inflow of dust or particles from the outside, but embodiments of the present disclosure are not limited thereto.

According to an embodiment of the present disclosure, because the width W of the hollow part 501 is configured to 1 mm or more, a sound characteristic and/or a sound pressure level characteristic can be enhanced in a pitched sound band including a sound of a low-pitched sound band, and peak and/or dip in a high-pitched sound band can be improved, thereby enhancing a balance characteristic of a sound pressure level and/or a flatness characteristic of a sound pressure level. According to an embodiment of the present disclosure, because the width W of the hollow part 501 is configured to 1 mm or more, dust or particles flowing in from the outside can be reduced or minimized.

According to another embodiment of the present disclosure, the coupling part 500 can include a latch member 503 having a certain length L (or a second width). For example, the latch member 503 can be configured to have the certain length L. For example, the length L of the latch member 503 can be a length which extends from an outer surface (or an outer circumference surface) of the hollow part 501 in a direction parallel to the vehicle interior material 130. For example, the length L of the latch member 503 can be a length which extends from a lower outer surface of the hollow member 502 in the direction parallel to the vehicle interior material 130. The latch member 503 having the length L can overlap at least one of the vehicle interior material 130, a connection member 380, and an enclosure 310. For example, the length L of the latch member 503 can be a same as a short-side length of the hollow part 501, but embodiments of the present disclosure are not limited thereto.

According to an embodiment of the present disclosure, as the length L of the coupling part 500 or the latch member 503 decreases, a sound pressure level characteristic can be enhanced. According to an embodiment of the present disclosure, the length L of the latch member 503 can be 10 mm or more, but embodiments of the present disclosure are not limited thereto. For example, the length L of the latch member 503 can be 10 mm or more and less than 19 mm, but embodiments of the present disclosure are not limited thereto. For example, when the length L of the latch member 503 is smaller than 10 mm, the dip and/or peak of a sound can be improved, but there can be a problem where it is difficult to equip a sound apparatus in a roof trim of a vehicular apparatus. According to an embodiment of the present disclosure, because the length L of the latch member 503 is configured to 10 mm or more and less than 19 mm, a sound characteristic and/or a sound pressure level characteristic can be enhanced in a pitched sound band including a sound of a low-pitched sound band, and peak and/or dip in a high-pitched sound band can be improved, thereby enhancing a balance characteristic of a sound pressure level or a flatness characteristic of a sound pressure level.

According to another embodiment of the present disclosure, because the coupling part 500 is configured to include one or more of the width W of the hollow part 501 and the length L of the latch member 503, a sound characteristic and/or a sound pressure level characteristic of the sound apparatus 30 can be more enhanced.

The coupling part 500 described above with reference to FIGS. 30 and 31 can be applied to the sound apparatus 30 described above with reference to FIGS. 25 to 29. For example, the coupling part 500 of the sound apparatus 30 described above with reference to FIGS. 25 to 29 can be changed to the coupling part 500 described above with reference to FIGS. 30 and 31. For example, in the description of the sound apparatus 30 described above with reference to FIGS. 25 to 29, the other descriptions except the descriptions of the coupling part 500 can be included in descriptions of the sound apparatus 30 illustrated in FIGS. 30 and 31, and thus, repeated descriptions thereof are omitted. For example, according to another embodiment of the present disclosure, because the sound apparatus 30 can include the one or more holes 3310, and can be configured to include one or more of a shape of a coupling part 500, a width W of the coupling part 500, and a length L of the coupling part 500, a sound characteristic and/or a sound pressure level characteristic of each of a low-pitched sound band and a middle-pitched sound band can be more enhanced, a sound reproduction band can more expand.

FIG. 32 illustrates a sound apparatus according to another embodiment of the present disclosure, and illustrates another embodiment of the connection member 380 described above with reference to FIG. 25 or 30. Therefore, in the following description, repeated descriptions of the other elements except the connection member 380 are omitted or will be briefly given below.

In a case where the connection member 380 of FIG. 25 or 30 is configured, the inventors of the present disclosure have recognized that a sound characteristic and/or a sound pressure level characteristic are/is reduced because an edge portion (or a periphery portion) of a connection member 380 is not connected to or does not contact a vehicle interior material 130. For example, the inventors of the present disclosure have recognized that the loss of a sound (or vibration transfer) occurs due to the periphery portion of the connection member 380 which is not connected to or does not contact the vehicle interior material 130. Therefore, the inventors of the present disclosure have recognized that a sound characteristic and/or a sound pressure level characteristic of a low-pitched sound band are/is reduced. Accordingly, the inventors have performed extensive research and experiments. Based on the extensive research and experiments, the inventors of the present disclosure have invented a sound apparatus and a vehicular apparatus including the same, which can further enhance a sound characteristic and/or a sound pressure level characteristic of the low-pitched sound band. This will be described below.

With reference to FIG. 32, a sound apparatus 30 according to another embodiment of the present disclosure can further include a connection member 380.

The connection member 380 can include a first portion and a second portion. The second portion can be a periphery portion of an enclosure 310. The second portion can be a portion (or a region) between the vehicle interior material 130 and the periphery portion of the enclosure 310. The first portion can be the other portion, except the periphery portion, of the enclosure 310. For example, the first portion can correspond to a center portion of the enclosure 310 surrounded by the second portion corresponding to the periphery portion of the enclosure 310.

According to an embodiment of the present disclosure, the first portion of the connection member 380 can include an opening hole 3800 connected to an internal space 313 of the enclosure 310. For example, the first portion of the connection member 380 can include an opening hole 3800 connected to an internal space 313 of a first enclosure 311.

According to an embodiment of the present disclosure, the enclosure 310 or the first enclosure 311 can include at least one or more regions. For example, the enclosure 310 or the first enclosure 311 can include a first region A1, a second region A2, and a third region A3.

The first region A1 can correspond to a center portion of the enclosure 310 or the first enclosure 311. The first region A1 can be at the center portion of the enclosure 310 or the first enclosure 311. The second region A2 can correspond to a periphery portion, surrounding the center portion, of the enclosure 310 or the first enclosure 311. The third region A3 can be between the first region A1 and the second region A2. For example, the first portion of the connection member 380 can be at the first region A1 and the third region A3. For example, the second portion of the connection member 380 can be at the second region A2.

According to an embodiment of the present disclosure, the first portion and the second portion of the connection member 380 can have different thicknesses. For example, the connection member 380 can include the first portion and the second portion having different thicknesses. In the connection member 380, a thickness T1 of the first portion can differ from a thickness “T1+T2” of the second portion. For example, in the connection member 380, the thickness “T1+T2” of the second portion can be thicker than the thickness T1 of the first portion. For example, the thickness T1 of the connection member 380 at the first region A1 can differ from the thickness “T1+T2” of the connection member 380 at the second region A2. At least one of thicknesses of the connection members 30 at each of the first and third regions A1 and A3 can differ from the thickness “T1+T2” of the connection member 380 at the second region A2. For example, the thickness “T1+T2” of the connection member 380 at the second region A2 can be thicker than the thickness T1 of the connection member 380 at the first region A1.

According to an embodiment of the present disclosure, the second portion of the connection member 380 can have a thickness “T1+T2” which is thicker than the first portion, and thus, the periphery portion of the connection member 380 can be connected to or contact the vehicle interior material 130 without being partially detached (or lifted). Therefore, the periphery portion of the connection member 380 can be prevented from being partially detached (or lifted) from the vehicle interior material 130, and a vibration at a periphery portion of the enclosure 310 can be transferred to the vehicle interior material 130 without the loss of a vibration (or vibration transfer) at the periphery portion of the enclosure 310. A vibration at the periphery portion of the enclosure 310 can increase a vibration region of the vehicle interior material 130, and thus, can further improve or reinforce a sound characteristic of a low-pitched sound band. Therefore, a sound generated from a vibration of the sound apparatus 30 can be transferred to the vehicle interior material 130 without being lost, and thus, a sound of the low-pitched sound band can be further enhanced. For example, a sound generated from a vibration of the sound apparatus 30 can be transferred to the vehicle interior material 130 through the opening part 310o and the periphery portion of the enclosure 310, and thus, vibration efficiency transferred from the enclosure 310 to the vehicle interior material 130 can increase, thereby further enhancing a sound characteristic and/or a sound pressure level characteristic of the low-pitched sound band.

The connection member 380 according to an embodiment of the present disclosure can include a first connection member 381 and a second connection member 382.

The first connection member 381 can be at the first portion and the second portion. The first connection member 381 can be connected to the enclosure 310. The first connection member 381 can be connected to (or attached on) the first enclosure 311. The first connection member 381 can be connected to (or attached on) a rear surface of the first enclosure 311. The first connection member 381 can be connected to (or attached on) the first to third regions A1, A2, and A3 of the enclosure 310. For example, the first connection member 381 can be connected to (or attached on) the entire rear surface of the first enclosure 311.

According to an embodiment of the present disclosure, the first connection member 381 can include a hole 3800 which is at the first portion and is connected to an internal space 313 of the enclosure 310. For example, the first connection member 381 can include a hole 3800 which is at the first portion and is connected to the internal space 313 of the first enclosure 311.

The second connection member 382 can be at the second portion. The second connection member 382 can be connected to a portion of the first connection member 381. The second connection member 382 can be on the first connection member 381 at the second portion. For example, the first portion can include only the first connection member 381 of the first connection member 381 and the second connection member 382. The first connection member 381 and the second connection member 382 can be together at the second portion. For example, the second portion can include all of the first connection member 381 and the second connection member 382. For example, the first connection member 381 and the second connection member 382 can be together at the second region A2.

The first portion and the second portion of the connection member 380 can have different widths (or sizes). In the connection member 380, a width of the first portion can be smaller than that of the second portion. For example, widths of the connection member 380 at the first regions A1 and the third regions A3 can be smaller than a width of the connection member 380 at the second regions A2. Accordingly, the connection member 380 can include the first portion and the second portion having different sizes (or widths) and different thicknesses.

The second connection member 382 can be at a periphery of the first connection member 381. The second connection member 382 can be configured to be stacked on the first connection member 381, at the second portion. The second connection member 382 can be configured to be stacked on the first connection member 381, at the second region A2. Accordingly, the thickness “T1+T2” of the second portion of the connection member 380 can be thicker than the thickness T1 of the first portion, and thus, the periphery portion of the enclosure 310 can be connected to (or contact) the vehicle interior material 130 without being partially detached (or lifted). For example, the second connection member 382 can be a cushion member or a pad member, but embodiments of the present disclosure are not limited thereto.

The first connection member 381 can be substantially a same as the connection member 380 described above with reference to FIG. 25 or 30, and thus, repeated descriptions thereof are omitted.

The second connection member 382 can include a same material (or substance) as that of the first connection member 381, but embodiments of the present disclosure are not limited thereto. For example, one of the first connection member 381 and the second connection member 382 can include a material which is a relatively high elasticity (or Young's modulus). One of the first connection member 381 and the second connection member 382 can be configured in high elastic rubber, but embodiments of the present disclosure are not limited thereto. One of the first connection member 381 and the second connection member 382 can have a material which is a relatively high elasticity (or Young's modulus) and can include a material which is relatively high in tensile strength. For example, one of the first connection member 381 and the second connection member 382 can include a rubber material, or can include ethylene propylene diene rubber (or ethylene propylene diene M-class rubber), ethylene propylene rubber, or urethane rubber. For example, the ethylene propylene rubber can be ethylene propylene diene monomer (EPDM), but embodiments of the present disclosure are not limited thereto. For example, a hardness of the EPDM can be 40 to 90, but embodiments of the present disclosure are not limited thereto. For example, a tensile strength of the EPDM can be 50 kg/cm² to 200 kg/cm², but embodiments of the present disclosure are not limited thereto. For example, a minimum elongation rate of the EPDM can be 200%, but embodiments of the present disclosure are not limited thereto. For example, a use temperature of the EPDM can be −30° C. to 110° C., but embodiments of the present disclosure are not limited thereto.

According to an embodiment of the present disclosure, a coupling member 320 can be configured as a material which differs from that of the connection member 380. For example, one of the first connection member 381 and the second connection member 382 can be configured as a material having elasticity (or a Young's modulus) which is higher than that of the coupling member 320.

According to an embodiment of the present disclosure, a width of the connection member 380 at the second portion can be greater than that of a width of the coupling member 320. For example, the width of the connection member 380 at the second region A2 can be greater than that of the width of the coupling member 320.

According to an embodiment of the present disclosure, each of the first connection member 381 and the second connection member 382 of the connection member 380 can have a compressive force (or contractive force) and an elastic restoring force and can be contracted or compressed by coupling between the coupling part 500 and the first enclosure 311. For example, the first connection member 381 disposed (or interposed) between the first enclosure 311 and the vehicle interior material 130 can have a first thickness T1 obtained through compression by a pressing force of the first enclosure 311. The second connection member 382 disposed (or interposed) between the first enclosure 311 and the vehicle interior material 130 can have a second thickness T2 obtained through compression by a pressing force of the first enclosure 311.

The first thickness T1 of the first connection member 381 can be equal to or different from the second thickness T2 of the second connection member 382. The first thickness T1 of the first connection member 381 and the second thickness T2 of the second connection member 382 can each be 0.5 mm or more, but embodiments of the present disclosure are not limited thereto. For example, the first thickness T1 of the first connection member 381 and the second thickness T2 of the second connection member 382 can each be 0.5 mm to 3 mm, but embodiments of the present disclosure are not limited thereto.

The sound apparatus 30 according to another embodiment of the present disclosure can further include an air gap AG at a region between the enclosure 310 and the vehicle interior material 130. For example, the air gap AG can be at a region between the vehicle interior material 130 and the first portion of the connection member 380 or a region between the first portion and the second portion of the connection member 380. For example, the air gap AG can be at the third region A3 between the first region A1 and the second region A2 of the enclosure 310. For example, the air gap AG can be at a region between the third region A3 of the enclosure 310 and the vehicle interior material 130. For example, the air gap AG can be provided at the third region A3 between the first region A1 and the second region A2 of the enclosure 310, and thus, can minimize separation or interference between a vibration of the first region A1 and a vibration of the second region A2, thereby increasing a vibration force (or the amount of vibration) transferred from the second region A2 (for example, the periphery portion) of the enclosure 310 to the vehicle interior material 130. Accordingly, a band (a reproduction band) of a low-pitched sound band can expand, and thus, a sound characteristic and/or a sound pressure level characteristic of the low-pitched sound band can be further improved.

According to an embodiment of the present disclosure, the connection member 380 including the first and second portions having different thicknesses can be configured, thereby providing the sound apparatus 30 where a sound characteristic and/or a sound pressure level characteristic of the low-pitched sound band are/is further enhanced. According to an embodiment of the present disclosure, because the second connection member 382 is configured, a vibration area (or a vibration region) of a roof trim of a vehicular apparatus can be widened when coupling the sound apparatus 30 to the roof trim of the vehicular apparatus, and thus, a sound characteristic and/or a sound pressure level characteristic of the low-pitched sound band can be further enhanced.

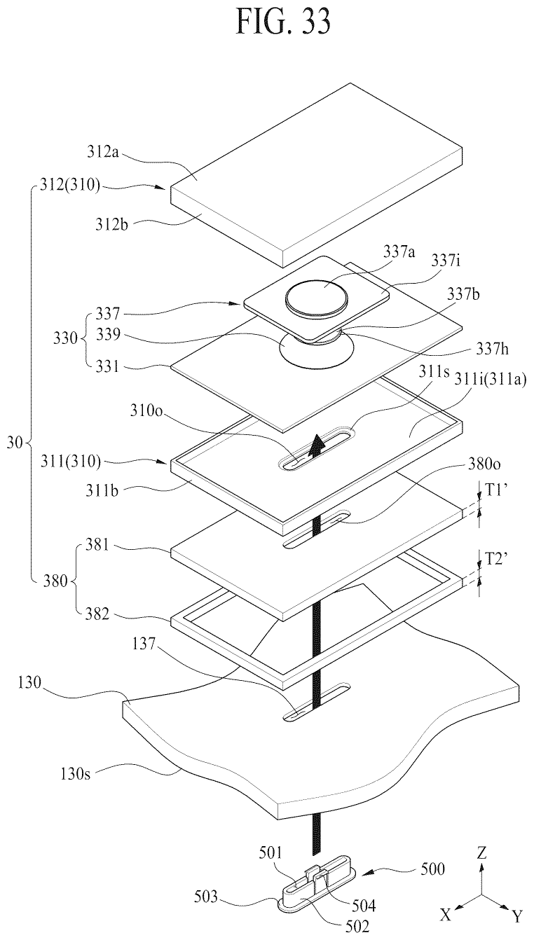

FIG. 33 illustrates a connection method between the sound apparatus and the coupling part illustrated in FIG. 32 according to another embodiment of the present disclosure.

With reference to FIGS. 32 and 33, according to an embodiment of the present disclosure, the first connection member 381 of the connection member 380 can be connected (or attached) to the rear surface (or the first portion and the second portion) of the enclosure 310 or the first enclosure 311 so that the hole 3800 overlaps (or is connected to) the enclosure 310 or the first enclosure 311, and the second connection member 382 of the connection member 380 can be connected (or attached) to the periphery portion (or the second portion) of the first connection member 381.

The enclosure 310 or the first enclosure 311 can be disposed on the vehicle interior material 130 so that the opening part 310o overlaps (or is connected to) the hole 137 of the vehicle interior material 130. The coupling part 500 can be connected or coupled to the sound apparatus 30 or the enclosure 310 through (an arrow direction) the hole 137 of the vehicle interior material 130 at an interior space (or an indoor space) of the vehicle. For example, the coupling part 500 can be connected or coupled to the sound apparatus 30 or the enclosure 310 through (an arrow direction) the second hole 137 of the vehicle interior material 130 and the hole 3800 of the first connection member 381 at the interior space of the vehicle. For example, the coupling part 500 can be accommodated or inserted into the hole 137 of the vehicle interior material 130, the hole 3800 of the first connection member 381, and the opening part 310o of the first enclosure 311 at the interior space of the vehicle. For example, the hook member 504 of the coupling part 500 can be connected or coupled to the opening part 310o of the first enclosure 311. For example, the hook member 504 of the coupling part 500 can be inserted (or accommodated) into the opening part 310o of the first enclosure 311 and can be connected or coupled to the groove portion 311g of the first enclosure 311, based on a hook coupling scheme.

Accordingly, the first enclosure 311 can be connected (or contact) the interior material 130 by the first connection member 381 and the second connection member 382 and coupling with the coupling part 500 and can vibrate the vehicle interior material 130 to output a sound based on a vibration of a vibration apparatus.

The first connection member 381 can have an initial thickness T1′ before compression (or contraction) and can be compressed (or contracted) to have a deformed thickness (or a compression thickness) T1, based on pressure applied from the enclosure 310 by coupling (or connection) between the coupling part 500 and the enclosure 310. For example, when the coupling part 500 is coupled (or connected) to the enclosure 310, a thickness of the first connection member 381 can be compressed from the initial thickness T1′ to the compression thickness T1, based on pressure applied from the enclosure 310, and thus, a vibration of the first region A1 in the first enclosure 311 can be efficiently transferred to the vehicle interior material 130 through the first portion of the first connection member 381. For example, when the sound apparatus 30 is separated (or detached) from the vehicle interior material 130 by the detachment of the coupling part 500, the first connection member 381 can be restored from the deformed thickness (or the compression thickness) T1 to the initial thickness T1′ by an elastic restoring force.

The second connection member 382 can have an initial thickness T2′ before compression (or contraction) and can be compressed (or contracted) to have a deformed thickness (or a compression thickness) T2, based on pressure applied from the enclosure 310 by coupling (or connection) between the coupling part 500 and the enclosure 310. For example, when the coupling part 500 is coupled (or connected) to the enclosure 310, a thickness of the second connection member 382 can be compressed from the initial thickness T1′ to the compression thickness T1, based on pressure applied from the enclosure 310, and thus, a vibration of the second region A2 at the first enclosure 311 can be efficiently transferred to the vehicle interior material 130 through the first connection member 381 which is compressed (or contracted) and the first portion of the second connection member 381. For example, when the sound apparatus 30 is separated (or detached) from the vehicle interior material 130 by the detachment of the coupling part 500, the second connection member 382 can be restored from the deformed thickness (or the compression thickness) T2 to the initial thickness T2′ by an elastic restoring force.

The vehicle interior material 130 connected to (or contacting) the enclosure 310 or the first enclosure 311 can be deformed to include a flexural portion or at least one curved portion, based on coupling (or connection) between the coupling part 500 and the enclosure 310, and thus, partial detachment (or lifting or separation) occurring between the periphery portion of the enclosure 310 or the first enclosure 311 and the vehicle interior material 130 can be prevented by the second portion of the connection member 380 having a relatively thick thickness. Accordingly, a vibration at the periphery portion of the enclosure 310 or the first enclosure 311 based on a vibration of the vibration apparatus can be transferred to the vehicle interior material 130 without the loss of a vibration (or vibration transfer) at the periphery portion of the first enclosure 311, and thus, vibration efficiency transferred from the enclosure 310 to the vehicle interior material 130 can increase, thereby further enhancing a sound characteristic and/or a sound pressure level characteristic of the low-pitched sound band.

According to another embodiment of the present disclosure, the connection member 380 described above with reference to FIGS. 25 to 31 can be changed to the connection member 380 that includes the first connection member 381 and the second connection member 382 described above with reference to FIGS. 32 and 33, and thus, in the sound apparatus 30 described above with reference to FIGS. 25 to 31, a sound characteristic and/or a sound pressure level characteristic of each of a low-pitched sound band and a middle-pitched sound band can be more enhanced, a sound reproduction band can more expand.

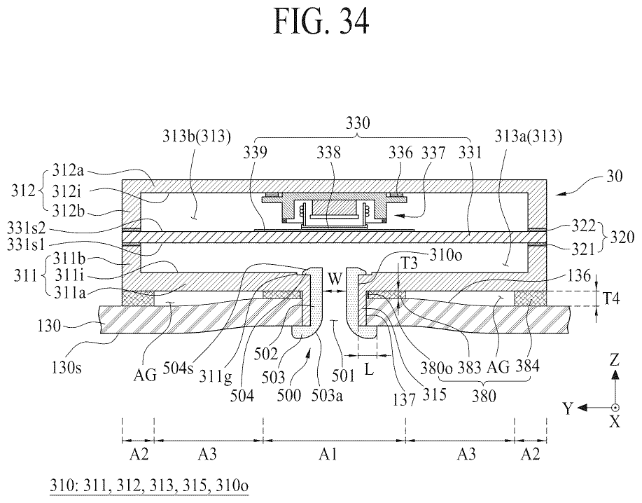

FIG. 34 illustrates a sound apparatus according to another embodiment of the present disclosure, and illustrates another embodiment of the connection member 380 described above with reference to FIGS. 32 and 33. Therefore, in the following description, repeated descriptions of the other elements except the connection member 380 are omitted or can be briefly given below. Descriptions of the enclosure 310 or the first enclosure 311 and the descriptions of the connection member 380 described above with reference to FIGS. 32 and 33 can be included in the descriptions of FIG. 34.

With reference to FIG. 34, a sound apparatus 30 according to another embodiment of the present disclosure can further include a connection member 380.

The connection member 380 can include a first portion and a second portion. The first portion of the connection member 380 can include a hole 3800 connected to an internal space 313 of the enclosure 310. For example, the first portion of the connection member 380 can include a hole 3800 connected to an internal space 313 of a first enclosure 311. The enclosure 310 or the first enclosure 311 can include a first region A1, a second region A2, and a third region A3.

According to an embodiment of the present disclosure, the first portion and the second portion of the connection member 380 can have different thicknesses T3 and T4. For example, the connection member 380 can include the first portion and the second portion having different thicknesses T3 and T4. In the connection member 380, a thickness T3 of the first portion can differ from a thickness T4 of the second portion. For example, in the connection member 380, the thickness T4 of the second portion can be thicker than the thickness T3 of the first portion. For example, the thickness T3 of the connection member 380 at the first region A1 can differ from the thickness T4 of the connection member 380 at the second region A2. For example, the thickness T4 of the connection member 380 at the second region A2 can be thicker than the thickness T3 of the connection member 380 at the first region A1. For example, the connection member 380 may not be disposed at the third region A3 between the first region A1 and the second region A2 or at a portion between the first portion and the second portion.

According to an embodiment of the present disclosure, the second portion of the connection member 380 can have the thickness T4 which is thicker than the first portion, and thus, the periphery portion of the connection member 380 can be connected to or contact the vehicle interior material 130 without being partially detached (or lifted). Therefore, the periphery portion of the connection member 380 can be prevented from being partially detached (or lifted) from the vehicle interior material 130, and a vibration at a periphery portion of the enclosure 310 can be transferred to the vehicle interior material 130 without the loss of a vibration (or vibration transfer) at the periphery portion of the enclosure 310. A vibration at the periphery portion of the enclosure 310 can increase a vibration region of the vehicle interior material 130, and thus, can further improve or reinforce a sound characteristic of a low-pitched sound band. Therefore, a sound generated from a vibration of the sound apparatus 30 can be transferred to the vehicle interior material 130 without being lost, and thus, a sound of the low-pitched sound band can be further enhanced. For example, a sound generated from a vibration of the sound apparatus 30 can be transferred to the vehicle interior material 130 through the opening part 310o and the periphery portion of the enclosure 310, and thus, vibration efficiency transferred from the enclosure 310 to the vehicle interior material 130 can increase, thereby further enhancing a sound characteristic and/or a sound pressure level characteristic of the low-pitched sound band.

According to an embodiment of the present disclosure, the connection member 380 can include a first connection member 383 and a second connection member 384.

The first connection member 383 can be connected to the enclosure 310. The first connection member 383 can be at the first portion. The first connection member 383 can be only at the first portion of the first portion and the second portion. The first connection member 383 can be connected to (or attached on) the first enclosure 311 of the enclosure 310. For example, the first connection member 383 can be connected to (or attached on) a rear surface of the first enclosure 311. The first connection member 383 can be connected to (or attached on) the rear surface of the first enclosure 311 corresponding to the first portion of the first portion and the second portion. For example, the first connection member 383 can be connected to (or attached on) a center portion (or a rear center portion) of the first enclosure 311. For example, the first connection member 383 can be connected to (or attached to) only the first region A1 of the first to third regions A1, A2, and A3 of the enclosure 310.

According to an embodiment of the present disclosure, the first connection member 383 can include a hole 3800 which is at the first portion and is connected to an internal space 313 of the enclosure 310. For example, the first connection member 383 can include a hole 3800 which is at the first portion and is connected to the internal space 313 of the first enclosure 311.

The second connection member 384 can be at the second portion. The second connection member 384 can be only at the second portion of the first portion and the second portion and can be spaced apart from the first connection member 383. The second connection member 384 can be at the second portion of the first portion and the second portion to surround the first connection member 383 with an air gap AG therebetween. The second connection member 384 can be connected to (or attached on) the second area A2 of the enclosure 310. For example, the second connection member 384 can be connected to (or attached to) the rear surface of the first enclosure 311 corresponding to the second portion of the first portion and the second portion. For example, the second connection member 384 can be connected to (or attached on) a periphery portion (or a rear periphery portion) of the first enclosure 311. For example, the second connection member 384 can be connected to (or attached to) only the second region A2 of the first to third regions A1, A2, and A3 of the enclosure 310.

The first portion and the second portion of the connection member 380 can have different widths (or sizes). A width of the first portion can be smaller than that of a width of the second portion. For example, a width of the first connection member 383 at the first regions A1 can be smaller than a width of the second connection member 384 at the second regions A2. Accordingly, the first connection member 383 and the second connection member 384 can include different sizes (or widths) and different thicknesses.

Each of the first connection member 383 and the second connection member 384 can be a cushion member or a pad member, but embodiments of the present disclosure are not limited thereto.

The first connection member 383 can include a same material (or substance) as that of the second connection member 384. Each of the first connection member 383 and the second connection member 384 can be a high elastic rubber or the like, but embodiments of the present disclosure are not limited thereto. For example, each of the first connection member 383 and the second connection member 384 can include a rubber material, or can include ethylene propylene diene rubber (or ethylene propylene diene M-class rubber), ethylene propylene rubber, or urethane rubber.

According to an embodiment of the present disclosure, a width of the connection member 380 at the second portion can be greater than that of a width of the coupling member 320. For example, a width of the connection member 380 at the second region A2 can be greater than that of the width of the coupling member 320.

According to an embodiment of the present disclosure, each of the first connection member 383 and the second connection member 384 of the connection member 380 can have a compressive force (or contractive force) and an elastic restoring force and can be contracted or compressed by coupling between the coupling part 500 and the first enclosure 311. For example, the first connection member 383 disposed (or interposed) between the first enclosure 311 and the vehicle interior material 130 can have a first thickness (or a third thickness) T3 obtained through compression by a pressing force of the first enclosure 311. The second connection member 384 disposed (or interposed) between the first enclosure 311 and the vehicle interior material 130 can have a second thickness (or a fourth thickness) T4 obtained through compression by a pressing force of the first enclosure 311.

The first thickness T3 of the first connection member 383 can be different from the second thickness T4 of the second connection member 382. The first thickness T3 of the first connection member 383 and the second thickness T4 of the second connection member 384 can each be 0.5 mm or more, but embodiments of the present disclosure are not limited thereto. For example, the first thickness T3 of the first connection member 383 and the second thickness T4 of the second connection member 384 can each be 0.5 mm to 3 mm, but embodiments of the present disclosure are not limited thereto. For example, the first thickness T3 of the first connection member 383 and the second thickness T4 of the second connection member 384 can have different thicknesses within a range of 0.5 mm to 3 mm. For example, the second thickness T4 of the second connection member 384 can be thicker than the first thickness T3 of the first connection member 383 within a range of 0.5 mm to 3 mm.

The sound apparatus 30 according to another embodiment of the present disclosure can further include an air gap AG. For example, the air gap AG can be at a region between the vehicle interior material 130 and the first portion of the connection member 380 or a region between the first portion and the second portion of the connection member 380. For example, the air gap AG can be at the third region A3 between the first region A1 and the second region A2 of the enclosure 310. For example, the air gap AG can be at a region between the second region A2 of the enclosure 310 and the vehicle interior material 130. For example, the air gap AG can be provided at the third region A3 between the first region A1 and the second region A2 of the enclosure 310, and thus, can minimize separation or interference between a vibration of the first region A1 and a vibration of the second region A2, thereby increasing a vibration force (or the amount of vibration) transferred from the second region A2 (for example, the periphery portion) of the enclosure 310 to the vehicle interior material 130. Accordingly, a band (a reproduction band) of a low-pitched sound band can expand, and thus, a sound characteristic and/or a sound pressure level characteristic of the low-pitched sound band can be further improved.

According to an embodiment of the present disclosure, the connection member 380 including the first and second connection members 383 and 384 having different thicknesses T3 and T4 can be configured, thereby providing the sound apparatus 30 where a sound characteristic and/or a sound pressure level characteristic of the low-pitched sound band are/is further enhanced. According to an embodiment of the present disclosure, because the second connection member 384 is configured, a vibration area (or a vibration region) of a roof trim of a vehicular apparatus can be widened when coupling the sound apparatus 30 to the roof trim of the vehicular apparatus, and thus, a sound characteristic and/or a sound pressure level characteristic of the low-pitched sound band can be further enhanced.

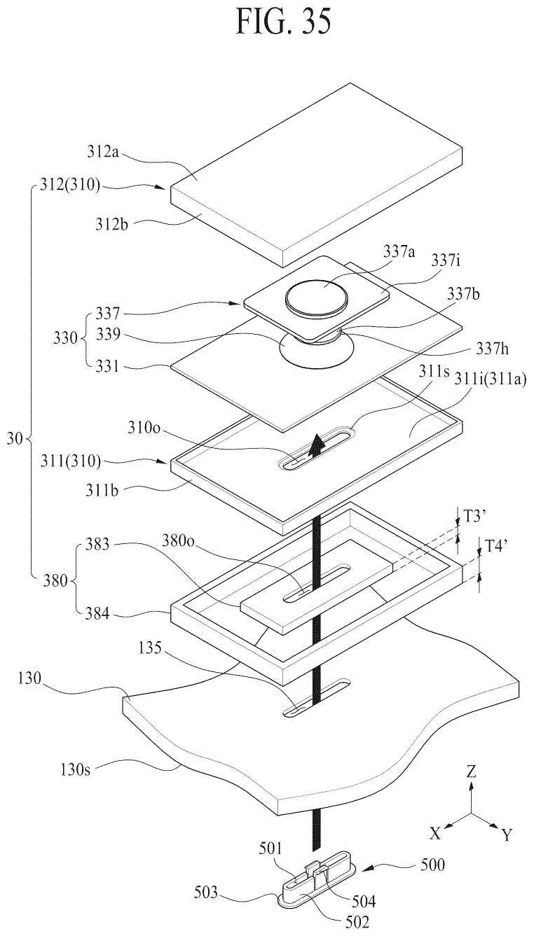

FIG. 35 illustrates a connection method between the sound apparatus and the coupling part illustrated in FIG. 34 according to another embodiment of the present disclosure.

With reference to FIGS. 34 and 35, according to an embodiment of the present disclosure, the first connection member 383 of the connection member 380 can be connected (or attached) to the center portion (or the first portion) of the enclosure 310 or the first enclosure 311 so that the hole 3800 overlaps (or is connected to) the enclosure 310 or the first enclosure 311, and the second connection member 384 of the connection member 380 can be connected (or attached) to the periphery portion (or the second portion) of the enclosure 310 or the first enclosure 311.

The enclosure 310 or the first enclosure 311 can be disposed on the vehicle interior material 130 so that the opening part 310o overlaps (or is connected to) the hole 137 of the vehicle interior material 130. The coupling part 500 can be connected or coupled to the sound apparatus 30 or the enclosure 310 through (an arrow direction) the hole 137 of the vehicle interior material 130 at an interior space (or an indoor space) of the vehicle. For example, the coupling part 500 can be connected or coupled to the sound apparatus 30 or the enclosure 310 through (an arrow direction) the second hole 137 of the vehicle interior material 130 and the hole 3800 of the first connection member 383 at the interior space of the vehicle. For example, the coupling part 500 can be accommodated or inserted into the hole 137 of the vehicle interior material 130, the hole 3800 of the first connection member 383, and the opening part 310o of the first enclosure 311 at the interior space of the vehicle. For example, the hook member 504 of the coupling part 500 can be connected or coupled to the opening part 310o of the first enclosure 311. For example, the hook member 504 of the coupling part 500 can be inserted (or accommodated) into the opening part 310o of the first enclosure 311 and can be connected or coupled to the groove portion 311g of the first enclosure 311, based on a hook coupling scheme.

Accordingly, the first enclosure 311 can be connected (or contact) the interior material 130 by the first connection member 383 and the second connection member 384 and coupling with the coupling part 500 and can vibrate the vehicle interior material 130 to output a sound based on a vibration of a vibration apparatus.

The first connection member 383 can have an initial thickness T3′ before compression (or contraction) and can be compressed (or contracted) to have a deformed thickness (or a compression thickness) T3, based on pressure applied from the enclosure 310 by coupling (or connection) between the coupling part 500 and the enclosure 310. For example, when the coupling part 500 is coupled (or connected) to the enclosure 310, a thickness of the first connection member 383 can be compressed from the initial thickness T3′ to the compression thickness T3, based on pressure applied from the enclosure 310, and thus, a vibration of the first region A1 in the first enclosure 311 can be efficiently transferred to the vehicle interior material 130 through the first connection member 381. For example, when the sound apparatus 30 is separated (or detached) from the vehicle interior material 130 by the detachment of the coupling part 500, the first connection member 383 can be restored from the deformed thickness (or the compression thickness) T3 to the initial thickness T3′ by an elastic restoring force.

The second connection member 384 can have an initial thickness T4′ before compression (or contraction) and can be compressed (or contracted) to have a deformed thickness (or a compression thickness) T4, based on pressure applied from the enclosure 310 by coupling (or connection) between the coupling part 500 and the enclosure 310. For example, when the coupling part 500 is coupled (or connected) to the enclosure 310, a thickness of the second connection member 384 can be compressed from the initial thickness T4′ to the compression thickness T4, based on pressure applied from the enclosure 310, and thus, a vibration of the second region A2 at the first enclosure 311 can be efficiently transferred to the vehicle interior material 130 through the second connection member 384 which is compressed (or contracted). For example, when the sound apparatus 30 is separated (or detached) from the vehicle interior material 130 by the detachment of the coupling part 500, the second connection member 384 can be restored from the deformed thickness (or the compression thickness) T4 to the initial thickness T4′ by an elastic restoring force.

The vehicle interior material 130 connected to (or contacting) the enclosure 310 or the first enclosure 311 can be deformed to include a flexural portion or at least one curved portion, based on coupling (or connection) between the coupling part 500 and the enclosure 310, and thus, partial detachment (or lifting or separation) occurring between the periphery portion of the enclosure 310 or the first enclosure 311 and the vehicle interior material 130 can be prevented by the second connection member 384 having a relatively thick thickness. Accordingly, a vibration at the periphery portion of the enclosure 310 or the first enclosure 311 based on a vibration of the vibration apparatus can be transferred to the vehicle interior material 130 without the loss of a vibration (or vibration transfer) at the periphery portion of the first enclosure 311, and thus, vibration efficiency transferred from the enclosure 310 to the vehicle interior material 130 can increase, thereby further enhancing a sound characteristic and/or a sound pressure level characteristic of the low-pitched sound band.

According to another embodiment of the present disclosure, the connection member 380 described above with reference to FIGS. 25 to 31 can be changed to the connection member 380 that includes the first connection member 381 and the second connection member 382 described above with reference to FIGS. 34 and 35, and thus, in the sound apparatus 30 described above with reference to FIGS. 25 to 31, a sound characteristic and/or a sound pressure level characteristic of each of a low-pitched sound band and a middle-pitched sound band can be more enhanced, a sound reproduction band can more expand.

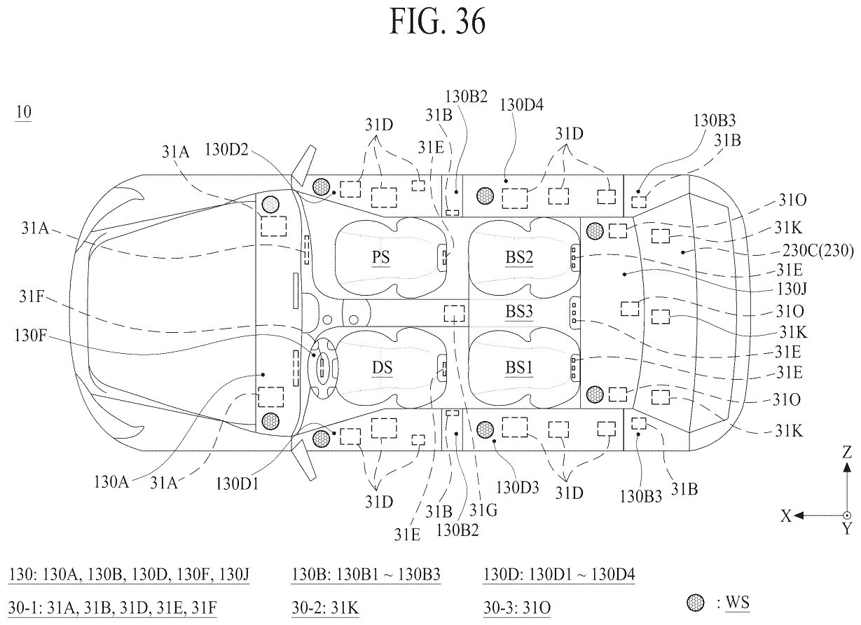

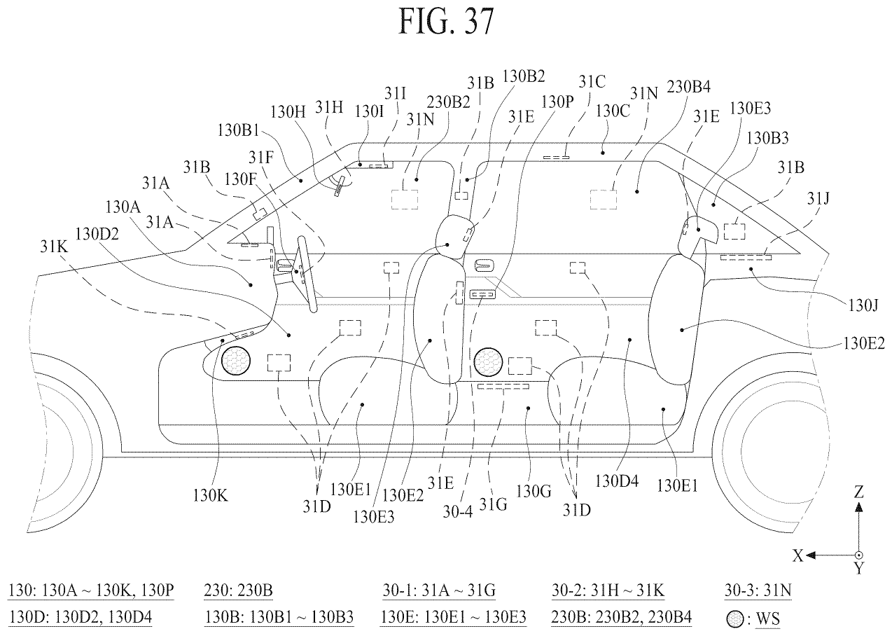

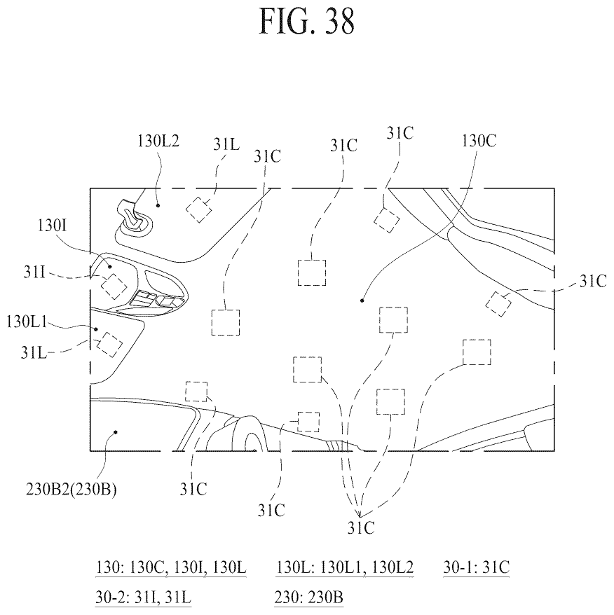

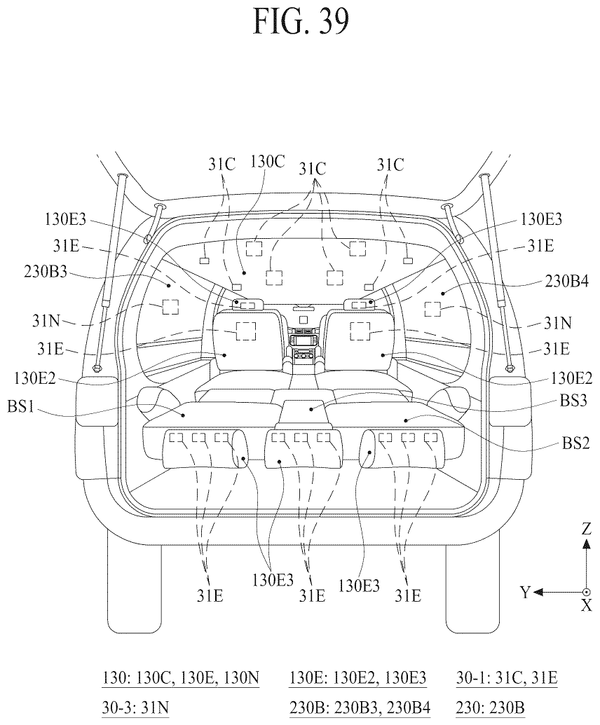

FIG. 36 illustrates a vehicular apparatus according to an embodiment of the present disclosure. FIG. 37 illustrates a vehicular apparatus according to an embodiment of the present disclosure. FIG. 38 illustrates a sound generating apparatus disposed at a roof of the vehicular apparatus illustrated in FIGS. 36 and 37 according to an embodiment of the present disclosure. FIG. 39 illustrates a sound generating apparatus disposed at a roof and a seat of the vehicular apparatus illustrated in FIGS. 36 and 37 according to an embodiment of the present disclosure. Descriptions of FIGS. 36 to 39 can be described with reference to FIGS. 1 and 2.

With reference to FIGS. 36 to 39, a vehicular apparatus 10 according to an embodiment of the present disclosure can include a vehicle interior material 130 and one or more sound generating apparatuses 30-1, 30-2, and 30-3.

According to an embodiment of the present disclosure, a vehicle interior material 130 can include at least one or more of a dashboard, a pillar interior material (or a pillar trim), a floor interior material (or a floor carpet), a roof interior material (or a headliner), a door interior material (or a door trim), a handle interior material (or a steering cover), a seat interior material, a rear package interior material (or a back seat shelf), an overhead console (or an indoor illumination interior material), a rear view mirror, a glove box, and a sun visor, or the like, but embodiments of the present disclosure are not limited thereto. The one or more sound generating apparatuses 30-1, 30-2, and 30-3 mat vibrate at least one or more of the dashboard, the pillar interior material (or the pillar trim), the floor interior material (or the floor carpet), the roof interior material (or the headliner), the door interior material (or the door trim), the handle interior material (or the steering cover), the seat interior material, the rear package interior material (or the back seat shelf), the overhead console (or the indoor illumination interior material), the rear view mirror, the glove box, and the sun visor.

With reference to FIGS. 1, 2, 36, and 37, the one or more sound generating apparatuses 30-1, 30-2, and 30-3 can be configured at a region between the vehicle interior material 130 and the main structure 110, or a region between the vehicle interior material 130 and the exterior material 120. The one or more sound generating apparatuses 30-1, 30-2, and 30-3 can be disposed at a region between the vehicle interior material 130 and the main structure 110, or a region between the vehicle interior material 130 and the exterior material 120, and can indirectly or directly vibrate one or more of the region between the vehicle interior material 130 and the main structure 110 or the region between the vehicle interior material 130 and the exterior material 120 to output sound.

The vehicular apparatus 10 according to an embodiment of the present disclosure can include a first sound generating apparatus 30-1 which is configured to output a sound at the main structure 110, the exterior material 120, and a region between the main structure 110 and the vehicle interior material 130. For example, the first sound generating apparatus 30-1 can be disposed at at least one or more of between the main structure 110 and the exterior material 120 of the vehicular apparatus 10, between the main structure 110 and the vehicle interior material 130, the exterior material 120, the vehicle interior material 130, and between the exterior material 120 and the vehicle interior material 130 to output a sound.

The vehicular apparatus 10 according to an embodiment of the present disclosure can include the first sound generating apparatus 30-1 which is configured to output a sound at the main structure 110, the exterior material 120, and a region between the main structure 110 and the vehicle interior material 130. For example, the first sound generating apparatus 30-1 can be disposed at at least one or more of between the main structure 110 and the exterior material 120 of the vehicular apparatus 10, between the main structure 110 and the vehicle interior material 130, the exterior material 120, the vehicle interior material 130, and between the exterior material 120 and the vehicle interior material 130 to output a sound. For example, the vehicle interior material 130 can output a sound based on a vibration of the one or more first sound generating apparatuses 30-1. For example, the vehicle interior material 130 can be exposed at an interior space IS.

The first sound generating apparatus 30-1 can include at least one or more sound generating modules 31A to 31G which are disposed at at least one or more of the dashboard 130A, the pillar interior material 130B, the roof interior material 130C, the door interior material 130D, the seat interior material 130E, the handle interior material 130F, and the floor interior material 130G. For example, the first sound generating apparatus 30-1 can include at least one or more of the first to seventh sound generating modules 31A to 31G (or sound apparatus, or sound output apparatus, or sound generating unit), and thus, can output sounds of one or more channels.

With reference to FIGS. 36 to 39, the first sound generating module 31A according to an embodiment of the present disclosure can be disposed between the dashboard 130A and a dash panel and can vibrate the dashboard 130A to output a sound based on a vibration of the dashboard 130A. For example, the first sound generating module 31A can be configured to directly vibrate the dashboard 130A to output a sound based on a vibration of the dashboard 130A. For example, the first sound generating module 31A can include the sound apparatus 30 described above with reference to FIGS. 3 to 35, and thus, the repetitive descriptions can be omitted. For example, the first sound generating module 31A can be a dashboard speaker.

According to an embodiment of the present disclosure, at least one or more of the dash panel and the dashboard 130A can include a first region corresponding to a driver seat DS, a second region corresponding to a passenger seat PS, and a third region (or a middle region) between the first region and the second region. At least one or more of the dash panel and the dashboard 130A can include a fourth region which is inclined to face the passenger seat PS.

According to an embodiment of the present disclosure, the first sound generating module 31A can be disposed to vibrate at least one or more of the first to fourth regions of the dashboard 130A. For example, the first sound generating module 31A can be disposed at each of the first and second regions of the dashboard 130A, or can be disposed at each of the first to fourth regions of the dashboard 130A. For example, the first sound generating module 31A can be disposed at each of the first and second regions of the dashboard 130A, or can be disposed at at least one or more of the first to fourth regions of the dashboard 130A. For example, the first sound generating module 31A can be configured to output a sound of about 150 Hz to about 20 kHz. For example, the first sound generating module 31A configured to vibrate at least one or more of the first to fourth regions of the dashboard 130A can have a same sound output characteristic or different sound output characteristics. For example, the first sound generating module 31A configured to vibrate each of the first to fourth regions of the dashboard 130A can have a same sound output characteristic or different sound output characteristics.

The second sound generating module 31B according to an embodiment of the present disclosure can be disposed between the pillar interior material 130B and a pillar panel and can vibrate the pillar interior material 130B to output a sound based on a vibration of the pillar interior material 130B. For example, the second sound generating module 31B can directly vibrate the pillar interior material 130B to output a sound based on a vibration of the pillar interior material 130B. For example, the second sound generating module 31B can include the sound apparatus 30 described above with reference to FIGS. 3 to 35, and thus, repeated descriptions are omitted. For example, the second sound generating module 31B can be a pillar speaker or a tweeter speaker.

According to an embodiment of the present disclosure, the pillar panel can include a first pillar (or an A pillar) disposed at both sides of a front window, a second pillar (or a B pillar) disposed at both sides of a center of a vehicle body, and a third pillar (or a C pillar) disposed at both sides of a rear portion of the vehicle body. The pillar interior material 130B can include a first pillar interior material 130B1 covering the first pillar, a second pillar interior material 130B2 covering the second pillar, and a third pillar interior material 130B3 covering the third pillar.

According to an embodiment of the present disclosure, the second sound generating module 31B can be disposed at at least one or more of a region between the first pillar and the first pillar interior material 130B1, a region between the second pillar and the second pillar interior material 130B2, and a region between the third pillar and the third pillar interior material 130B3, and thus, can vibrate at least one or more of the first to third pillar interior materials 130B1 to 130B3. For example, the second sound generating module 31B can be configured to output a sound at about 2 kHz to about 20 kHz, but embodiments of the present disclosure are not limited thereto. For example, the second sound generating module 31B can be configured to output a sound at about 150 Hz to about 20 kHz. For example, the second sound generating module 31B configured to vibrate at least one or more of the first to third pillar interior materials 130B1 to 130B3 can have a same sound output characteristic or different sound output characteristics.

With reference to FIGS. 37 to 39, the third sound generating module 31C according to an embodiment of the present disclosure can be disposed between the roof interior material 130C and a roof frame (or a roof panel) and can vibrate the roof interior material 130C to output a sound based on a vibration of the roof interior material 130C. For example, the third sound generating module 31C can directly vibrate the roof interior material 130C to output a sound based on a vibration of the roof interior material 130C. For example, the third sound generating module 31C can include the sound apparatus 30 described above with reference to FIGS. 3 to 35, and thus, repeated descriptions are omitted. For example, the third sound generating module 31C can be a roof speaker.

With reference to FIG. 38, at least one or more the third sound generating modules 31C can be disposed at the roof interior material 130C. For example, at least six or more third sound generating modules 31C can be disposed at the roof interior material 130C, but embodiments of the present disclosure are not limited thereto.

According to an embodiment of the present disclosure, at least one or more of the roof frame and the roof interior material 130C covering the roof frame can include the first region corresponding to the driver seat DS, the second region corresponding to the passenger seat PS, a third region corresponding to a region between the driver seat DS and the passenger seat PS, a fourth region corresponding to a first rear seat BS1 behind the driver seat DS, a fifth region corresponding to a second rear seat BS2 behind the passenger seat PS, a sixth region corresponding to a region between the first rear seat BS1 and the second rear seat BS2, and a seventh region between the third region and the sixth region.

According to an embodiment of the present disclosure, the third sound generating module 31C can be disposed to vibrate at least one or more among the first to seventh regions of the roof interior material 130C. For example, the third sound generating module 31C can be configured to output a sound of about 150 Hz to about 20 kHz. For example, the third sound generating module 31C configured to vibrate at least one or more of the first to seventh regions of the roof interior material 130C can have a same sound output characteristic or different sound output characteristics. For example, the third sound generating module 31C configured to vibrate each of the first to seventh regions of the roof interior material 130C can have a same sound output characteristic or different sound output characteristics. For example, at least one or more third sound generating modules 31C configured to vibrate at least one or more of the first to seventh regions of the roof interior material 130C can be configured to output a sound of about 2 kHz to about 20 kHz, and the other third sound generating modules 31C can be configured to output a sound of about 150 Hz to about 20 kHz. For example, at least one or more third sound generating modules 31C configured to vibrate each of the first to seventh regions of the roof interior material 130C can be configured to output a sound of about 2 kHz to about 20 kHz, and the other third sound generating modules 31C can be configured to output a sound of about 150 Hz to about 20 kHz.

With reference to FIGS. 37 and 38, the fourth sound generating module 31D according to an embodiment of the present disclosure can be disposed between the door frame and the door interior material 130D and can vibrate the door interior material 130D to output a sound based on a vibration of the door interior material 130D. For example, the fourth sound generating module 31D can directly vibrate the door interior material 130D to output a sound based on a vibration of the door interior material 130D. According to an embodiment of the present disclosure, the fourth sound generating module 31D can include the sound apparatus 30 described above with reference to FIGS. 3 to 35, and thus, repeated descriptions are omitted. For example, the fourth sound generating module 31D can be a door speaker.

According to an embodiment of the present disclosure, at least one or more of the door frame and the door interior material 130D can include an upper region, a middle region, and a lower region with respect to a height direction Z of the vehicular apparatus 10. For example, the fourth sound generating module 31D can be disposed at at least one or more of the upper region, the middle region, and the lower region between the door frame and the door interior material 130D, and thus, can vibrate at least one or more of the upper region, the middle region, and the lower region of the door interior material 130D.

According to an embodiment of the present disclosure, the upper region of the door interior material 130D can have a relatively small curvature radius. The fourth sound generating module 31D for vibrating the upper region of the door interior material 130D can include the sound apparatus 30 having the soft member 360 described above with reference to FIG. 17 or the sound apparatus 30 having the connection member 380 described above with reference to FIGS. 25 to 35, but embodiments of the present disclosure are not limited thereto.

According to an embodiment of the present disclosure, the door frame can include a first door frame (or a left front door frame), a second door frame (or a right front door frame), a third door frame (or a left rear door frame), and a fourth door frame (or a right rear door frame). According to an embodiment of the present disclosure, the door interior material 130D can include a first door interior material (or a left front door interior material) 130D1 covering the first door frame, a second door interior material (or a right front door interior material) 130D2 covering the second door frame, a third door interior material (or a left rear door interior material) 130D3 covering the third door frame, and a fourth door interior material (or a right rear door interior material) 130D4 covering the fourth door frame. For example, the fourth sound generating module 31D can be disposed at at least one or more of an upper region, a middle region, and a lower region between each of the first to fourth door frames and the first to fourth door interior materials 130D1, 130D2, 130D3, and 130D4 and can vibrate at least one or more of the upper region, the middle region, and the lower region of each of the first to fourth door interior materials 130D1, 130D2, 130D3, and 130D4.

According to an embodiment of the present disclosure, the fourth sound generating module 31D configured to vibrate the upper region of each of the first to fourth door interior materials 130D1, 130D2, 130D3, and 130D4 can be configured to output a sound of about 2 kHz to about 20 kHz, or can be configured to output a sound of about 150 Hz to about 20 kHz. For example, the fourth sound generating module 31D configured to vibrate the upper regions of at least one or more of the first to fourth door interior materials 130D1, 130D2, 130D3, and 130D4 can be configured to output a sound of about 2 kHz to about 20 kHz, or can be configured to output a sound of about 150 Hz to about 20 kHz.

According to an embodiment of the present disclosure, the fourth sound generating module 31D configured to vibrate the middle regions and the lower regions of at least one or more of the first to fourth door interior materials 130D1, 130D2, 130D3, and 130D4 can be configured to output a sound of about 150 Hz to about 20 kHz. The fourth sound generating module 31D configured to vibrate the middle region and the lower region of each of the first to fourth door interior materials 130D1, 130D2, 130D3, and 130D4 can be configured to output a sound of about 150 Hz to about 20 kHz. For example, the fourth sound generating module 31D configured to vibrate the middle regions and the lower regions of at least one or more of the first to fourth door interior materials 130D1, 130D2, 130D3, and 130D4 can be one or more of a woofer, a mid-woofer, and a sub-woofer. For example, the fourth sound generating module 31D configured to vibrate the middle region and the lower region of each of the first to fourth door interior materials 130D1, 130D2, 130D3, and 130D4 can be one or more of a woofer, a mid-woofer, and a sub-woofer.

Sounds, which are respectively output from the fourth sound generating module 31D disposed at the first door interior material 130D1 and the fourth sound generating module 31D disposed at the second door interior material 130D2, can be combined and output. For example, sounds, which are respectively output from at least one or more of the fourth sound generating modules 31D disposed at the first door interior material 130D1 and the fourth sound generating module 31D disposed at the second door interior material 130D2, can be combined and output. In addition, sounds, which are respectively output from the fourth sound generating module 31D disposed at the third door interior material 130D3 and the fourth sound generating module 31D disposed at the fourth door interior material 130D4 can be combined and output.

According to an embodiment of the present disclosure, the upper region of each of the first to fourth door interior materials 130D1, 130D2, 130D3, and 130D4 can include a first upper region adjacent to the dashboard 130A, a second upper region adjacent to the rear seats BS1, BS2, and BS3, and a third upper region between the first upper region and the second upper region. For example, the fourth sound generating module 31D can be disposed at one or more of the first to third upper regions of each of the first to fourth door interior materials 130D1, 130D2, 130D3, and 130D4. For example, the fourth sound generating module 31D can be disposed at the first upper region of each of the first and second door interior materials 130D1 and 130D2 and can be disposed at one or more of the second and third upper regions of each of the first and second door interior materials 130D1 and 130D2. For example, the fourth sound generating module 31D can be disposed at one or more among the first to third upper regions of one or more of the first to fourth door interior materials 130D1 to 130D4. For example, the fourth sound generating module 31D configured to vibrate the first upper regions of one or more of the first and second door interior materials 130D1 and 130D2 can be configured to output a sound of about 2 kHz to about 20 kHz, and the fourth sound generating module 31D configured to vibrate one or more among the second and third upper regions of each of the first and second door interior materials 130D1 and 130D2 can be configured to output a sound of about 2 kHz to about 20 kHz, or can be configured to output a sound of about 150 Hz to about 20 kHz. For example, the fourth sound generating module 31D configured to vibrate one or more among the second and third upper regions of at least one or more of the first and second door interior materials 130D1 and 130D2 can be configured to output a sound of about 2 kHz to about 20 kHz, or can be configured to output a sound of about 150 Hz to about 20 KHz.

With reference to FIGS. 36, 37, and 39, the fifth sound generating module 31E according to an embodiment of the present disclosure can be disposed between a seat frame and the seat interior material 130E and can vibrate the seat interior material 130E to output a sound based on a vibration of the seat interior material 130E. For example, the fifth sound generating module 31E can directly vibrate the seat interior material 130E to output a sound based on a vibration of the seat interior material 130E. According to an embodiment of the present disclosure, the fifth sound generating module 31E can include the sound apparatus 30 described above with reference to FIGS. 3 to 35, and thus, repeated descriptions are omitted. For example, the fifth sound generating module 31E can be a sheet speaker or a headrest speaker.

According to an embodiment of the present disclosure, the seat frame can include a first seat frame (or a driver seat frame), a second seat frame (or a passenger seat frame), a third seat frame (or a first rear seat frame), a fourth seat frame (or a second rear seat frame), and a fifth seat frame (or a third rear seat frame). According to an embodiment of the present disclosure, the seat interior material 130E can include the first seat interior material surrounding the first seat frame, the second seat interior material surrounding the second seat frame, the third seat interior material surrounding the third seat frame, the fourth seat interior material surrounding the fourth seat frame, and the fifth seat interior material surrounding the fifth seat frame.

According to an embodiment of the present disclosure, at least one or more of the first to fifth seat frames can include a seat bottom frame, a seat back frame, and a headrest frame. The seat interior material 130E can include a seat bottom interior material 130E1 surrounding the seat bottom frame, a seat back interior material 130E2 surrounding the seat back frame, and a headrest interior material 130E3 surrounding the headrest frame. At least one or more of the seat bottom interior material 130E1, the seat back interior material 130E2, and the headrest interior material 130E3 can include an inner interior material and an outer interior material. For example, the inner interior material can include a foam layer. For example, as described above with reference to FIG. 2, the outer interior material can include a surface member including a fiber or leather. For example, the outer interior material can further include a base member including a plastic material which supports the surface member.

According to an embodiment of the present disclosure, the fifth sound generating module 31E can be disposed at at least one or more of a region between the seat back frame and the seat back interior material 130E2 and a region between the headrest frame and the headrest interior material 130E3, and thus, can vibrate at least one or more of the outer interior material of the seat back interior material 130E2 and the outer interior material of the headrest interior material 130E3.

According to an embodiment of the present disclosure, the fifth sound generating module 31E disposed at at least one or more of the driver seat DS and the passenger seat PS can be disposed at at least one or more of the region between the seat back frame and the seat back interior material 130E2 and the region between the headrest frame and the headrest interior material 130E3.

According to an embodiment of the present disclosure, the fifth sound generating module 31E disposed at at least one or more of the first to third rear seats BS1, BS2, and BS3 can be disposed between the headrest frame and the headrest interior material 130E3. For example, at least one or more of the first to third rear seats BS1, BS2, and BS3 can include at least one or more fifth sound generating modules 31E disposed between the headrest frame and the headrest interior material 130E3.

According to an embodiment of the present disclosure, the fifth sound generating module 31E vibrating the seat back interior materials 130E2 of at least one or more of the driver seat DS and the passenger seat PS can be configured to output a sound of about 150 Hz to about 20 kHz.

According to an embodiment of the present disclosure, the fifth sound generating module 31E vibrating the headrest interior materials 130E3 of at least one or more of the driver seat DS, the passenger seat PS, and the first to third rear seats BS1, BS2, and BS3 can be configured to output a sound of about 2 kHz to about 20 kHz, or can be configured to output a sound of about 150 Hz to about 20 kHz.

With reference to FIGS. 36 and 38, the sixth sound generating module 31F according to an embodiment of the present disclosure can be disposed between a handle frame and the handle interior material 130F and can vibrate the handle interior material 130F to output a sound based on a vibration of the handle interior material 130F. For example, the sixth sound generating module 31F can directly vibrate the handle interior material 130F to output a sound based on a vibration of the handle interior material 130F. According to an embodiment of the present disclosure, the sixth sound generating module 31F can include the sound apparatus 30 described above with reference to FIGS. 3 to 35, and thus, repeated descriptions are omitted. For example, the sixth sound generating module 31F can be a handle speaker or a steering speaker.

According to an embodiment of the present disclosure, the sixth sound generating module 31F can vibrate the handle interior material 130F to provide a driver with a sound based on a vibration of the handle interior material 130F. For example, the sixth sound generating module 31F can directly vibrate the handle interior material 130F to provide the driver with the sound based on the vibration of the handle interior material 130F. A sound output by the sixth sound generating module 31F can be a sound which is a same as or different from a sound output from each of the first to fifth sound generating modules 31A to 31E. For example, a sound output by the sixth sound generating module 31F can be a sound which is the same as or different from sounds output from at least one or more of the first to fifth sound generating modules 31A to 31E. As an embodiment of the present disclosure, the sixth sound generating module 31F can output a sound which is to be provided to only the driver. As another embodiment of the present disclosure, the sound output by the sixth sound generating module 31F and a sound output by each of the first to fifth sound generating modules 31A to 31E can be combined and output. For example, the sound output by the sixth sound generating module 31F and the sound output by at least one or more of the first to fifth sound generating modules 31A to 31E can be combined and output.

With reference to FIGS. 36 and 38, the seventh sound generating module 31G can be disposed between the floor panel and the floor interior material 130G and can vibrate the floor interior material 130G to output a sound based on a vibration of the floor interior material 130G. For example, the seventh sound generating module 31G can directly vibrate the floor interior material 130G to output the sound based on the vibration of the floor interior material 130G.

The seventh sound generating module 31G can be disposed between the floor panel and the floor interior material 130G disposed between the front seats DS and PS and the third rear seat BS3. For example, the seventh sound generating module 31G can include the sound apparatus 30 described above with reference to FIGS. 3 to 35, and thus, repeated descriptions are omitted. For example, the seventh sound generating module 31G can be configured to output a sound of about 150 Hz to about 20 kHz. For example, the seventh sound generating module 31G can be a floor speaker, a bottom speaker, or an under speaker.

With reference to FIGS. 36 to 38, the vehicular apparatus or the vehicle 10 according to an embodiment of the present disclosure can further include a second sound generating apparatus 30-2 which is disposed at the vehicle interior material 130 exposed at an interior space. For example, the vehicular apparatus or the vehicle 10 according to an embodiment of the present disclosure can include only the second sound generating apparatus 30-2 instead of the first sound generating apparatus 30-1, or can include all of the first sound generating apparatus 30-1 and the second sound generating apparatus 30-2.

According to an embodiment of the present disclosure, the vehicle interior material 130 can further include a rear view mirror 130H, an overhead console 130I, a rear package interior material 130J, a glove box 130K, and a sun visor 130L, or the like.

The second sound generating apparatus 30-2 can include one or more sound generating modules 31H to 31L which are disposed at at least one of the rear view mirror 130H, the overhead console 130I, the rear package interior material 130J, the glove box 130K, and the sun visor 130L. For example, the second sound generating apparatus 30-2 can include at least one or more of eighth to twelfth sound generating modules 31H to 31L, and thus, can output sounds of one or more channels.

With reference to FIGS. 36 to 38, the eighth sound generating module 31H can be disposed at the rear view mirror 130H and can vibrate the rear view mirror 130H to output a sound based on a vibration of the rear view mirror 130H. For example, the eighth sound generating module 31H can be configured to directly vibrate the rear view mirror 130H to output the sound based on the vibration of the rear view mirror 130H.

The eighth sound generating module 31H can be disposed between a mirror housing connected to a vehicle body structure and the rear view mirror 130H supported by the mirror housing. According to an embodiment of the present disclosure, the eighth sound generating module 31H can include the sound apparatus 30 described above with reference to FIGS. 3 to 35, and thus, repeated descriptions are omitted. For example, the eighth sound generating module 31H can be configured to output a sound of about 150 Hz to about 20 kHz. For example, the eighth sound generating module 31H can be a mirror speaker.

With reference to FIGS. 38 and 39, the ninth sound generating module 31I can be disposed at the overhead console 130I and can vibrate a console cover of the overhead console 130I to output a sound based on a vibration of an interior material of the overhead console 130I. For example, the ninth sound generating module 31I can be configured to directly vibrate the console cover of the overhead console 130I to output the sound based on the vibration of the interior material of the overhead console 130I.

According to an embodiment of the present disclosure, the overhead console 130I can include a console box buried (or embedded) into the roof panel, a lighting device disposed at the console box, and the console cover covering the lighting device and the console box.

The ninth sound generating module 31I can be disposed between the console cover and the console box of the overhead console 130I and can vibrate the console cover. For example, the ninth sound generating module 31I can be disposed between the console cover and the console box of the overhead console 130I and can directly vibrate the console cover. According to an embodiment of the present disclosure, the ninth sound generating module 31I can include the sound apparatus 30 described above with reference to FIGS. 3 to 35, and thus, repeated descriptions are omitted. For example, the ninth sound generating module 31I can be configured to output a sound of about 150 Hz to about 20 kHz. For example, the ninth sound generating module 31I can be a console speaker or a lighting speaker.

According to an embodiment of the present disclosure, the vehicular apparatus or the vehicle 10 can further include a center lighting box disposed at a center region of the roof interior material 130C, a center lighting device disposed at the center lighting box, and a center lighting cover covering the center lighting device. In this case, the ninth sound generating module 31I can be further disposed between a center lighting cover and a center lighting box of the center lighting device and can additionally vibrate the center lighting cover.

With reference to FIGS. 36 and 38, the tenth sound generating module 31J can be disposed at the rear package interior material 130J and can vibrate the rear package interior material 130J to output a sound based on a vibration of the rear package interior material 130J. For example, the ninth sound generating module 31I can be configured to directly vibrate the rear package interior material 130J to output the sound based on the vibration of the rear package interior material 130J.

The rear package interior material 130J can be disposed behind the first to third rear seats BS1, BS2, and BS3. For example, a portion of the rear package interior material 130J can be disposed under a rear window 230C.

The tenth sound generating module 31J can be disposed at a rear surface of the rear package interior material 130J and can vibrate the rear package interior material 130J. For example, the tenth sound generating module 31J can directly vibrate the rear package interior material 130J. According to an embodiment of the present disclosure, the tenth sound generating module 31J can include the sound apparatus 30 described above with reference to FIGS. 3 to 35, and thus, repeated descriptions are omitted. For example, the tenth sound generating module 31J can be a rear speaker.

According to an embodiment of the present disclosure, the rear package interior material 130J can include a first region corresponding to a rear portion of the first rear seat BS1, a second region corresponding to a rear portion of the second rear seat BS2, and a third region corresponding to a rear portion of the third passenger seat BS3. According to an embodiment of the present disclosure, the tenth sound generating module 31J can be disposed to vibrate at least one or more of the first to third regions of the rear package interior material 130J. For example, the tenth sound generating module 31J can be disposed at each of the first and second regions of the rear package interior material 130J, or can be disposed at each of the first to third regions of the rear package interior material 130J. For example, the tenth sound generating module 31J can be disposed at at least one or more of the first and second regions of the rear package interior material 130J, or can be disposed at at least one or more of the first to third regions of the rear package interior material 130J. For example, the tenth sound generating module 31J can be configured to output a sound of about 150 Hz to about 20 kHz. For example, the tenth sound generating module 31J configured to vibrate each of the first to third regions of the rear package interior material 130J can have a same sound output characteristic or different sound output characteristics. For example, the tenth sound generating module 31J configured to vibrate at least one or more of the first to third regions of the rear package interior material 130J can have a same sound output characteristic or different sound output characteristics.

With reference to FIGS. 36 and 38, the eleventh sound generating module 31K can be disposed at a glove box 130K and can vibrate the glove box 130K to output a sound based on a vibration of the glove box 130K. For example, the eleventh sound generating module 31K can directly vibrate the glove box 130K to output the sound based on the vibration of the glove box 130K.

The glove box 130K can be disposed at a dashboard 130A corresponding to a front portion of the passenger seat PS.

The eleventh sound generating module 31K can be disposed at an inner surface of the glove box 130K and can vibrate the glove box 130K. For example, the eleventh sound generating module 31K can directly vibrate the glove box 130K. According to an embodiment of the present disclosure, the eleventh sound generating module 31K can include the sound apparatus 30 described above with reference to FIGS. 3 to 35, and thus, repeated descriptions are omitted. For example, the eleventh sound generating module 31K can be configured to output a sound of about 150 Hz to about 20 kHz, or can be one or more of a woofer, a mid-woofer, and a sub-woofer. For example, the eleventh sound generating module 31K can be a glove box speaker.

With reference to FIG. 38, the twelfth sound generating module 31L can be disposed at the sun visor 130L and can vibrate the sun visor 130L to output a sound based on a vibration of the sun visor 130L. For example, the twelfth sound generating module 31L can directly vibrate the sun visor 130L to output the sound based on the vibration of the sun visor 130L.

The sun visor 130L can include a first sun visor 130L1 corresponding to the driver seat DS and a second sun visor 130L2 corresponding to the passenger seat PS.

The twelfth sound generating module 31L can be disposed at at least one or more of the first sun visor 130L1 and the second sun visor 130L2 and can vibrate at least one or more of the first sun visor 130L1 and the second sun visor 130L2. For example, the twelfth sound generating module 31L can directly vibrate at least one or more of the first sun visor 130L1 and the second sun visor 130L2. According to an embodiment of the present disclosure, the twelfth sound generating module 31L can include the sound apparatus 30 described above with reference to FIGS. 3 to 35, and thus, repeated descriptions are omitted. For example, the twelfth sound generating module 31L can be configured to output a sound of about 150 Hz to about 20 kHz. For example, the twelfth sound generating module 31L can be a sun visor speaker.

According to an embodiment of the present disclosure, at least one or more of the first sun visor 130L1 and the second sun visor 130L2 can further include a sun visor mirror. In this case, the twelfth sound generating module 31L can be configured to vibrate a sun visor mirror of one or more of the first sun visor 130L1 and the second sun visor 130L2. The twelfth sound generating module 31L can directly vibrate the sun visor mirror of one or more of the first sun visor 130L1 and the second sun visor 130L2. The twelfth sound generating module 31L vibrating the sun visor mirror can include the sound apparatus 30 described above with reference to FIGS. 3 to 35, and thus, repeated descriptions are omitted.

With reference to FIGS. 36 to 38, the vehicular apparatus or the vehicle 10 according to an embodiment of the present disclosure can further include a third sound generating apparatus 30-3 disposed at a vehicle window 230. For example, the vehicular apparatus or the vehicle 10 according to an embodiment of the present disclosure can include the third sound generating apparatus 30-3 instead of at least one or more of the first and second sound generating apparatuses 30-1 and 30-2, or can include all of the first to third sound generating apparatuses 30-1 to 30-3.

The third sound generating apparatus 30-3 can include one or more sound generating modules 31N to 31O disposed at the vehicle window 230. For example, the third sound generating apparatus 30-3 can include at least one or more of thirteenth and fourteenth sound generating modules 31N and 31O, and thus, can output sounds of one or more channels.

At least one or more of the thirteenth and fourteenth sound generating modules 31N and 31O can include the sound apparatus 30 described above with reference to FIGS. 3 to 35, and thus, repeated descriptions are omitted.

With reference to FIGS. 36 to 39 in conjunction with FIG. 1, the at least one or more of the thirteenth and fourteenth sound generating modules 31N and 31O can be disposed at one surface (or an indoor surface) of the vehicle window 230 exposed at inside and/or an interior space IS of the vehicular apparatus or the vehicle 10. For example, the at least one or more of the thirteenth and fourteenth sound generating modules 31N and 31O can be disposed at at least one or more of the front window and the side window and can be further disposed at at least one or more of the rear window and the roof window.

The at least one or more of the thirteenth and fourteenth sound generating modules 31N and 31O can vibrate the vehicle window 230 to output a sound based on a vibration of the vehicle window 230. For example, the at least one or more of the thirteenth and fourteenth sound generating modules 31N and 31O can directly vibrate the vehicle window 230 to output a sound based on a vibration of the vehicle window 230.

According to an embodiment of the present disclosure, the vehicle window 230 can include the front window, the side window 230B, and the rear window. According to an embodiment of the present disclosure, the vehicle window 230 can further include the roof window 230D. For example, when the vehicular apparatus or the vehicle 10 includes the roof window 230D, a portion of a region of the roof frame and the roof interior material 130C can be replaced with the roof window 230D. For example, when the vehicular apparatus or the vehicle 10 includes the roof window 230D, the third sound generating module 31C can be configured to vibrate a periphery portion of the roof interior material 130C surrounding the roof window 230D.

With reference to FIGS. 37 to 39, the thirteenth sound generating module 31N according to an embodiment of the present disclosure can be disposed at the side window 230B and can be configured to output a sound by vibrating itself (or self-vibration thereof), or can be configured to indirectly or directly vibrate the side window 230B to output a sound based on a vibration of the side window 230B. For example, the thirteenth sound generating module 31N can directly vibrate the side window 230B to output a sound based on the vibration of the side window 230B.

According to an embodiment of the present disclosure, the side window 230B can include a first glass window (or a right front window) 230B2, a second side window (or a left rear window) 230B3, a third side window (or a right rear window) 230B4, and a fourth side window (or a left front window).

According to an embodiment of the present disclosure, the thirteenth sound generating module 31N can be disposed at at least one or more of the first to third side windows 230B2, 230B3, and 230B4. For example, at least one or more of the first to third side windows 230B2, 230B3, and 230B4 can include one or more thirteenth sound generating modules 31N.

According to an embodiment of the present disclosure, the thirteenth sound generating module 31N can be disposed at at least one or more of the first to third side windows 230B2, 230B3, and 230B4 and can output a sound by vibrating itself (or self-vibration thereof), or can vibrate a corresponding side windows 230B2, 230B3, and 230B4 to output a sound. For example, the thirteenth sound generating module 31N can directly vibrate the side windows 230B2, 230B3, and 230B4 to output the sound. For example, the thirteenth sound generating module 31N can be configured to output the sound of 150 Hz to 20 kHz. For example, the thirteenth sound generating module 31N disposed at at least one or more of the first to third side windows 230B2, 230B3, and 230B4 can have a same sound output characteristic or different sound output characteristics. For example, the thirteenth sound generating module 31N can be configured to output the sound of 150 Hz to 20 kHz. For example, the thirteenth sound generating module 31N can be a side window speaker.

With reference to FIG. 36, the fourteenth sound generating module 31O according to an embodiment of the present disclosure can be disposed at the rear window 230C and can output a sound by vibrating itself (or self-vibration thereof), or can vibrate the rear window 230C to output a sound based on a vibration of the rear window 230C. For example, the fourteenth sound generating module 31O can directly vibrate the rear window 230C to output the sound based on the vibration of the rear window 230C.

According to an embodiment of the present disclosure, the rear window 230C can include a first region corresponding to a rear portion of the first rear seat BS1, a second region corresponding to a rear portion of the second rear seat BS2, and a third region corresponding to a rear portion of the third rear seat BS3.

According to an embodiment of the present disclosure, the fourteenth sound generating module 31O can be disposed at at least one or more of the first and second regions of the rear window 230C. For example, the fourteenth sound generating module 31O can be disposed at at least one or more of the first to third regions of the rear window 230C. For example, the fourteenth sound generating module 31O can be disposed at each of the first and second regions of the rear window 230C, or can be disposed at each of the first to third regions of the rear window 230C. For example, the fourteenth sound generating module 31O can be disposed at at least one or more of the first and second regions of the rear window 230C, or can be disposed at at least one or more of the first to third regions of the rear window 230C.

According to an embodiment of the present disclosure, the fourteenth sound generating module 31O can be configured to output a sound of about 150 Hz to about 20 kHz. For example, the fourteenth sound generating module 31O disposed at at least one or more of the first to third regions of the rear window 230C can have a same sound output characteristic or different sound output characteristics. For example, the fourteenth sound generating module 31O disposed at at least one or more of the first to third regions of the rear window 230C can have a same sound output characteristic or different sound output characteristics. For example, the fourteenth sound generating module 31O disposed at at least one or more of the first and second regions of the rear window 230C can be configured to output a sound of about 150 Hz to about 20 kHz, or can be one or more of a woofer, a mid-woofer, and a sub-woofer. For example, the fourteenth sound generating module 31O can be a rear window speaker.

With reference to FIGS. 36 and 37, the vehicular apparatus or the vehicle 10 according to an embodiment of the present disclosure can further include a woofer speaker WS which is disposed at at least one or more of the dashboard 130A, the door interior material 130D, and the rear package interior material 130J.

The woofer speaker WS according to an embodiment of the present disclosure can include at least one or more of a woofer, a mid-woofer, and a sub-woofer. For example, the woofer speaker WS can be a speaker which outputs a sound of about 60 Hz to about 150 Hz. Therefore, the woofer speaker WS can output a sound of about 60 Hz to about 150 Hz, and thus, can enhance a low-pitched sound band characteristic of a sound which is output to an interior space.

According to an embodiment of the present disclosure, the woofer speaker WS can be disposed at at least one or more of first and second regions of the dashboard 130A. According to an embodiment of the present disclosure, the woofer speaker WS can be disposed at each of first to fourth door frames of the door frame and can be exposed at a lower region of each of the first to fourth door interior materials 130D1 to 130D4 of the door interior material 130D. For example, the woofer speaker WS can be disposed at at least one or more of the first to fourth door frames of the door frame and can be exposed at the lower regions of at least one or more of the first to fourth door interior materials 130D1 to 130D4 of the door interior material 130D.

According to an embodiment of the present disclosure, the woofer speaker WS can be disposed at at least one or more of the first and second regions of the rear package interior material 130J. For example, the fourth sound generating module 31D disposed at least one or more of the first to fourth door frames of the door frame can be replaced by the woofer speaker WS. For example, the fourth sound generating module 31D disposed at the lower region of at least one or more of the first to fourth door interior materials 130D1 to 130D4 can be replaced by the woofer speaker WS.

The vehicular apparatus 10 according to an embodiment of the present disclosure can further include a garnish member 130P which covers a portion of the vehicle interior material 130 exposed at the interior space IS, and a fourth sound generating apparatus 30-4 disposed at the vehicle interior material 130. For example, the fourth sound generating apparatus 30-4 can be disposed at the garnish member 130P and the vehicle interior material 130 to output a sound. For example, at least one or more of the garnish member 130P and the vehicle interior material 130 can output a sound based on vibrations of fourth sound generating apparatus 30-4.

The garnish member 130P can be configured to cover a portion of the door interior material 130D exposed at the interior space IS, but embodiments of the present disclosure are not limited thereto. For example, the garnish member 130P can be configured to cover a portion of one or more of the dashboard 130A, the pillar interior material 130B, and the roof interior material 130C, which are exposed at the interior space IS.

The garnish member 130P according to an embodiment of the present disclosure can include a metal material or a nonmetal material (or a composite nonmetal material) having a material characteristic suitable for generating a sound based on a vibration. For example, a metal material of the garnish member 130P can include any one or more materials of stainless steel, aluminum (Al), an Al alloy, a magnesium (Mg), a Mg alloy, and a magnesium-lithium (Mg—Li) alloy, but embodiments of the present disclosure are not limited thereto. The nonmetal material (or the composite nonmetal material) of the garnish member 130P can include one or more of wood, plastic, glass, metal, cloth, fiber, rubber, paper, carbon, and leather, but embodiments of the present disclosure are not limited thereto. For example, the garnish member 130P can include a metal material having a material characteristic suitable for generating a sound of a high-pitched sound band, but embodiments of the present disclosure are not limited thereto. For example, the high-pitched sound band can have a frequency of 1 kHz or more or 3 kHz or more, but embodiments of the present disclosure are not limited thereto.

The fourth sound generating apparatus 30-4 can be disposed between the garnish member 130P and the vehicle interior material 130. For example, the fourth sound generating apparatus 30-4 can be a garnish speaker or the like, but embodiments of the present disclosure are not limited thereto.

The fourth sound generating apparatus 30-4 according to an embodiment of the present disclosure can include one or more of the sound apparatus 30 described above with reference to FIGS. 3 to 35. The fourth sound generating apparatus 30-4 can be disposed at a main interior material or the vehicle interior material 130 and the garnish member 130P and can be connected or coupled to the garnish member 130P.

The fourth sound generating apparatus 30-4 according to an embodiment of the present disclosure can be configured to indirectly or directly vibrate the garnish member 130P to output a sound into the interior space IS of the vehicular apparatus 10. For example, the fourth sound generating apparatus 30-4 can be configured to output a sound of a high-pitched sound band, but embodiments of the present disclosure are not limited thereto.

The vehicular apparatus or the vehicle 10 according to an embodiment of the present disclosure can output a sound to the interior space IS through at least one or more of the first sound generating apparatus 30-1 disposed at the vehicle interior material 130, the second sound generating apparatus 30-2 disposed at the vehicle interior material 130 exposed at the interior space IS, the third sound generating apparatus 30-3 disposed at the vehicle window 230, and the fourth sound generating apparatus 30-4 disposed at the garnish member 130P, and thus, can output the sound by a vehicle interior material 130 as a vibration plate or a sound vibration plate, thereby outputting a multichannel surround stereo sound.

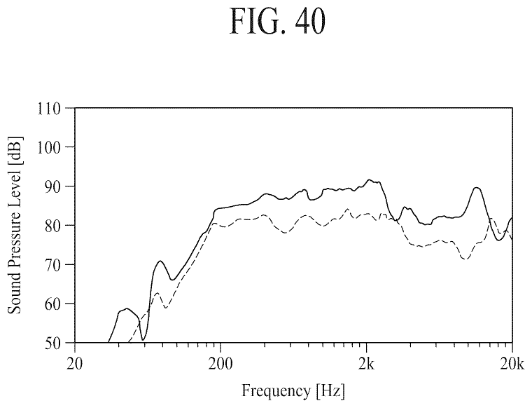

FIG. 40 illustrates a sound output characteristic of an apparatus according to each of an embodiment of the present disclosure and an experimental example.

In FIG. 40, the abscissa axis represents a frequency in hertz (Hz), and the ordinate axis represents a sound pressure level (SPL) in decibels (dB). a solid line represents a sound output characteristic of a sound apparatus according to an embodiment of the present disclosure described above with reference to FIG. 21. A dotted line represents a sound output characteristic of a sound generating module where an enclosure has been removed in the sound apparatus described above with reference to FIG. 3.

The sound output characteristic can be measured by sound analysis equipment. The sound analysis equipment can include a control PC, a sound card for transmitting and receiving sound, an amplifier for amplifying and transmitting the sound generated from the sound card to the sound apparatus, and a microphone for collecting the sound generated in the apparatus based on driving of the vibration apparatus. The sound collected by the microphone is input to the control PC through the sound card, and the sound is checked in a control program to analyze the sound of the apparatus.

The sound output characteristic has been measured in an anechoic chamber, which is closed in all directions. When measuring, an applied frequency signal is applied as a sine sweep within a range of 20 Hz to 20 kHz, and ⅙ octave smoothing has been performed on a measurement result. A separation distance between the apparatus and the microphone is adjusted to be 1 m (meter). However, a measurement method of the sound output characteristic can be not limited thereto.

With reference to FIG. 40, comparing with the dotted line, in the solid line, it can be seen that a sound pressure level increases, and it can be seen that a sound pressure level increases in a pitches sound band of about 40 Hz or more, and thus, a flatness characteristic of a sound pressure level is enhanced.

Accordingly, a sound apparatus according to one or more embodiments of the present disclosure can include an enclosure which surrounds a sound generating module, and thus, can output a sound having a sufficient sound pressure level in a low-pitched sound band of 200 Hz or less, enhance a sound characteristic and/or a sound pressure level characteristic of a middle-low-pitched sound band and a high-pitched sound band of 200 Hz or more, and enhance a flatness characteristic of a sound pressure level.

A sound apparatus and a vehicular apparatus including the same according to one or more embodiments of the present disclosure are described below.

A sound apparatus according to one or more embodiments of the present disclosure can comprise an enclosure including an internal space and an opening part connected to the internal space; and a sound generating module at the internal space of the enclosure, the sound generating module can comprise a vibration member at the enclosure; and a vibration apparatus connected to the enclosure to vibrate the vibration member.

According to various embodiments of the present disclosure, the vibration apparatus can be a coil-type vibration apparatus.

According to various embodiments of the present disclosure, the vibration apparatus can be connected to the vibration member and the enclosure at the internal space of the enclosure, and the vibration member can be spaced apart from the opening part.

According to various embodiments of the present disclosure, the sound apparatus can further comprise a heat dissipation plate disposed between the vibration apparatus and the vibration member.

According to various embodiments of the present disclosure, the vibration apparatus can comprise a base frame connected to the enclosure; a magnetic circuit part disposed at the base frame, the magnetic circuit part including a bobbin connected to the vibration member; and a damper connected between the base frame and the bobbin.

According to various embodiments of the present disclosure, the vibration apparatus can comprise a base frame connected to the enclosure; a bobbin disposed at the base frame and connected to the vibration member; a magnet provided inside or outside the bobbin; a coil wound around the bobbin; and a damper connected between the base frame and the bobbin.

According to various embodiments of the present disclosure, the sound apparatus can further comprise a fixing member configured to fix the vibration apparatus to the enclosure, the fixing member can comprise an adhesive member disposed between at least a portion of the base frame and the enclosure, or can comprise a plurality of screws passing through at least a portion of the base frame and fastened to the enclosure.

According to various embodiments of the present disclosure, the vibration apparatus can further comprise a protection member connected to a front surface of the bobbin.

According to various embodiments of the present disclosure, the vibration apparatus can further comprise a protection member connected to a front surface of the bobbin, and the sound generating module can further comprise an adhesive member between the protection member and the vibration member.

According to various embodiments of the present disclosure, the enclosure can comprise a first enclosure and a second enclosure providing the internal space, the vibration member can be between the first enclosure and the second enclosure, and the vibration apparatus can be between the vibration member and the second enclosure.

According to various embodiments of the present disclosure, the first enclosure can comprise the opening part and can be connected to a first surface of the vibration member, and the second enclosure covers the vibration apparatus and can be connected to a second surface of the vibration member opposite to the first surface of the vibration member.

According to various embodiments of the present disclosure, the vibration apparatus can be coupled to the second enclosure at a space between the vibration member and the second enclosure and can be configured to vibrate the vibration member.

According to various embodiments of the present disclosure, the sound apparatus can further comprise a heat dissipation part including one or more holes configured at the second enclosure.

According to various embodiments of the present disclosure, the one or more holes can be configured to pass through a portion of the second enclosure overlapping the vibration apparatus, or can be configured to pass through a portion of the second enclosure facing the vibration member at a periphery of the vibration apparatus.

According to various embodiments of the present disclosure, the internal space can comprise a first space between the vibration member and the first enclosure and connected to the opening part; and a second space between the vibration member and the second enclosure.

According to various embodiments of the present disclosure, the vibration member can comprise one or more holes at a periphery of the vibration apparatus, and the first space and the second space can be connected to each other through the one or more holes.

According to various embodiments of the present disclosure, the sound apparatus can further comprise a fixing member configured to fix the vibration apparatus to the second enclosure.

According to various embodiments of the present disclosure, the sound apparatus can further comprise a connection member connected to a rear surface of the first enclosure, the connection member can comprise a first portion and a second portion having different thicknesses.

According to various embodiments of the present disclosure, a thickness of the second portion can be greater than a thickness of the first portion.

According to various embodiments of the present disclosure, the second portion can be at a periphery portion of the first enclosure, and the first portion can be at a remaining portion, other than the periphery portion, of the first enclosure.

According to various embodiments of the present disclosure, the enclosure can comprise a first region corresponding to a center portion; a second region corresponding to a periphery portion surrounding the center portion; and a third region between the first region and the second region, the first portion can be at the first region and the third region, and the second portion can be at the second region.

According to various embodiments of the present disclosure, the connection member can comprise a first connection member connected to the first enclosure; and a second connection member connected to a portion of the first connection member, the first portion can comprise only the first connection member of the first connection member and the second connection member, and the second portion can comprise both the first connection member and the second connection member.

According to various embodiments of the present disclosure, the second connection member can be stacked on the first connection member at the second portion.

According to various embodiments of the present disclosure, at least one of the first connection member and the second connection member can comprise a rubber material, or can comprise ethylene propylene diene monomer, ethylene propylene rubber, or urethane rubber.

According to various embodiments of the present disclosure, the sound apparatus can further comprise a coupling member between the vibration member and each of the first enclosure and the second enclosure; and a connection member connected to the first enclosure, the connection member can comprise a material different from a material of the coupling member.

According to various embodiments of the present disclosure, the connection member can comprise a rubber material, or can comprise ethylene propylene diene monomer, ethylene propylene rubber, or urethane rubber.

According to various embodiments of the present disclosure, the vibration member can comprise a metal material, or can comprise a single nonmetal material or a composite nonmetal material of one or more of wood, rubber, plastic, carbon, glass, fiber, cloth, paper, mirror, and leather.

According to various embodiments of the present disclosure, the opening part can be disposed to correspond to a center portion of the vibration apparatus.

A vehicular apparatus according to one or more embodiments of the present disclosure can comprise an interior material exposed at an interior space, and one or more sound generating apparatuses disposed at the interior material to output a sound to the interior space, the one or more sound generating apparatuses can comprise an enclosure including an internal space and an opening part connected to the internal space; and a sound generating module at the internal space of the enclosure, the sound generating module can comprise a vibration member at the enclosure; and a vibration apparatus connected to the enclosure to vibrate the vibration member.

According to various embodiments of the present disclosure, the vehicular apparatus can further comprise a coupling part configured to couple the enclosure at the one or more sound generating apparatuses to the interior material, the coupling part can comprise a hollow part connected to the internal space of the enclosure through the opening part of the enclosure.

According to various embodiments of the present disclosure, the interior material can comprise an opening hole connected to the opening part of the enclosure; and the coupling part can be configured to be coupled to the enclosure through the opening hole of the interior material and the opening part of the enclosure.

According to various embodiments of the present disclosure, the coupling part can further comprise a hollow member accommodated into the opening hole of the interior material and the opening part, the hollow member including the hollow part, a hook member connected to a first side of the hollow member and coupled to an inner surface of the enclosure, and a latch member connected to a second side of the hollow member and coupled to one surface of the interior material exposed at the interior space.

According to various embodiments of the present disclosure, the interior material can comprise an opening hole connected to the opening part of the enclosure, the enclosure can further comprise a protrusion part protruding from the enclosure to surround the opening part and accommodated into the opening hole, and the coupling part can be configured to be coupled to the enclosure at the internal space of the enclosure through the protrusion part and the opening part.

According to various embodiments of the present disclosure, the protrusion part can comprise a hollow hole connected to the opening part, and the coupling part can further comprise a hollow member accommodated into the hollow hole through the opening hole of the interior material, the hollow member including the hollow part; a hook member connected to a first side of the hollow member and coupled to an inner surface of the enclosure at the internal space of the enclosure; and a latch member connected to a second side of the hollow member and configured to be coupled to one surface of the interior material exposed at the interior space.

According to various embodiments of the present disclosure, the interior material can comprise an opening hole connected to the opening part, the enclosure can further comprise a protrusion part protruding from the enclosure to surround the opening part and configured to be accommodated into the opening hole, and the coupling part can be accommodated into and coupled to the protrusion part and configured to be coupled to one surface of the interior material exposed at the interior space.

According to various embodiments of the present disclosure, the protrusion part can comprise a hollow hole connected to the opening part, the coupling part can comprise a hollow member accommodated into and coupled to the hollow hole, the hollow member including the hollow part; and a latch member connected to the hollow member, and the latch member can be configured to be coupled to one surface of the interior material exposed at the interior space.

According to various embodiments of the present disclosure, the latch member can comprise a flexible material.

According to various embodiments of the present disclosure, the interior material can comprise one or more materials of metal, wood, rubber, plastic, carbon, glass, fiber, cloth, paper, a mirror, and leather.

According to various embodiments of the present disclosure, the interior material can comprise at least one or more of a dashboard, a pillar interior material, a roof interior material, a door interior material, a seat interior material, a handle interior material, a floor interior material, a rear package interior material, an overhead console, a rear view mirror, a glove box, a garnish member, and a sun visor, and the one or more sound generating apparatuses can be configured to vibrate at least one or more of the dashboard, the pillar interior material, the roof interior material, the door interior material, the seat interior material, the handle interior material, the floor interior material, the rear package interior material, the overhead console, the rear view mirror, the glove box, the garnish member, and the sun visor, to generate a sound.

A vehicular apparatus according to one or more embodiments of the present disclosure can comprise an interior material exposed at an interior space, and one or more sound apparatuses as described above, disposed at the interior material to output a sound to the interior space.

A sound apparatus according to one or more embodiments of the present disclosure can be applied to or included in a sound apparatus disposed at an apparatus or a display apparatus. The apparatus according to an embodiment of the present disclosure can be applied to or included in mobile apparatuses, video phones, smart watches, watch phones, wearable apparatuses, foldable apparatuses, rollable apparatuses, bendable apparatuses, flexible apparatuses, curved apparatuses, sliding apparatuses, variable apparatuses, electronic organizers, electronic books, portable multimedia players (PMPs), personal digital assistants (PDAs), MP3 players, mobile medical devices, desktop personal computers (PCs), laptop PCs, netbook computers, workstations, navigation apparatuses, automotive navigation apparatuses, automotive display apparatuses, automotive apparatuses, theatre apparatuses, theatre display apparatuses, TVs, wall paper display apparatuses, signage apparatuses, game machines, notebook computers, monitors, cameras, camcorders, and home appliances, or the like.

Furthermore, the sound apparatus according to one or more embodiments of the present disclosure can be applied to or included in an organic light-emitting lighting apparatus or an inorganic light-emitting lighting apparatus. When the sound apparatus is applied to or included in the lighting apparatuses, the lighting apparatuses can act as lighting and a speaker. In addition, when the sound apparatus according to one or more embodiments of the present disclosure is applied to or included in the mobile apparatuses, or the like, the sound apparatus can be one or more of a speaker, a receiver, and a haptic device, but embodiments of the present disclosure are not limited thereto.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the appended claims and their equivalents.

What is claimed is:

1. A sound apparatus, comprising:
an enclosure including an internal space and an opening part connected to the internal space; and
a sound generating module at the internal space of the enclosure,
wherein the sound generating module comprises:
a vibration member at the enclosure; and
a vibration apparatus connected to the enclosure to vibrate the vibration member.

2. The sound apparatus of claim 1, wherein the vibration apparatus is a coil-type vibration apparatus.

3. The sound apparatus of claim 1, wherein the vibration apparatus is connected to the vibration member and the enclosure at the internal space of the enclosure, and
wherein the vibration member is spaced apart from the opening part of the enclosure.

4. The sound apparatus of claim 1, further comprising a heat dissipation plate disposed between the vibration apparatus and the vibration member.

5. The sound apparatus of claim 1, wherein the vibration apparatus comprises:
a base frame connected to the enclosure;
a magnetic circuit part disposed at the base frame, the magnetic circuit part including a bobbin connected to the vibration member; and
a damper connected between the base frame and the bobbin.

6. The sound apparatus of claim 1, wherein the vibration apparatus comprises:
a base frame connected to the enclosure;
a bobbin disposed at the base frame and connected to the vibration member;
a magnet provided inside or outside the bobbin;
a coil wound around the bobbin; and
a damper connected between the base frame and the bobbin.

7. The sound apparatus of claim 5, further comprising a fixing member configured to fix the vibration apparatus to the enclosure,
wherein the fixing member comprises an adhesive member disposed between at least a portion of the base frame and the enclosure, or comprises a plurality of screws passing through at least a portion of the base frame and fastened to the enclosure.

8. The sound apparatus of claim 5, wherein the vibration apparatus further comprises a protection member connected to a front surface of the bobbin.

9. The sound apparatus of claim 5, wherein the vibration apparatus further comprises a protection member connected to a front surface of the bobbin, and
wherein the sound generating module further comprises an adhesive member between the protection member and the vibration member.

10. The sound apparatus of claim 1, wherein the enclosure comprises a first enclosure and a second enclosure providing the internal space,
wherein the vibration member is between the first enclosure and the second enclosure, and
wherein the vibration apparatus is between the vibration member and the second enclosure.

11. The sound apparatus of claim 10, wherein the first enclosure comprises the opening part and is connected to a first surface of the vibration member, and
wherein the second enclosure covers the vibration apparatus and is connected to a second surface of the vibration member opposite to the first surface of the vibration member.

12. The sound apparatus of claim 10, further comprising a heat dissipation part including one or more holes configured at the second enclosure.

13. The sound apparatus of claim 1, wherein the vibration member comprises one or more holes at a periphery of the vibration apparatus.

14. The sound apparatus of claim 1, wherein the opening part of the enclosure is disposed to correspond to a center portion of the vibration apparatus.

15. A vehicular apparatus, comprising:
an interior material exposed at an interior space of the vehicular apparatus; and
one or more sound generating apparatuses disposed at the interior material to output a sound to the interior space,
wherein the one or more sound generating apparatuses comprise the sound apparatus of claim 1.

16. The vehicular apparatus of claim 15, further comprising a coupling part configured to couple the enclosure at the one or more sound generating apparatuses to the interior material,
wherein the coupling part comprises a hollow part connected to the internal space of the enclosure through the opening part of the enclosure.

17. The vehicular apparatus of claim 16, wherein the interior material comprises an opening hole connected to the opening part of the enclosure, and
wherein the coupling part is configured to be coupled to the enclosure through the opening hole of the interior material and the opening part of the enclosure.

18. The vehicular apparatus of claim 16, wherein the interior material comprises an opening hole connected to the opening part of the enclosure,
wherein the enclosure further comprises a protrusion part protruding from the enclosure to surround the opening part and accommodated into the opening hole of the interior material, and
wherein the coupling part is configured to be coupled to the enclosure at the internal space of the enclosure through the protrusion part and the opening part.

19. The vehicular apparatus of claim 15, wherein the interior material comprises one or more materials among metal, wood, rubber, plastic, carbon, glass, fiber, cloth, paper, a mirror, and leather.

20. The vehicular apparatus of claim 15, further comprising one or more of at least one of a connection member and a soft member disposed between the interior material and the enclosure,
wherein the soft member is configured as a soft material, and
wherein the connection member comprises a first portion and a second portion having different thicknesses, or comprises a rubber material, ethylene propylene diene monomer, ethylene propylene rubber, or urethane rubber.
